(19) United States
(12) Patent Application Publication
(10) Pub. No.: US 2026/0225250 A1
(43) Pub. Date: Aug. 6, 2026

(54) PORTABLE DATA COLLECTION SYSTEM

(71) Applicant: Figure AI Inc., San Jose, CA (US)

(72) Inventors: Victor Ragusila, San Jose, CA (US); Nathan Jenest, San Jose, CA (US); Corey Lynch, San Jose, CA (US); Michael Rose, San Jose, CA (US); Lee Magnusson, San Jose, CA (US)

(21) Appl. No.: 19/530,199

(22) Filed: Feb. 4, 2026

Related U.S. Application Data
(60) Provisional application No. 63/753,670, filed on Feb. 4, 2025.
(60) Provisional application No. 63/792,998, filed on Apr. 23, 2025.
(60) Provisional application No. 63/795,722, filed on Apr. 28, 2025.
(60) Provisional application No. 63/801,451, filed on May 7, 2025.
(60) Provisional application No. 63/808,832, filed on May 20, 2025.
(60) Provisional application No. 63/839,517, filed on Jul. 7, 2025.
(60) Provisional application No. 63/845,821, filed on Jul. 17, 2025.
(60) Provisional application No. 63/860,580, filed on Aug. 8, 2025.

(51) Int. Cl. B25J 9/16; B25J 3/00

(52) U.S. Cl. CPC B25J 9/1689; B25J 3/00

(57) ABSTRACT

The present disclosure provides a mobile data collection apparatus for use with a humanoid robot. The apparatus comprises a wearable base mount configured to be secured to a human operator's torso via a harness. The apparatus comprises a pair of articulated arms extending from opposite sides of the base mount. Each articulated arm comprises a first rigid frame link coupled to the base mount, a shoulder joint with first and second couplers defining orthogonal rotational axes with corresponding sensors, a shoulder joint rotator, a second rigid frame link, an elbow joint with coupler and sensor, a third rigid frame link, and a wrist assembly comprising first and second wrist joint couplers defining fourth and fifth rotational axes.

### CROSS REFERENCE TO RELATED APPLICATIONS

This application claims the benefit of and priority to U.S. Provisional Patent Application Nos. 63/753,670 filed Feb. 4, 2025, 63/792,998 filed Apr. 23, 2025, 63/795,722 filed Apr. 28, 2025, 63/801,451 filed May 7, 2025, 63/808,832 filed May 20, 2025, 63/839,517 filed Jul. 7, 2025, 63/845,821 filed Jul. 17, 2025, and 63/860,580 filed Aug. 8, 2025, each of which is expressly incorporated by reference herein in its entirety.

### TECHNICAL FIELD

This disclosure relates to a portable data collection system, assemblies, software, and methods for collecting said robot data.

### BACKGROUND

Humanoid robots are increasingly being developed for a wide range of general-purpose tasks in environments such as factories, warehouses, and industrial facilities. The ability of these robots to perform complex tasks often relies on advanced machine learning models, which require large amounts of high-quality motion data for training. The collection of this training data presents significant challenges. Traditional robot training systems are often bulky, expensive, and require complex infrastructure such as dedicated motion capture studios or heavy-duty robotic rigs. Many conventional systems rely on extensive camera setups that demand specific lighting conditions and are susceptible to “black-out spots” caused by occlusion from machines or other structures in the environment. Similarly, systems that use acoustic sensors may be impractical in noisy industrial settings as they require quiet environments to function properly. Furthermore, the operator's mobility is often restricted by external wires or complicated walking bases, making it difficult to capture data for tasks that require movement through a dynamic environment. Therefore, there is a need in the art for an improved portable data collection system that overcomes the foregoing challenges.

### SUMMARY

The presently disclosed subject matter is directed to a portable data collection apparatus for use with a humanoid robot. Particularly, the portable data collection apparatus comprises a base mount configured to be secured to the torso of a human operator via a harness, wherein the base mount is configured to move with the operator as the operator walks through an environment. The apparatus comprises a piloting control system. The apparatus comprises an articulated arm extending from the base mount, the articulated arm comprising a plurality of rigid frame links pivotably coupled between the base mount and the glove mount via a plurality of joints, wherein each joint of the plurality of joints includes a respective joint sensor configured to obtain joint positional data associated with the respective joint, and wherein each joint sensor is configured to provide joint positional data to the piloting control system. The apparatus comprises a headset device configured to be worn by the operator and that includes (i) a display providing virtual reality and/or augmented reality visual feedback to the operator and (ii) a head position sensor configured to determine a position of a head of the operator and provide to the piloting control system head positional data associated with the position of the head of the operator, wherein the piloting control system is configured to track the pose of an extent of the articulated arm via the provided joint positional data and to track at least one degree of freedom of the operator's head via the provided head positional data.

The presently disclosed subject matter is directed to a portable data collection apparatus for use with a humanoid robot. Particularly, the portable data collection apparatus comprises a headset device configured to be worn by the operator and that includes a display providing virtual reality and/or augmented reality visual feedback to the operator. The apparatus comprises a glove having a flexible textile and a finger portion, wherein the glove is configured to be worn by an operator and provide haptic feedback to the operator. The apparatus comprises a rigid housing coupled to a dorsal side of the glove. The apparatus comprises a finger encoder mounted at the rigid housing and configured to detect a finger movement of the operator. The apparatus comprises a first deformable connector pivotably coupled to the finger encoder at a proximal end of the first deformable connector and coupled to a tip of the finger portion of the glove at a distal end of the first deformable connector, wherein the deformable connector is configured to flex in a flexion/extension direction with the finger movement of the operator.

In some embodiments, the apparatus includes a base mount configured to be worn on an operator's torso, for instance, via a main support portion extending along the posterior of the operator. The apparatus is configured to be carried by the operator without external support. An articulated arm, which may be coupled to left or right arm attachment portions on the base mount, extends from the base mount to a glove mount at its distal end. The articulated arm may comprise a plurality of rigid frame links coupled by joints, with at least one link having an adjustable length. Also, in other embodiments, a glove is detachably coupled to the glove mount, for example, at a dorsal side of the glove. The glove is configured to determine finger positional data via a hand position sensor. This sensor may comprise a finger encoder pivotably coupled to a deformable connector, which is in turn coupled to a tip of a finger portion; in other embodiments, the sensor determines finger position by detecting alterations in an electromagnetic field. A thumb's position may be detected by a first and second thumb encoder. The glove can also be configured to provide haptic feedback to the operator, and may include a haptic button on a palmar side.

In some embodiments, a piloting control system and a power source, such as a battery, are carried by the base mount; in other embodiments, one or both may be remotely located. The apparatus may include joint sensors at fixed positions on the articulated arm, a head position sensor, and a torso position sensor located at the base mount. The piloting control system obtains positional data (e.g., joint, finger, head, torso) and stores it in data storage for later retrieval by a remote computer. Further, in other embodiments, each joint of the articulated arm substantially corresponds to a respective actuator of a robot arm. The collected positional data is used for training an artificial intelligence model. The apparatus may also collect robot data from a humanoid robot, relate it to the positional data generated by the apparatus, and provide the combined data for training the artificial intelligence model.

The presently disclosed subject matter is further directed to a portable data collection apparatus configured to provide haptic feedback to a human operator during teleoperation of a humanoid robot. Particularly, the portable data collection apparatus comprises a base mount configured to be secured to the torso of a human operator via a harness. The apparatus comprises at least one articulated arm extending from the base mount, the articulated arm comprising a base actuation assembly and a medial actuation assembly. The base actuation assembly comprises a first actuator having a first actuator housing and a first output mount that rotates about a first rotational axis, and a second actuator having a second actuator housing and a second output mount that rotates about a second rotational axis, wherein the first rotational axis is positioned at a predetermined angle with respect to the second rotational axis. The base actuation assembly further comprises an actuator output coupler configured to couple the first and second output mounts to each other at the predetermined angle. The medial actuation assembly comprises a third actuator having a third actuator housing and a third output mount that rotates about a third rotational axis. The apparatus comprises a piloting control system configured to modulate torque output of the first, second, and third actuators to provide resistive forces corresponding to forces experienced by the humanoid robot during task execution.

In some embodiments, the predetermined angle between the first rotational axis and the second rotational axis is substantially orthogonal, preferably between 70 and 110 degrees, and most preferably 90 degrees. The first actuator housing may include a first output mounting ring that surrounds the first output mount, wherein the first output mounting ring includes a first interface surface and a first limiter protruding from the first interface surface. The first limiter may have first and second limit walls configured to engage with corresponding limit projections on the actuator output coupler to define a range of motion for the articulated arm. The actuators may comprise brushless motors having momentary peak torque ranging from 17.6-26.4 N-m coupled with high-reduction gear mechanisms such as strain wave gears, cycloidal reducers, or planetary gearboxes. The piloting control system may implement gravity compensation algorithms to counteract moments produced by the weight of the actuators positioned along the articulated arm.

The presently disclosed subject matter is further directed to a glove assembly for use with a portable data collection apparatus, the glove assembly configured to track finger and thumb positions of a human operator using mechanical linkages. The glove assembly comprises a hand receptacle constructed from a flexible textile and configured to receive a human hand. The glove assembly comprises a housing coupled to a dorsal side of the hand receptacle, the housing having a distal portion and a proximal portion. The glove assembly comprises a plurality of finger encoders positioned within the distal portion of the housing, each finger encoder aligned with a respective finger portion of the hand receptacle. The glove assembly comprises a plurality of deformable connectors, each deformable connector comprising a deformable member having a proximal end pivotably coupled to a respective finger encoder and a distal end coupled to a tip of the respective finger portion. The deformable member is configured to bend in a first inward direction to allow curling of the operator's fingers and to bend in a second lateral direction to allow abduction and adduction of the operator's fingers, wherein a force required to move the deformable member a predetermined distance in the lateral direction is greater than a force required to move the deformable member the predetermined distance in the curling direction.

In some embodiments, the force ratio between the lateral direction and the curling direction is between 1× and 130×. The finger encoders may have a resolution of 12-14 bits and may be positioned with center-to-center spacing of 18-22 mm. The distal end of each deformable connector may be coupled to an eyelet having an inner diameter of 3-5 mm and a tip guard configured to receive an axis portion positioned within the eyelet, wherein the tip guard is coupled to a haptic button on a palmar side of the glove at the fingertip. The glove assembly may further comprise first and second thumb encoders positioned at the proximal portion of the housing with substantially perpendicular axes, and a thumb deformable connector having a proximal end coupled to the first thumb encoder and a distal end coupled to a thumb tip guard. The thumb deformable connector may include ribs protruding from at least one surface to maintain orientation of the deformable member with respect to the two thumb encoders as the thumb changes position.

The presently disclosed subject matter is further directed to a glove assembly configured to provide active force feedback to a human operator. The glove assembly comprises a housing configured to couple to a glove mount of an articulated arm. The glove assembly comprises a plurality of finger motors positioned at a distal portion of the housing, each finger motor aligned with a respective finger portion of a hand receptacle. The glove assembly comprises first and second thumb motors positioned at a proximal portion of the housing with perpendicular rotational axes. The glove assembly comprises a plurality of deformable members, each deformable member extending from a respective motor to a haptic button positioned at a fingertip or thumb tip of the hand receptacle. The glove assembly comprises a piloting control system configured to execute an actuator control application that modulates torque output of the finger motors and thumb motors based on force data received from the humanoid robot, wherein the force data corresponds to forces experienced by fingers of the humanoid robot during manipulation tasks.

In some embodiments, the actuator control application is configured to receive data from one or more of: simulated data generated via computational models predicting dynamic interactions based on a virtual environment, simulated data informed by a state of the humanoid robot allowing adaptive learning algorithms to refine actuation patterns, and direct data received from sensors positioned on joints, limbs, or end-effectors of the humanoid robot. The actuator control application may modulate torque output in real-time with latencies under 20 ms to provide haptic feedback corresponding to object stiffness, surface texture, grip force, and manipulation resistance.

The presently disclosed subject matter is further directed to a glove assembly for use with a portable data collection apparatus, the glove assembly configured to track hand and finger positions using electromagnetic field sensing. The glove assembly comprises a housing configured to couple to a glove mount of an articulated arm, the housing containing a magnetic field-generating apparatus. The magnetic field-generating apparatus comprises an electromagnetic field source configured to emit controlled electromagnetic field signals over a defined space around the operator's hand, the electromagnetic field source operating within a frequency range between 10 kHz and 200 kHz. The glove assembly comprises a plurality of hand position sensors configured to be positioned on or over the operator's hands and fingers, each hand position sensor configured to detect the electromagnetic field signals with high sensitivity and selectivity. The glove assembly comprises a processor configured to determine positions of the operator's fingers by analyzing detected electromagnetic field signals in conjunction with known properties of the emitted field, wherein determining positions comprises one or more of measuring signal strength attenuation, measuring phase difference between emitted and received signals, and analyzing magnetic field vector components.

In some embodiments, the hand position sensors comprise one or more of magnetic flux density sensors with sensitivities of 1-100 nT, Hall effect sensors with voltage sensitivities of 1-5 mV/mT, and inertial measurement units with gyroscope ranges of 2000 degrees/second. The hand position sensors may sample at a frequency at least six times the highest frequency component of the electromagnetic field signals. The processor may implement sensor fusion algorithms combining magnetic field vector measurements with IMU data to determine rotation of the operator's wrist and fingers, the sensor fusion algorithms comprising one or more of Extended Kalman Filters, Complementary Filters, and Madgwick filters. The glove assembly may be configured to perform environmental mapping to record variations in field strength and direction within an operational volume, creating a baseline reference to adapt dynamically to changing conditions including metallic objects causing field distortions and magnetic interference from external sources.

The presently disclosed subject matter is further directed to a method for training a machine learning model for controlling a humanoid robot using data collected from a portable data collection apparatus. The method comprises collecting sensor data from a portable data collection apparatus worn by a human operator while the human operator performs tasks, the sensor data comprising positional data associated with movements of articulated arms and finger positions of the human operator. The method comprises transmitting the sensor data to a computer system configured to generate robot control data based on the sensor data. The method comprises transmitting the robot control data to a humanoid robot to cause the humanoid robot to replicate movements of the human operator. The method comprises collecting robot data from sensors of the humanoid robot during execution of the movements, the robot data comprising one or more of measured forces and torques from joint sensors, control signals sent to actuators, measured actuator positions, and video feeds from onboard cameras. The method comprises processing the sensor data and the robot data to generate training data for a machine learning model. The method comprises training the machine learning model using the training data, wherein training comprises applying reinforcement learning with domain randomization in a simulation environment.

In some embodiments, the domain randomization comprises randomizing physical properties of the simulated robot including mass variations of ±15%, friction changes of ±40%, and sensor noise levels of 1-5%. The method may further comprise applying zero-shot transfer of the trained machine learning model to a physical humanoid robot without additional fine-tuning. The machine learning model may comprise a Bipedal Action Model having 10\hat{ }8 to 10\hat{ }9 parameters. Training may comprise applying one or more of reward shaping based on position matching between operator movements and robot movements, zero-velocity updates when a hand or foot is detected to be stationary, and kinematic constraints limiting estimated movements to those physically feasible based on anatomical and mechanical limits. The method may further comprise deploying the trained machine learning model on one or more of a remote computer, an edge computing node positioned proximate to the humanoid robot, and a whole body controller of the humanoid robot, with inference times under 5 ms.

The presently disclosed subject matter is further directed to a method for sensor fusion in a portable data collection apparatus to correct for drift and provide accurate pose estimation. The method comprises obtaining raw sensor data from a plurality of sensors distributed across the portable data collection apparatus, the sensors comprising joint encoders, wrist-mounted inertial measurement units, and a torso-mounted inertial measurement unit. The method comprises integrating gyroscope signals over time to estimate changes in orientation of the operator's wrists. The method comprises applying accelerometer data to correct for drift in the integrated gyroscope signal along pitch and roll axes. The method comprises fusing encoder position data with orientation signals from the inertial measurement units to correct for drift, wherein the encoders are less susceptible to magnetic interference than the inertial measurement units. The method comprises outputting a six degree-of-freedom pose estimate for each wrist of the operator relative to the operator's torso.

In some embodiments, the method comprises applying one or more of a Mahony filter, a Madgwick filter, an Extended Kalman Filter, an Unscented Kalman Filter, or a Complementary filter to combine sensor readings into a stable orientation estimate. The method may further comprise applying zero-velocity updates when a hand is detected to be stationary for more than 0.5 seconds. The method may further comprise obtaining a magnetic field map of an operating environment and adjusting sensor fusion algorithms based on detected magnetic field strength, wherein a first set of weights is applied in regions of high magnetic interference and a second set of weights is applied in regions of low magnetic interference. The method may further comprise calibrating magnetometers of the inertial measurement units at one or more of startup, predefined intervals, and continuously during operation.

The presently disclosed subject matter is further directed to a clutch system for a portable data collection apparatus configured to selectively pause transmission of control data during teleoperation of a humanoid robot. The clutch system comprises a clutch actuator configured to be activated by a human operator to pause transmission of robot control data. The clutch system comprises an intelligent clutch module configured to analyze movements of the human operator and predict pauses in a workflow of the human operator. The intelligent clutch module is configured to automatically engage the clutch during predicted pauses without requiring activation by the human operator. The intelligent clutch module comprises one or more machine learning algorithms trained on datasets of operator interactions to recognize movement patterns indicative of non-task-related actions.

In some embodiments, the movement patterns indicative of non-task-related actions comprise movements exceeding a displacement threshold of 1 meter or a velocity threshold of 2 m/s. The intelligent clutch module may be configured to detect when the operator is looking away from a primary task area for a period exceeding 3 seconds and automatically engage the clutch. The clutch system may be configured to suspend transmission of robot control data for all degrees of freedom simultaneously or for only a predefined subset of degrees of freedom while leaving other tracking active. Upon deactivation of the clutch, the clutch system may implement a ramping period of 0.5-2 seconds using velocity and acceleration limits to ensure smooth re-engagement of motion of the humanoid robot. The clutch actuator may comprise one or more of a physical button integrated into the portable data collection apparatus, a foot pedal positioned on a floor surface, a voice-activated command recognized by the system with recognition accuracy above 95%, or a gesture recognized using sensors of the portable data collection apparatus.

The presently disclosed subject matter is further directed to a display system for a portable data collection apparatus configured to present visual feedback from a humanoid robot to a human operator. The display system comprises a headset device configured to be worn on a head of the human operator, the headset device comprising a display having a refresh rate of at least 90 Hz. The display system comprises a video processing pipeline configured to receive video data from one or more cameras of the humanoid robot and transform the video data for presentation on the display. The video processing pipeline is configured to transform video data captured in a vertical stereo vision format by vertically separated cameras of the humanoid robot into a horizontally oriented stereo image suitable for human viewing on the headset device.

In some embodiments, the video processing pipeline implements one or more of geometric rectification using homography transformations, disparity re-projection, Depth Image Based Rendering, Neural Radiance Fields, 3D Gaussian Splatting, or Multi-Plane Images. The display system may further comprise eye-tracking sensors configured to track gaze direction of the human operator, and the video processing pipeline may implement foveated rendering that renders higher detail only in an area where the operator is currently looking. The foveated rendering may reduce computational load and network bandwidth requirements by 40-60%. The display system may further implement Asynchronous Timewarp or Asynchronous Spacewarp to synthesize intermediate frames when the system cannot consistently maintain a target frame rate. The display system may achieve a motion-to-photon latency of less than 20 ms. The display system may further comprise calibration procedures to ensure color accuracy within ΔE<2, geometric fidelity with distortion under 1%, and depth perception consistency within 5%.

The present disclosure provides a mobile data collection apparatus for use with a humanoid robot. The apparatus comprises a wearable base mount configured to be secured to a torso of a human operator via a harness such that the mobile data collection apparatus is carryable by the human operator during operation. The apparatus comprises a pair of articulated arms extending from opposite sides of the wearable base mount. Each articulated arm of the pair of articulated arms respectively comprises a first rigid frame link having a proximal end and a distal end, the proximal end of the first rigid frame link coupled to the wearable base mount. Each articulated arm comprises a shoulder joint comprising (i) a first shoulder joint coupler coupled to the distal end of the first rigid frame link, the first shoulder joint coupler defining a first rotational axis, (ii) a first sensor configured to measure rotation of the first shoulder joint coupler, (iii) a second shoulder joint coupler defining a second rotational axis that is substantially orthogonal to the first rotational axis, (iv) a second sensor configured to measure rotation of the second shoulder joint coupler, and (v) a shoulder joint rotator rotatably coupling the first shoulder joint coupler and the second shoulder joint coupler. Each articulated arm comprises a second rigid frame link having a proximal end and a distal end, the proximal end of the second rigid frame link coupled to the second shoulder joint coupler. Each articulated arm comprises an elbow joint coupled to the distal end of the second rigid frame link, the elbow joint comprising (i) an elbow joint coupler defining a third rotational axis and (ii) a third sensor configured to measure rotation of the elbow joint coupler. Each articulated arm comprises a third rigid frame link having a proximal end and a distal end, the proximal end of the third rigid frame link coupled to the elbow joint coupler. Each articulated arm comprises a wrist assembly comprising (i) a first wrist joint coupler coupled to the distal end of the third rigid frame link, the first wrist joint coupler defining a fourth rotational axis, and (ii) a second wrist joint coupler coupled to the first wrist joint coupler, the second wrist joint coupler defining a fifth rotational axis.

The present disclosure provides a mobile data collection apparatus for use with a humanoid robot. The apparatus comprises a wearable base mount configured to be secured to a torso of a human operator such that the mobile data collection apparatus is carryable by the human operator during operation. The apparatus comprises at least one articulated arm extending from the wearable base mount. The at least one articulated arm comprises a shoulder joint coupled to the wearable base mount, the shoulder joint comprising a first joint coupler defining a first rotational axis and a second joint coupler defining a second rotational axis. The at least one articulated arm comprises a first rigid frame link coupled to the shoulder joint. The at least one articulated arm comprises an elbow joint coupled to the first rigid frame link, the elbow joint defining a third rotational axis. The at least one articulated arm comprises a second rigid frame link coupled to the elbow joint. The at least one articulated arm comprises a plurality of joint sensors configured to obtain positional data associated with the shoulder joint and the elbow joint. The at least one articulated arm comprises a wrist assembly coupled to a distal end of the second rigid frame link.

The present disclosure further provides a mobile data collection apparatus. The apparatus comprises a wearable base mount configured to be worn on a torso of a human operator such that the mobile data collection apparatus is carryable by the human operator during operation. The apparatus comprises at least one articulated arm extending from the base mount, the at least one articulated arm comprising a plurality of rigid frame links coupled by a plurality of joints. The apparatus comprises a plurality of joint sensors, wherein each joint sensor of the plurality of joint sensors is coupled to a respective joint of the plurality of joints and configured to obtain positional data.

The present disclosure further provides a mobile data collection apparatus. The apparatus comprises a wearable base mount configured to be secured to a torso of a human operator via a harness such that the mobile data collection apparatus is carryable by the human operator during operation. The apparatus comprises left and right articulated arms extending from opposing sides of the base mount. Each articulated arm respectively comprises a first rigid frame link extending from the base mount, a second rigid frame link rotatably coupled to the first rigid frame link, and a third rigid frame link rotatably coupled to the second rigid frame link. The apparatus comprises a first limiting member and a second limiting member positioned between the first rigid frame link and the second rigid frame link, wherein the first limiting member includes a first hard stop and the second limiting member includes a second hard stop, the first and second hard stops configured to limit rotational motion of the second rigid frame link with respect to the first rigid frame link. The apparatus comprises a plurality of encoders distributed along each articulated arm at joints between the rigid frame links. The apparatus comprises a wrist assembly coupled to the third rigid frame link, the wrist assembly comprising (i) a first wrist joint member having a first rotational axis, (ii) a second wrist joint member having a second rotational axis orthogonal to the first rotational axis, and (iii) a joint coupling member connecting the first wrist joint member and the second wrist joint member.

The apparatus is a wearable teleoperation system featuring articulated arms with rigid frame links connected by joints, mounted to a base worn on a human operator's torso. Each arm includes a shoulder joint, multiple rigid frame links (some with adjustable lengths), and a wrist assembly with at least two rotational axes. The system can incorporate up to seven axes of rotation per arm, totaling fourteen axes between both arms. Joint sensors, including 14-bit absolute encoders communicating via CAN bus, capture positional data throughout the apparatus, with these sensors matching the corresponding sensors in the humanoid robot being controlled.

The distal end of each arm includes a manipulator designed to receive the operator's hand, featuring haptic buttons with 2-5 N force thresholds aligned with finger positions. The wrist assembly may include IMUs for orientation data, and the system can integrate a headset display showing video from the robot's cameras, along with optional EEG sensors. A piloting control system-housed in the wearable base mount and powered by an onboard battery-processes sensor data to generate control information (position, velocity, or torque targets) and transmits it to the humanoid robot via wireless network with end-to-end latency under 20 ms. The system also includes a clutch mechanism that can use machine learning to predict workflow pauses and automatically suspend control transmission, plus data storage for capturing sensor data to train machine learning models.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded by, control and/or be controlled by, and/or interact;

FIG. 2 is a block diagram illustrating components of the humanoid robot of FIG. 1;

FIG. 3A is a perspective view of the humanoid robot of FIGS. 1-2;

FIG. 3B is a diagram illustrating actuators contained within the humanoid robot of FIG. 13A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a schematic diagram of a portable data collection system having: (i) a humanoid robot, (ii) a mobile data collection apparatus, (iii) data storage, (iv) a secondary computer, (v) a display, and (vi) a clutch in communication directly or via a network;

FIG. 7A is a perspective view of the mobile data collection apparatus of FIG. 6, wherein the display is shown as a headset;

FIG. 7B is another perspective view of the mobile data collection apparatus of FIG. 6;

FIG. 8 is a front view of the mobile data collection apparatus of FIG. 7B;

FIG. 9 is a front view of the robot of FIG. 3A;

FIG. 10 is a top view of the mobile data collection apparatus of FIG. 8;

FIG. 11 is a top view of the robot of FIG. 9;

FIG. 12 is a side view of the mobile data collection apparatus of FIG. 8;

FIG. 13 is a side view of the robot of FIG. 9;

FIG. 14 is a detailed view of an extent of the mobile data collection apparatus of FIG. 8, showing a joint of an articulated arm and two encoders to determine the direction and height of an operator's arm;

FIG. 15 is a detailed view of an extent of the mobile data collection apparatus of FIG. 8, showing a wrist component of the mobile data collection apparatus to determine the orientation of an operator's wrist;

FIG. 16 shows a top view a first embodiment of the glove to be used with the mobile data collection apparatus of FIG. 6;

FIG. 17 is a front view of the portable data collection system showing the humanoid robot and a user wearing the mobile data collection apparatus, with both the user and robot shown in a first position;

FIG. 18 is a front view of the portable data collection system showing the humanoid robot and a user wearing the mobile data collection apparatus, with both the user and robot shown in a second position;

FIG. 19A is a perspective view of a second embodiment of the mobile data collection apparatus of FIG. 6, wherein the display is shown as a headset;

FIG. 19B is another perspective view of the mobile data collection apparatus of FIG. 19A;

FIG. 20 is a front view of the mobile data collection apparatus of FIG. 19B;

FIG. 21 is a front view of the robot of FIG. 3A;

FIG. 22 is a top view of the mobile data collection apparatus of FIG. 19B;

FIG. 23 is a top view of the robot of FIG. 22;

FIG. 24 is a side view of the mobile data collection apparatus of FIG. 19B;

FIG. 25 is a side view of the robot of FIG. 22;

FIG. 26 is a zoomed in view of the base actuation assembly of FIG. 19B;

FIG. 27 is a zoomed in view of the medial actuation assembly of FIG. 19B;

FIG. 28 is a perspective view of a second embodiment glove to be used with the mobile data collection apparatus of FIG. 19B, where the glove includes a haptic feedback controlled mechanism, an encoder, and a deformable member that extends between said haptic feedback mechanism and the encoder;

FIG. 29 is a side view of the glove of FIG. 28;

FIG. 30 is a top view of the haptic feedback controlled mechanism, the encoder, and the deformable member of FIG. 28, shown without the hand receptacle; and

FIG. 31 is a perspective view of a third embodiment of a glove to be used with the mobile data collection apparatus of FIG. 6.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The portable data collection system, which includes the mobile data collection apparatus, is configured to capture robot data from a robot that is controlled by the human operator using the mobile data collection apparatus. In an operational scenario where the system is being used to control a robot for the purpose of collecting robot data, the mobile data collection apparatus is configured to transfer pilot movement data to a computer. The pilot movement may include sensor data and other information related to the position and/or movement of the operator wearing the mobile data collection apparatus. The computer then processes the pilot movement data to generate robot control data and sends this control data to the robot in real-time. Subsequently, a data storage database collects robot data from sensors contained in the robot that relate to the positions and movements of said robot to refine and annotate the robot data into training data.

The mobile data collection apparatus provides substantial benefits over conventional systems because it is portable, lightweight, can be manufactured with speed, and is less expensive than other conventional apparatuses. For example, the mobile data collection apparatus allows the operator to collect pilot movement data while performing actual tasks that the robot may perform. This is achieved by minimizing the footprint of the apparatus and eliminating a complicated walking base, additional wires, or other electrical components, which allows the portable data collection apparatus to move with the operator as the operator walks through an environment. In some examples, the mobile data collection apparatus may be used in a robot-free configuration, where the pilot movement data collected while the operator is performing a task may be stored for later use or be converted to directed to training data.

Certain embodiments of the mobile data collection apparatus include (i) a base mount having an adjustable harness coupled thereto, (ii) left and right articulated arms that extend from opposing sides of the base mount, (iii) a plurality of encoders coupled within articulated arms and sensors configured to capture pilot movement data associated with movements of the mobile data collection apparatus, and (iv) a piloting control system including a computing device and operatively connected to the encoders of the articulated arms and other sensors. Each articulated arm includes a plurality of rigid frame links and a glove coupled at the distal ends of the links. The plurality of rigid frame links are arranged in a geometry that is similar to arrangement of arm components of the robot, forming joint connections in the articulated arms that correspond to actuator locations in the robot, where encoders are located at said joint connections. This similar configuration reduces post-data collection processing of the collected pilot movement data and, in some cases, enables the mobile data collection apparatus to collect pilot movement data without a robot. The gloves may contain additional sensors to provide additional information positional information related to the hands of the operator.

When worn by the operator, the mobile data collection apparatus: (i) can be secured to the operator via a harness coupled to the base mount, (ii) includes gloves that are designed to receive the operator's hands, and (iii) has articulated arms that extend along the operator's arms between said base mount and gloves. In certain embodiments, the articulated arms are configured to be adjusted to fit the arms of the operator for a more ergonomic fit. This design allows the operator to perform repetitive tasks and collect the significant pilot movement data needed to train the robot without overly straining the operator during the data collection process. In contrast, an alternative embodiment does not allow for adjustment of the linkages or the distances between encoders. Further, other disclosed embodiments may be custom manufactured (e.g., 3D printed) or custom modified for a specific operator based on measurements or a scan (e.g., LiDAR or video).

In some embodiments disclosed herein, the portable data collection system also includes a clutch coupled to the mobile data collection apparatus to allow the operator to pause the sending of control data from the computer to the robot. The clutch permits the operator to reposition their hands to a more comfortable or natural position before resuming the operation of the mobile data collection apparatus. This functionality prevents the hands of the robot from replicating all of the hand motions of the operator, for example, when the operator is repositioning their hands.

A majority of the robot data that is captured can be added to the training data set without substantial review and multiple manipulations or alterations of the robot data. This simplifies training data collection and data labeling, and it allows for a task to be broken down into sub-steps, where certain aspects of the training data may be reused for other tasks. For example, in a factory environment for assembling automobiles, a task may include moving one piece of sheet metal in a factory line requiring a first set of movements, and then moving a second piece of sheet metal in the factory line requiring a second set of movements, wherein a substantial number (e.g., 80%) of the first and second sets of movements are the same.

The sensors of the mobile data collection apparatus are fixed to components of the mobile data collection apparatus and are not placed by the operator. This design eliminates the potential for misplacement or substantial changes to the location of the sensors between different operators. For example, the sensors may include the encoders positioned at joints in the articulated arm and inertial measurement units (IMUs) coupled to the mobile data collection apparatus at the wrist components and the torso (i.e., at the back frame).

The mobile data collection apparatus is a cost-effective solution that does not require a complex design for training data capture. The mobile data collection apparatus simplifies the collection of training data and does not require a substantial number of additional external sensors or detection devices. The mobile data collection apparatus does not require an extensive camera setup with the proper lighting that is typically required by conventional camera-based systems. Because the pilot movement data is collected by the operator wearing the mobile data collection apparatus, there are no black-out spots that are created due to machines or other structures found in a training environment. For similar reasons, the mobile data collection apparatus does not require the quiet environment needed for an acoustic sensor system.

In some embodiments, the disclosed data collection system enables a single individual to operate and train a robot using the described mobile data collection apparatus that is both portable and easily integrated into existing systems. The apparatus is designed to be intuitive and efficient, allowing a human operator to control the robot's movements in real-time while collecting high-quality training data. Furthermore, the apparatus is designed with interoperability in mind, making it compliant with existing robotic platforms and infrastructure, thereby streamlining adoption without the need for significant modification, additional hardware, or additional safety features to be put in place.

As described above, the disclosed techniques and systems provide advantages, including improvements over traditional robot training systems with respect to real-time, low-latency motion capture and its translation to robot control. Traditional robot training systems are often bulky, expensive, and require direct control and constant access to physical robots, making data collection difficult, unsafe, or inefficient. The disclosed techniques and systems provide technical solutions to said technical problems, such as by introducing a portable, lightweight mobile data collection apparatus that allows an operator to control a robot and/or collect training data in a simulated and/or robot-free environment. The disclosed techniques and systems solve problems relating to limited training efficiency and high hardware dependency by enabling remote and passive data capture. As a result, the disclosed technology supports robot-free training and hybrid training regimes, thereby reducing reliance on traditional and costly robot demonstrations or other traditional robot training systems.

Moreover, the disclosed technology provides technical solutions to technical problems in collecting high-quality robot motion data efficiently for training machine learning models. The disclosed technology addresses this technical problem with real-time sensor data transfer, robot control, and robot feedback logging, thereby enabling precise synchronization between human motion and robot behavior. This process leads to more accurate training datasets for learning-based control systems. Existing systems may also require complex infrastructure, such as motion capture studios or heavy-duty robotic rigs. The apparatus described herein, on the other hand, removes the need for external wires, complicated walking bases, and dedicated motion capture hardware, instead allowing for deployment and use in a variety of physical spaces, including constrained or dynamic environments. The hardware components of the disclosed system therefore enable real-time streaming of positional data collected by the apparatus to a computer system that translates the pilot movement data into robot control commands. This translation improves the responsiveness and fidelity of human-robot interaction and ensures the collection of accurate data for use in training the robot to perform actions.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

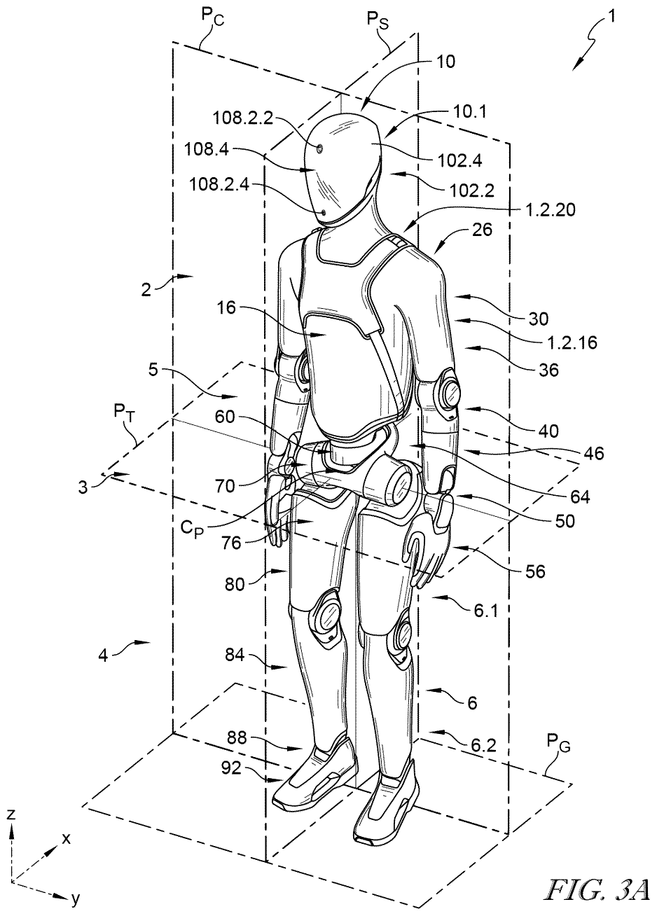

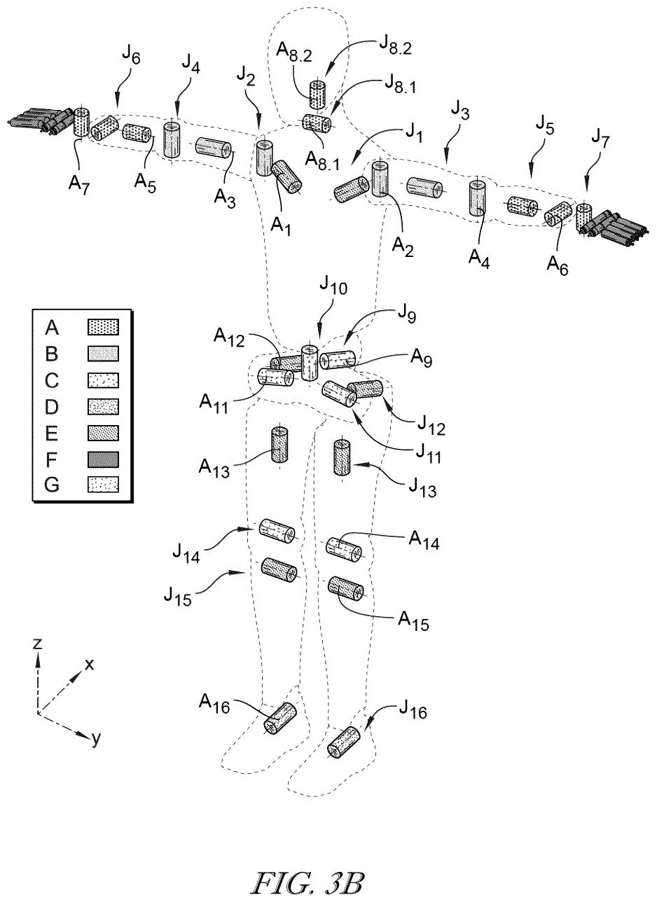

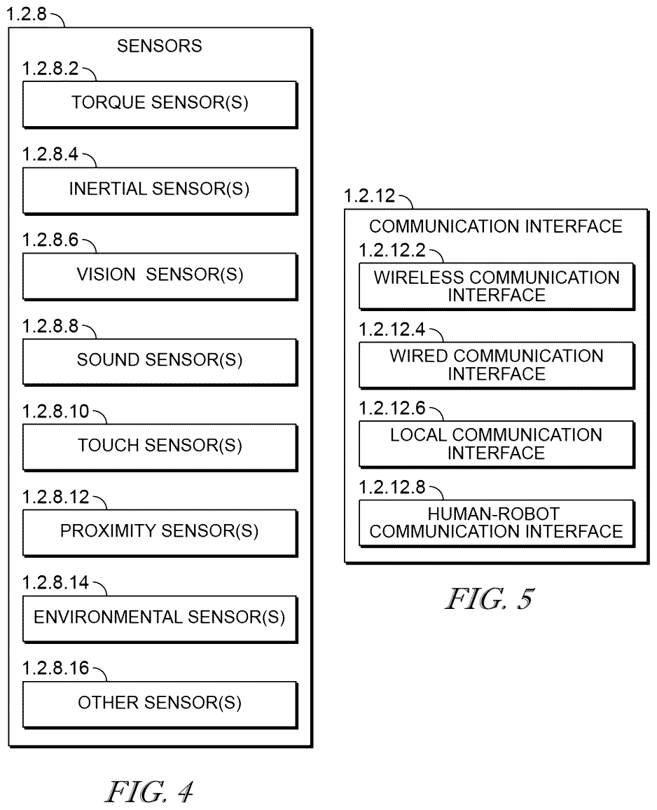

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁) and a right hip flex actuator (J11) axis (A₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

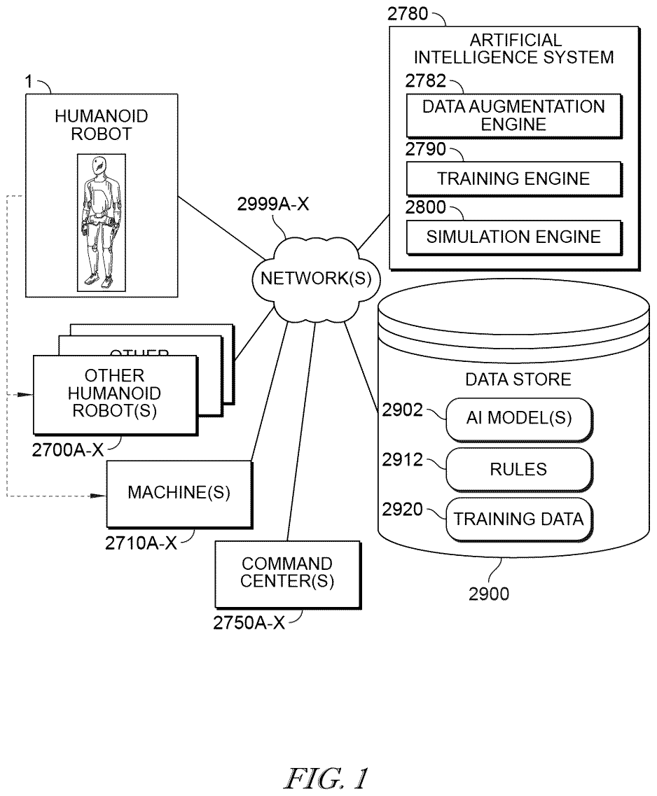

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X).

The one or more networks 2999A-X may include, for example, the Internet, a local area network, a wide area network, a private network, a cloud computing network, or a network based on a wireless communication protocol. The network 2999A-X includes, for example, the Internet, intranets, extranets, wide area networks (WANs), local area networks (LANs), wired networks, and wireless networks. For example, such networks may utilize any one of or any combination of the following technologies: (i) cellular network technologies (e.g., GSM, LTE, 1G to 5G), (ii) Wi-Fi (e.g., IEEE 802.11a, IEEE 802.11ax), (iii) bluetooth (e.g., Bluetooth Classic, Bluetooth Low Energy), (iv) low-power wide-area network (e.g., LoRaWAN, NB-IoT), (v) satellite (e.g., LEO systems like Starlink, GEO systems like Inmarsat), (vi) near-field communication (NFC) (e.g., contactless payment systems), (vii) Zigbee; (viii) Z-Wave, (ix) ultra-wideband, (x) wireless USB (e.g., Wireless USB 2.0), and/or (xi) WiMAX (e.g., WiMAX 2.0). Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of ANIL techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

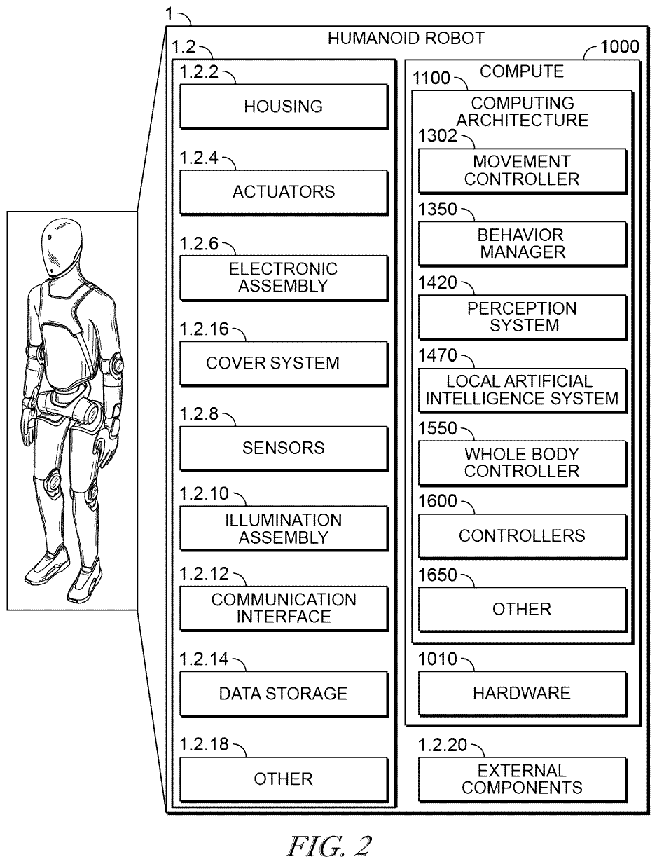

FIG. 2 is a block diagram of a humanoid robot 1 that includes a variety of architectures and other components that may include: (i) a mechanical and electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane PS but is asymmetrical about Z-Y and X-Y planes that intersect the head and are parallel to the coronal plane (PC) and the transverse plane (PT), respectively. The width (parallel to the y-axis) and depth (parallel to the x-axis) of the head 10.1 change constantly from top to bottom, reaching a maximum dimension in the temple region, which is located at approximately 30-50% of the head's height from its top end. The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 contained primarily within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1-J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1-J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm | upper arm x, upper arm roll | A₃ |
| | | twist | | |
| (J4) 374 | 2 | elbow | arm z, arm yaw, | A₄ |
| | | | lower humerus | |
| (J5) 468 | 2 | lower arm | lower arm x, lower arm roll | A₅ |
| | | twist | | |
| (J6) 484 | 2 | wrist flex | wrist/hand y, wrist/hand | A₆ |
| | | | pitch, flick | |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.
ii. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interfaces 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650. The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### E. Portable Data Collection System

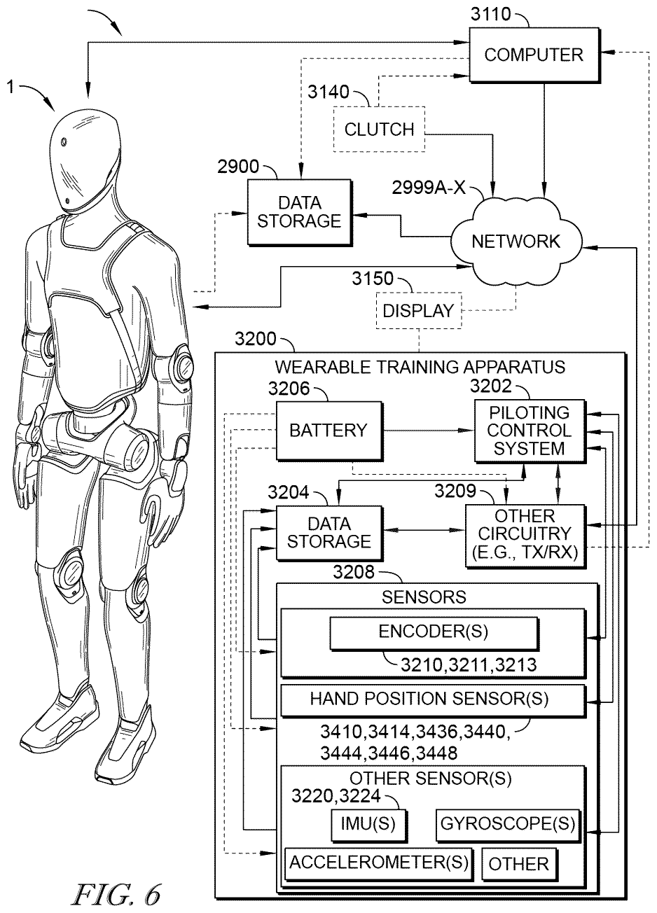

As best illustrated in FIG. 6, the portable data collection system 3010 may include: (i) a mobile data collection apparatus 3200, (ii) a computer 3110, (iii) a data storage database 2900, (iv) a clutch 3140, (v) a display 3150, which may be a headset device, and/or (vi) the robot 1 in data communication via a network 2999A-X. The data collection system 3010 includes a mobile data collection apparatus 3200 to be worn by an operator (H) (also referred to as a pilot, user, teleoperator, data collector, apparatus wearer, or human operator) to collect pilot movement data associated with the operator's movements. This pilot movement data may be utilized by a robot 1 for training models and executing teleoperation tasks. The pilot movement data may be stored locally within data storage 3204 on the apparatus 3200, stored remotely in the data storage database 2900, and/or transmitted in real-time to the robot 1 through the network 2999A-X. This data may be incorporated into training data of the robot 1 to be utilized to perform tasks in the operational environment, including manipulation tasks, locomotion patterns, and complex multi-step procedures.

The data collection system 3010 is designed to collect data derived from the movements of the operator (H) while performing various tasks and activities. Specifically, while wearing the apparatus 3200, the operator (H) generates pilot movement data that may include or relate to: (i) the position and/or movement of the operator (H) in space while performing a task, including translational and rotational components in three-dimensional space, (ii) the relative spatial locations of anatomical joint centers of rotation, including shoulder, hip, elbow, knee, wrist, ankle, and/or finger joints, (iii) the velocity and acceleration profiles of each tracked body segment, and/or (iv) any other data about the operator that is relevant to the control and training process (e.g., grip force patterns, hand orientation trajectories, or movement timing sequences). The pilot movement data may be captured at sampling rates ranging from 1 Hz to 10 kHz, with higher sampling rates providing finer temporal resolution for rapid movements. In some embodiments, the sampling rate may be dynamically adjusted based on the detected movement velocity or task complexity to optimize data quality while managing storage and bandwidth constraints.

This pilot movement data may encompass: (a) the position and movement of the operator's torso, including actions such as twisting or bending at the waist with angular measurements in roll, pitch, and yaw axes, and the operator's location within a training environment tracked through both relative and absolute positioning methods, (b) the position and movement of the arms of the operator (H), where such tracking may detail the operator's shoulder motion, elbow flexion and extension, wrist pose (defined by both position and orientation) in six degrees of freedom, and hand or finger gestures, which can be captured via gloves 3400 coupled to the mobile data collection apparatus 3200 or other sensors with sufficient resolution to distinguish individual finger movements (e.g., each joint) of the operator (H), and/or (c) the position and movement of the legs of the operator (H), where such tracking may detail the operator's hip motion, knee flexion and extension, ankle pose (defined by both position and orientation) in six degrees of freedom. In alternative embodiments, the pilot movement data may also include head position and orientation data captured through sensors integrated into the display 3150 or through separate head-mounted sensors. The tracking of leg movements may enable full-body teleoperation scenarios where the robot 1 replicates both upper and lower body motions of the operator.

The pilot movement data can be captured by the mobile data collection apparatus 3200 as sensor data, which may then be transferred to another component for further processing or storage through various communication protocols. This recipient component may be: (i) a remote computer (e.g., a command center 2750) connected via wireless or wired networks, (ii) the computer 3110 integrated with or separate from the apparatus 3200, or (iii) another computing system or architecture, such as the whole body controller (WBC) 1550 operating on compute 1000 of the robot 1. This data transfer enables the execution of instructions to generate robot control data or log data for training purposes, such as training the robot 1 itself through supervised learning methods, or training models like Bipedal Action Models (BAMs) for use in controlling the robot 1. The data transfer may occur at various rates depending on the application requirements, ranging from batch transfers for offline training to real-time streaming for teleoperation. In some embodiments, the data transfer may employ data compression algorithms to reduce bandwidth requirements while preserving data fidelity for time-sensitive teleoperation applications.

The disclosed data collection system 3010 is a cost-effective solution that may not require an overly complex mechanical design to achieve robust human data capture while maintaining high fidelity in motion tracking. This type of data collection system 3010 simplifies the overall data collection process when compared to some alternatives and may not require a substantial number of additional external sensors or environmental detection devices, such as the external cameras often utilized for tracking in traditional motion capture systems. For example, the data collection system 3010 does not inherently require an extensive external camera setup that necessitates controlled lighting, which is a common requirement for purely vision-based motion capture systems that rely on optical markers. Because the primary positional data is collected through integrated sensors directly coupled to the operator (H) wearing the mobile data collection apparatus 3200, there are generally no line-of-sight occlusion or “black-out” spots created by machines, furniture, or other structures present in the training environment. This can be a significant problem for external camera-based systems where occlusions may result in data loss or interpolation errors. In addition to avoiding such black-outs, the disclosed system is less expensive than highly complex, large-scale motion capture setups that require dedicated facilities and extensive calibration procedures.

The data collection system 3010 includes onboard sensors integrated directly into the wearable structure, and thus generally does not require a quiet acoustic environment. Additionally, the apparatus 3200 is designed to be portable as it is worn by the operator (H), relatively lightweight in comparison to full exoskeletons, and quicker to manufacture due to simpler mechanics than a full force-feedback exoskeleton which may require complex actuator assemblies. Further, the data collection system 3010 minimizes the infrastructure footprint when compared to fixed base systems and can eliminate the need for a complicated walking base simulator, numerous external wires that may restrict movement, or extensive external tracking components such as ceiling-mounted camera arrays. As a result, a large quantity of pilot movement data can be collected at a relatively low cost per hour, and this data can be used for training the robot control models (e.g., machine learning, BAM models). The portability of the apparatus 3200 also enables data collection in diverse environments, including outdoor settings, industrial facilities, and confined spaces that would be impractical for fixed motion capture installations.

a. Mobile Data Collection Apparatus

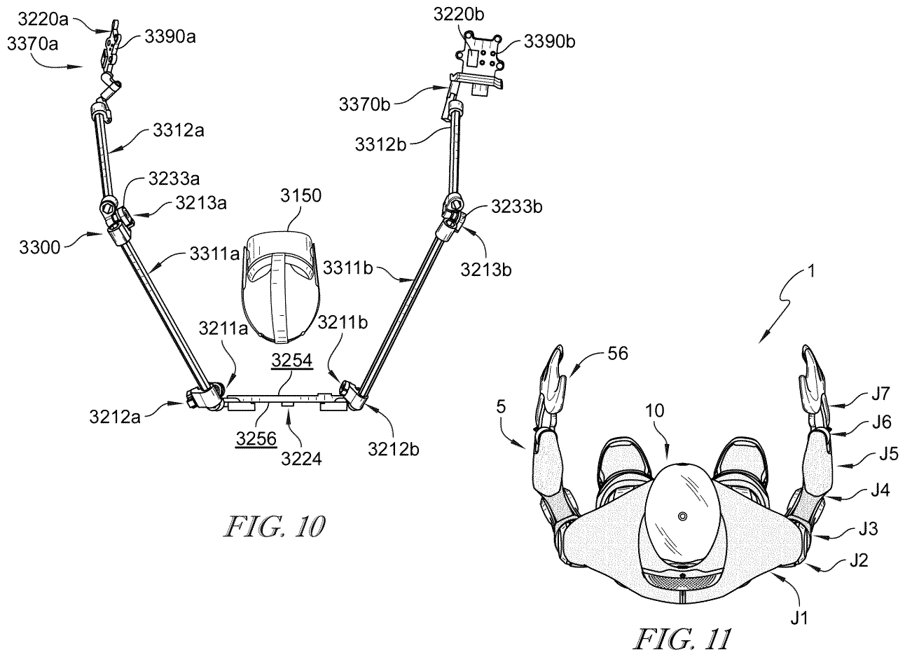

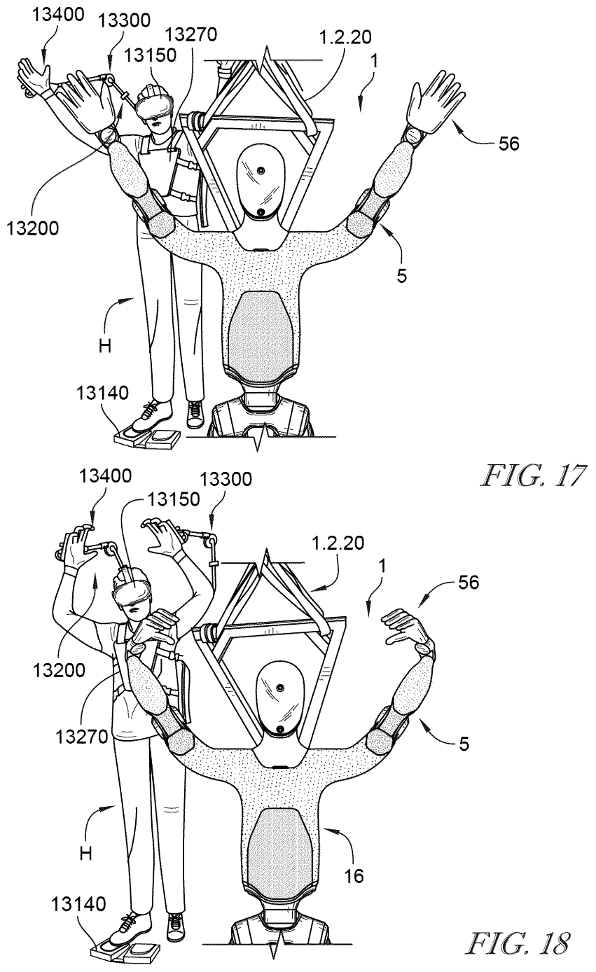

As best shown in FIGS. 6-8, 10, 12, 17, and 18, the mobile data collection apparatus 3200 includes (i) a base mount 3240, (ii) left and right articulated arms 3300 pivotably attached to the base mount 3240, (iii) a wrist assembly 3370 coupled to each articulated arm 3300, (iv) a glove 3400 coupled to the wrist assembly 3370 via a glove mount 3394, and (v) an apparatus electronics assembly 3201. The apparatus electronics assembly 3201 includes a piloting control system 3202, data storage 3204, a battery 3206, a plurality of sensors 3208, and other circuitry 3209. The mobile data collection apparatus 3200 is configured to be worn by a human operator (H) to perform data collection tasks. The operator (H) wears the mobile data collection apparatus 3200 on the back and secures it in position using the adjustable harness 3270. The operator (H) also wears the gloves 3400 on each hand to capture fine motor movements of the fingers and thumbs. The articulated arms 3300 are configured to move with the arms of the operator (H) wearing the mobile data collection apparatus 3200 as the operator (H) performs data collection tasks, where a plurality of sensors 3208 capture the position, orientation, and/or pitch of the operator's wrists and hands.

The sensors 3208 coupled to the mobile data collection apparatus 3200 include encoders 3211, 3212, 3213, IMUs 3220 and 3224, and hand sensors 3410. The encoders 3211-3213 are fixed to respective rigid frame links 3310-3312 to measure the rotational and positional movement of each rigid frame link. A torso IMU 3224 may be coupled to the base mount 3240 and wrist IMUs 3220 may be coupled to the glove mount 3394, or optionally the glove 3400, to provide information regarding the pitch and orientation of the operator's wrist. The gloves 3400 provide additional positional information for the fingers and thumbs of the operator. The pilot movement data is collected by the piloting control system 3202 as the operator (H) performs tasks. The collected pilot movement data is processed by the piloting control system 3202 and/or computer 3110 to provide robot control data to the robot 1 via the network 2999A-X to be processed by the WBC 1550 of the robot 1. The WBC 1550 utilizes the robot control data to control the actuators 1.2.4 of the robot 1 to replicate the operator's movements and sensor data from the robot 1 is collected as training data as the robot 1 performs the task.

i. Base Mount

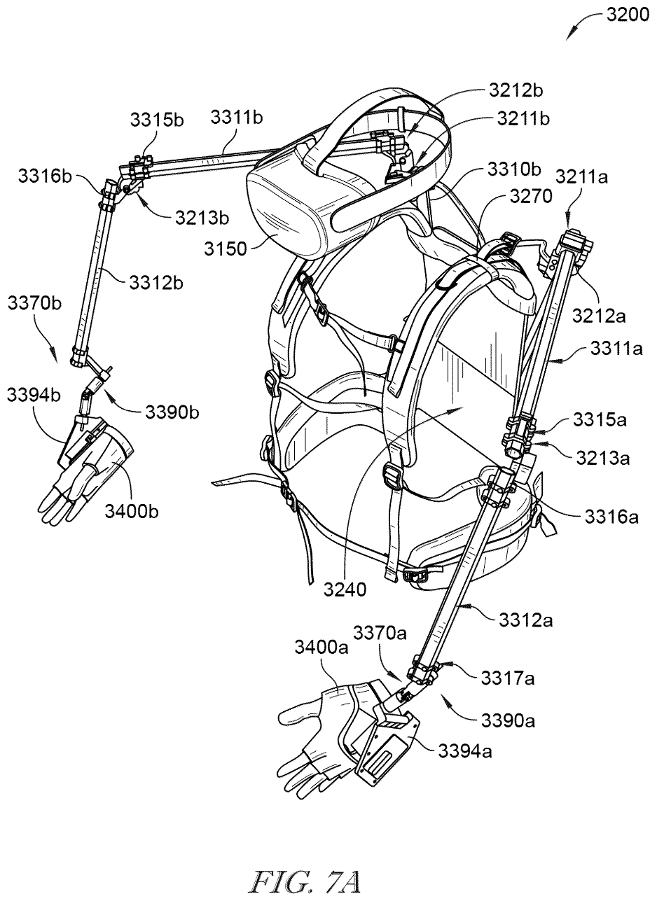

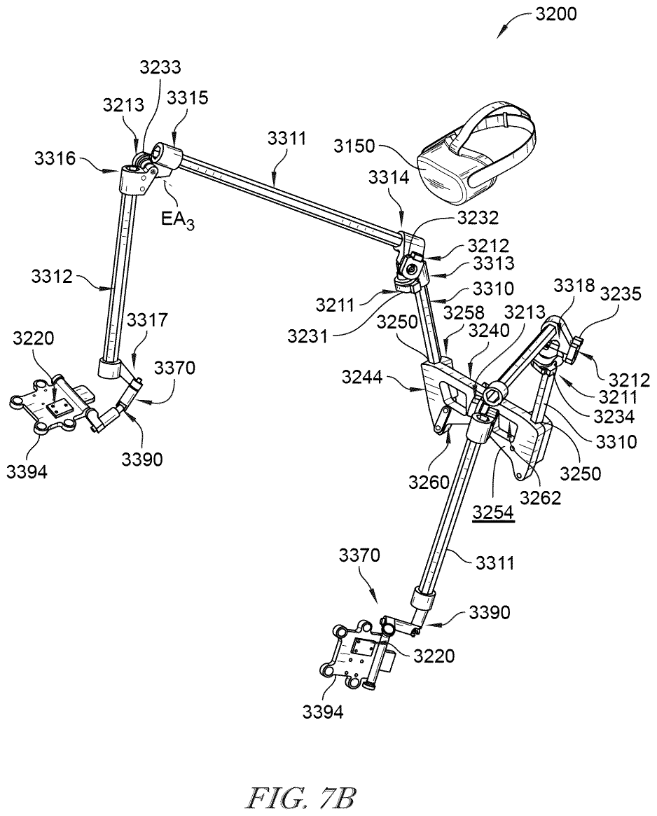

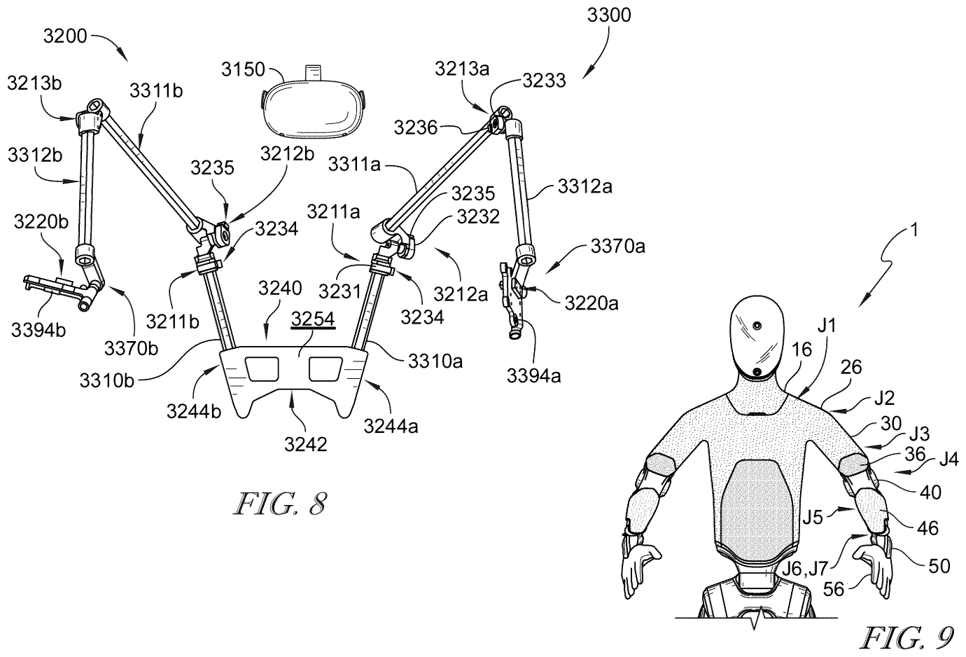

Referring to FIGS. 7A, 7B, 8, 10, and 12, the base mount 3240 of the mobile data collection apparatus 3200 includes a main support portion 3242 and left and right arm attachment portions 3244. The base mount 3240 has a first surface 3254 configured to face the operator (H) and a second surface 3256 configured to face outward from the operator (H). The main support portion 3242 is configured to extend along at least a portion of the operator's (H) back and provides structural support for the articulated arms 3300 and electronics assembly 3201. The main support portion 3242 generally extends vertically along a posterior of the torso of the operator from a first or upper end portion 3258 that has a width configured to span the operator's (H) back at least between a position below the operator's shoulders and a second or lower end portion 3260 that is configured to be positioned at or above the waist of the operator (H), for example in the operator's mid-back region. For example, the adjustable harness 3270 may include a harness component that couples to the main support portion 3242, such that the adjustable harness 3270 (e.g., backpack strap) may be worn over an extent of the torso of the operator (H), while the main support portion 3242 may span the lower back of an operator (H) at a location that is above the operator's (H) waist. In various embodiments, the adjustable harness 3270 may also couple to an extent of the articulated arms 3300 that extend from the main support portion 3242 and are positioned rearward of the operator (H).

The left and right attachment portions 3244 of the main support portion 3242 are configured to support the articulated arms 3300 and distribute the loads generated during operation. For example, the attachment portions 3244 may be coupled to the second surface 3256 or the sides of the main support portion 3242. The left and right attachment portions 3244 and the second surface 3256 cooperate to define left and right articulated arm-receiving apertures 3250 therebetween. Accordingly, the left and right attachment portions 3244 and the second surface 3256 cooperate to encase portions of the respective left and right articulated arms 3300 and provide mechanical protection for the enclosed components. The base mount 3240 is sized to generally match the size of an average human operator (H) that may train the robot 1, extending from just below the shoulder to the mid-back or waist. For example, a human operator (H) may be between 5.5 and 6.5 feet tall with one or more standard sizes of the base mount 3240, and the base mount 3240 may be manufactured in multiple size variants (e.g., small, medium, large, extra-large) to accommodate operators of different body types. In some examples, the main support portion 3242 and the attachment portions 3244 may be formed in one piece through casting, molding, or additive manufacturing processes. The base mount 3240 may also include additional cut-outs to provide attachment features 3262 for the adjustable harness 3270 and to reduce the weight of the mobile data collection apparatus 3200 without compromising the structural integrity of the base mount 3240 support structure.

Additionally, the base mount 3240 is configured to mount and/or support one or more components of the apparatus electronics assembly 3201 in a manner that protects the electronics from environmental factors and mechanical stress. For example, a torso IMU 3224 may be coupled to the main support portion 3242 as a sensor configured to obtain torso positional data, such as the orientation of the operator's torso, while the operator (H) is performing tasks. In various embodiments, the piloting control system 3202, data storage 3204, and battery 3206 may be contained in a housing and/or coupled to the second surface 3256 of the main support portion 3242. In some embodiments, the piloting control system 3202, data storage 3204, and battery 3206 may be coupled to or contained within the adjustable harness 3270 to distribute weight more evenly across the operator's body.

ii. Articulated Arms

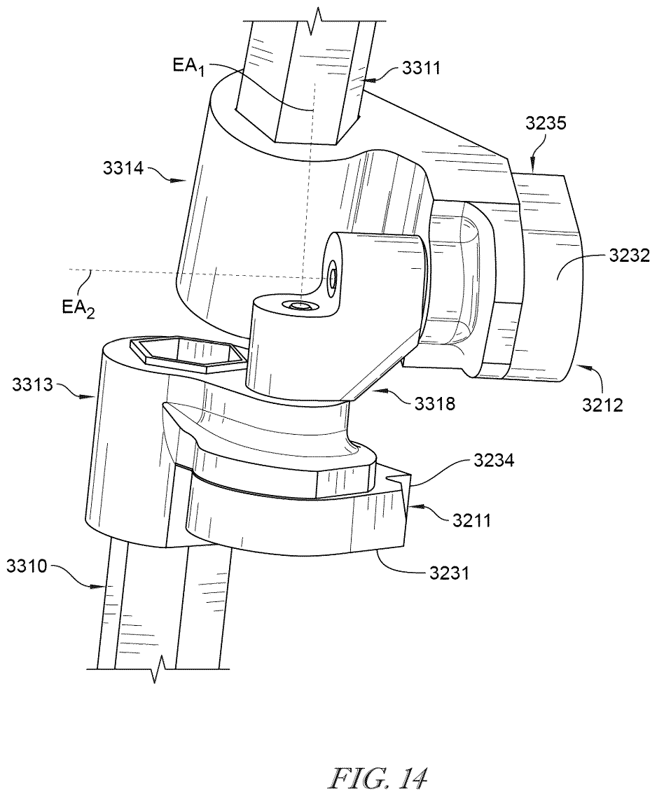

Referring to FIGS. 7A, 7B, 8, 10, and 12, left and right articulated arms 3300 extend from the attachment portions 3244 of the base mount 3240 to the wrist assembly 3370. As best shown in FIG. 7B, each articulated arm 3300 includes three (3) individual rigid frame links 3310-3312 and five (5) joint couplers 3313-3317 interconnecting the individual rigid frame links 3310-3312 and the third individual rigid frame link 3312 to the wrist assembly 3370. Each articulated arm 3300 also includes a joint rotator 3318 interconnecting the first joint coupler 3313 and the second joint coupler 3314 (FIG. 14). The first four joint couplers 3313-3316 and the joint rotator 3318 cooperate to define joint connections between the individual rigid frame links 3310-3312 and the fifth joint coupler 3317 defines a joint connection between the third individual rigid frame link 3312 and the wrist assembly 3370. The mobile data collection apparatus 3200 includes joint sensors, such as encoders 3211-3213, at some of the joint connections, wherein the encoders may be absolute encoders or incremental encoders depending on the precision requirements and power consumption constraints. The left and right articulated arms 3300 substantially mirror each other in size, position, and configuration to provide symmetric operation for both arms of the operator (H). The rigid frame links 3310-3312 may have a fixed length or adjustable lengths to accommodate operators with different arm lengths. In embodiments where the rigid frame links 3310-3312 have adjustable lengths, each rigid frame link 3310-3312 may have two or more telescopic adjustable segments configured to be secured together at different positions, thereby providing for an adjustable length of the rigid frame link to accommodate the size of the operator's arms and upper torso.

The first individual rigid frame link 3310 of each articulated arm 3300 is fixed to the base mount 3240 and provides a stable foundation for the kinematic chain. For example, the first individual rigid frame link 3310 may be fixed to the base mount 3240 at a proximal end between the second surface 3256 of the main support portion 3242 and the respective left or right attachment portion 3244. The first individual rigid frame link 3310 extends upward and outward from the upper end portion 3258 of the main support portion 3242 to couple to the first joint coupler 3313 at a distal end. In other words, the first individual rigid frame link 3310 is not perpendicular to the upper edge of the base mount 3240 or the support surface that the operator is standing on; instead, said first individual rigid frame link 3310 is angled (between 1 degree and 70 degrees, preferably between 30 degrees and 55 degrees) relative to the upper edge of the base mount 3240 or the support surface that the operator is standing on. The angle of the first individual rigid frame link 3310 allows the base mount 3240 to have a minimized footprint while positioning the subsequent joints near the operator's shoulder region. The first individual rigid frame link 3310 is configured to extend upwardly along the operator's upper back to or above the operator's scapula and/or shoulder. In other embodiments, the first individual rigid frame link 3310 may only extend upward and not outward. In this alternative embodiment, the first individual rigid frame link 3310 may be positioned at a 90 degree angle relative to a support surface or a transverse plane.

The first joint coupler 3313 is fixed to the first individual rigid frame link 3310 and coupled to the joint rotator 3318, forming a robust mechanical connection that withstands repeated movements. A first encoder 3211 is coupled to the first joint coupler 3313 to determine the direction of the operator's arm with high precision. In the illustrative embodiment, the first encoder 3211 may be coupled to or contained within a first limiting member 3231 coupled to the first joint coupler 3313. Accordingly, the first encoder 3211 is arranged at or above the operator's scapula and/or shoulder. As such, the upper edge of the first individual rigid frame link 3310, the first joint coupler 3313, and/or the first encoder 3211 may be positioned below the operator's clavicle. In other embodiments, the upper edge of the first individual rigid frame link 3310, the first joint coupler 3313, and/or the first encoder 3211 may be positioned below the operator's scapula or shoulder, or positioned above the operator's clavicle depending on the specific anthropometric requirements.

Referring to FIG. 14, the joint rotator 3318 is rotatably coupled to the first joint coupler 3313 and the second joint coupler 3314 to enable multi-axis rotation at this joint location. The joint rotator 3318 cooperates with the first joint coupler 3313 to define a yaw axis EA₁ about which the joint rotator 3318 rotates. The yaw axis EA₁ is parallel to the first individual rigid frame link 3310 and enables rotational movement corresponding to internal and external rotation of the operator's arm. The joint rotator 3318 also cooperates with the second joint coupler 3314 and/or a second encoder 3212 to define a first pitch axis EA₂ about which the second joint coupler 3314 and/or the second encoder 3212 rotates to determine the height of the operator's arm. The first pitch axis EA₂ is orthogonal to the yaw axis EA₁, forming a two-degree-of-freedom joint at this location. The second encoder 3212 is coupled to the second joint coupler 3314 to measure rotation about the first pitch axis EA₂. In the illustrative embodiment, the second encoder 3212 may be coupled to or contained within a second limiting member 3232 coupled to the second joint coupler 3314. Due to the positional relationship of the first joint coupler 3313 and the second joint coupler 3314, said the second joint coupler 3314 may be positioned below the operator's clavicle and/or at or above the operator's scapula and/or shoulder. In other embodiments, the second joint coupler 3314 may be positioned below the operator's scapula or shoulder or positioned above the operator's clavicle.

As best shown in FIG. 14, the first and second limiting members 3231, 3232 are arranged to prevent over rotation, such that the movements of the operator (H) do not exceed the range of motion of the robot 1 and to protect the mechanical components from damage. The first and second limiting members 3231, 3232 include hard stops 3234, 3235 configured to limit the rotational motion of the second individual rigid frame link 3311 with respect to the first individual rigid frame link 3310. In the illustrative embodiment, the first limiting member 3231 coupled to the first joint coupler 3313 may include a hard stop 3234 with a limit face 3237 positioned to engage with a second limiting member 3232 coupled to the second joint coupler 3314. Similarly, the second joint coupler 3314 may include a hard stop 3235 with a limit face 3238 positioned to engage with a first limiting member 3231 coupled to the first joint coupler 3313, providing bidirectional motion limitation.

The second individual rigid frame link 3311 of each articulated arm 3300 is fixed to the second joint coupler 3314 at a proximal end and extends outwardly away from the operator's torso to couple to the third joint coupler 3315 at a distal end. The second individual rigid frame link 3311 rotates with the second joint coupler 3314 and/or the second encoder 3212 about the first pitch axis EA₂, and the length of this link generally corresponds to the upper arm length of the operator (H). A third encoder 3213 is coupled to the third joint coupler 3315 to determine the reach of the operator's arm and measure elbow-like flexion and extension movements. In the illustrative embodiment, the third encoder 3213 may be coupled to or contained within a third limiting member 3233 coupled to the third joint coupler 3315, where the third limiting member 3233 may include a hard stop 3236 with a limit face 3239 positioned to engage with a fourth joint coupler 3316. The fourth joint coupler 3316 is rotatably coupled to the third joint coupler 3315 and/or the third encoder 3213 to enable elbow-like motion. The fourth joint coupler 3316 cooperates with the third joint coupler 3315 and/or the third encoder 3213 to define a second pitch axis EA₃ about which the fourth joint coupler 3316 rotates. The second pitch axis EA₃ is orthogonal to the yaw axis EA₁ and parallel to the first pitch axis EA₂, which maintains a consistent kinematic structure. The second pitch axis EA₃ and first pitch axis EA₂ being parallel allows for more accurate determinations of the height and reach of the arm through simplified kinematic calculations.

The third individual rigid frame link 3312 of each articulated arm 3300 is fixed to the fourth joint coupler 3316 at a proximal end and is fixed to the fifth joint coupler 3317 at a distal end. The third individual rigid frame link 3312 rotates with the fourth joint coupler 3316 about the second pitch axis EA₃, and the length of this link generally corresponds to the forearm length of the operator (H). The yaw axis EA₁, the first pitch axis EA₂, and the second pitch axis EA₃ cooperate to define three degrees of freedom of each of the left and right articulated arms 3300. The fifth joint coupler 3317 is coupled to the third individual rigid frame link 3312 and the wrist assembly 3370, providing a transition from the articulated arm structure to the wrist assembly that tracks hand orientation. As shown in the Figures, none of the rigid frame links are directly coupled to the operator. This allows the operator to move freely without being restricted by the data collection apparatus.

iii. Wrist Assembly

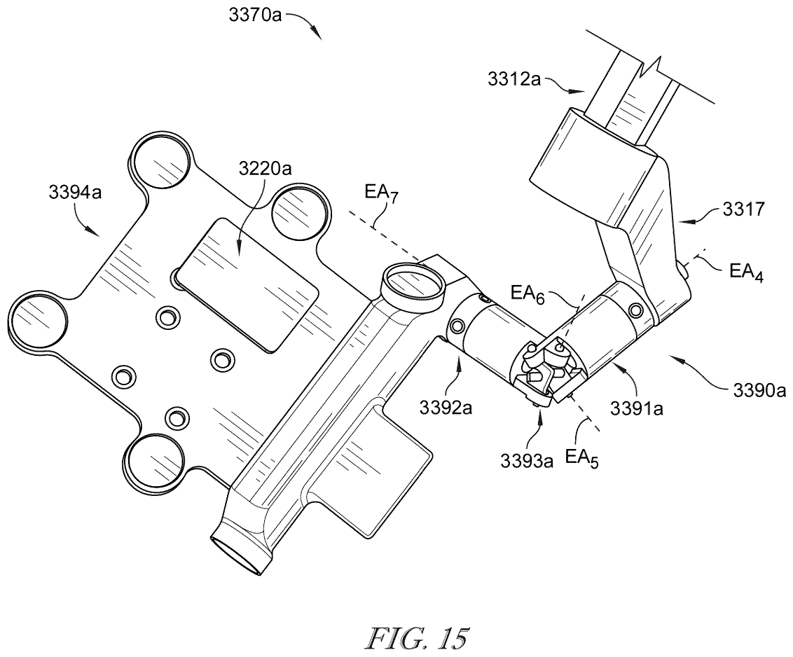

Referring to FIG. 15, the wrist assembly 3370 includes a wrist component 3390 and a glove mount 3394, where the glove mount 3394 is further configured to couple with the glove 3400 to enable tracking of hand position and orientation. Optionally, an IMU 3220 may be coupled to the glove mount 3394 and/or the glove 3400 to provide additional orientation data through inertial sensing. The wrist assembly 3370 is coupled to the fifth joint coupler 3317 at the distal end of the third rigid frame link 3312, where joint coupler 3317 is configured to position the wrist component 3390 away from the third rigid frame link 3312 to reduce interference with natural hand movements. In the illustrative embodiment, the wrist component 3390 comprises a first joint member 3391 and a second joint member 3392 interconnected by a joint coupling member 3393 and having rotational axes oriented at 900 to each other. This arrangement provides four degrees of freedom (DoF), enabling a wide range of complex movements for positioning the operator's hand in the glove 3400.

In particular, the proximal end of the first joint member 3391 is pivotably coupled to the fifth joint coupler 3317, establishing a pivotal connection that defines a fourth apparatus axis EA₄. The distal end of the first joint member 3391 connects to the second joint member 3392 via the joint coupling member 3393 to create a compound joint structure. Specifically, the distal end of the first joint member 3391 pivotably couples with the joint coupling member 3393, defining a fifth apparatus axis EA₅, and a proximal end of the second joint member 3392 couples with the joint coupling member 3393, defining a sixth apparatus axis EA₆, where axis EA₆ and axis EA₅ are perpendicular to each other to enable complex wrist articulations. The distal end of the second joint member 3392 pivotably couples to the glove mount 3394, establishing a seventh apparatus axis EA₇. Accordingly, the wrist component 3390 provides four (4) degrees of freedom about axes EA₄-EA₇, which together with the three degrees of freedom from the articulated arm 3300 provides seven total degrees of freedom for each arm.

Although the apparatus axes EA₁-EA₇ may provide a range of motion similar to the robot 1, there is not a direct correlation between the apparatus axes EA₁-EA₇ and rotational axes A₁-A₇ of the robot 1 due to differences in mechanical configuration and joint placement. Instead, using the known geometry of the articulated arms and positioning sensors 3208, the collected pilot movement data may be converted to robot control data, based at least in part on the geometric relationship of the sensors 3208 through kinematic transformation algorithms. In some examples, the fourth axis EA₄ may represent a roll axis analogous to the pronation and supination of the human forearm. The fifth axis EA₅ may represent a pitch axis (flexion-extension) of the wrist and the sixth axis EA₆ may represent a yaw axis (abduction-adduction) of the wrist. Finally, seventh axis EA₇ may represent a further roll axis for rotation of the hand about its longitudinal axis.

In the illustrative embodiment, the wrist component 3390 may include a Cardan joint or universal joint pivotably coupled between the fifth joint coupler 3317 and the glove mount 3394 to provide smooth and continuous rotation. The cardan joint may be formed from a combination of U-joints arranged in series. In other embodiments, the wrist component 3390 may include a triple cardan joint that is formed by adding a third universal joint in series with a double U-joint to provide an additional rotational axis or translational movement for enhanced flexibility. In another embodiment, the joint coupling member 3393 may be a spherical or ball-and-socket joint with a prismatic joint. The spherical joint allows for rotation in all directions around a single point where the joint members 3391, 3392 meet, while a prismatic joint allows for linear movement along an axis to accommodate variations in arm length during movement.

In some embodiments, the joint coupling member 3393 may be a gimbal mechanism with a prismatic joint for enhanced range of motion. The gimbal mechanism may include three nested rings, each allowing rotation along a different axis, and may be combined with a prismatic joint to achieve 4 degrees of freedom. In other embodiments, the joint coupling member 3393 may be a Stewart platform (Hexapod) having limited actuation for precise positioning. Traditional Stewart platforms provide 6 degrees of freedom (3 translational+3 rotational) using actuators in parallel. However, the disclosed Stewart platform may be designed or constrained to move in 4 degrees of freedom by limiting its actuation, providing both rotational and translational capabilities similar to a double U-joint but with more freedom. In another embodiment, the joint coupling member 3393 may be a spherical parallel mechanism with an additional prismatic joint.

In other embodiments, the joint coupling member 3393 may be a modified spherical joint with helical motion where rotation along one axis also generates linear movement through mechanical coupling. This adds a fourth degree of freedom to a spherical joint while maintaining a compact form factor. In some embodiments, the joint coupling member 3393 may be a four-bar linkage with additional rotation, such as a rotary joint, to provide four degrees of freedom while using simple mechanical components. In some embodiments, the joint coupling member 3393 may be a cylindrical joint with an additional rotational joint for combined rotary and linear motion. The cylindrical joint may provide rotational movement around a single axis and a sliding motion along the same axis. In another embodiment, the joint coupling member 3393 may be a Watt's linkage with a rotational or prismatic joint. The Watt's linkage is a parallel mechanism used to constrain motion in a particular direction while allowing some flexibility. A rotational or prismatic joint is added to the Watt's linkage to provide 4 degrees of freedom, mimicking the function of a double U-joint but with added flexibility. In other embodiments, the joint coupling member 3393 may be a spherical parallel mechanism with an additional prismatic joint for enhanced positioning capability. The spherical parallel mechanism may include multiple parallel arms that control the movement of an end-effector. They may provide multi-axis rotational freedom (3 degrees of freedom), and the addition of a prismatic joint allows for 4 degrees of freedom.

iv. Distal Manipulator

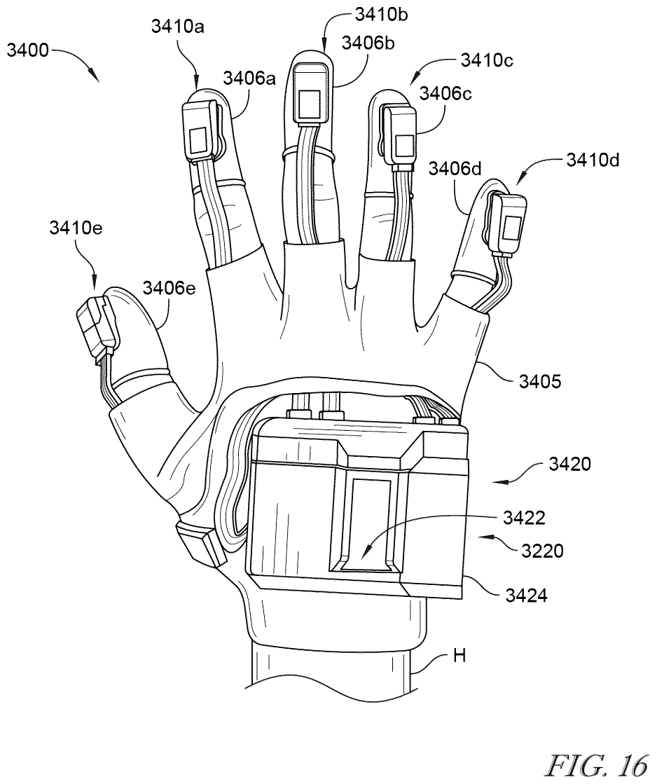

Referring to FIG. 16, the portable data collection system 3010 may include a distal manipulator (otherwise referred to as a glove) 3400 coupled to the articulated arm 3300 at the distal manipulator mount (otherwise referred to as a glove mount) 3394 through a mechanical interface designed for quick attachment and removal. The glove 3400 is configured to be worn on the hand of an operator (H) to capture the location data of the operator's hand, palm, and/or fingers with sufficient resolution for dexterous manipulation tasks requiring fine motor control. The glove 3400 is the only location on that the operator's arms are directly coupled to the data collection apparatus. In other words, if the operator removed their arms from the distal manipulators, the articulated arms will fall towards the support surface, as they are not supported by any other aspect of the operator.

The glove 3400 includes a hand receptacle 3405, a glove sensor assembly 3420, and a housing 3424 coupled to the hand receptacle 3405, where the housing 3424 is configured to (i) enclose at least a portion of the glove sensor assembly 3420 and (ii) provide a mounting surface 3422 configured to couple with the glove mount 3394 using quick-release mechanisms. The hand receptacle 3405 may be made from a textile material and formed to surround and fit at least a portion of a human hand comfortably during extended use. The gloves 3400 may include a magnetic field-generating apparatus designed to collect training material by accurately tracking the position and rotation of a human operator's wrist and fingers in three-dimensional space with millimeter-level position accuracy and degree-level orientation accuracy.

In the illustrative embodiment, the glove sensor assembly 3420 may include a magnetic field-generating apparatus 3412 (e.g., a first component) and a plurality of hand position sensors 3410 (e.g., a second component or set of components). The magnetic field-generating apparatus 3412 generates a magnetic field with controlled characteristics and may be contained in the housing 3424 with appropriate shielding to minimize interference. The hand position sensors 3410 may be positioned on or over the operator's hands and fingers for field detection with high sensitivity. As shown in FIG. 16, a set of hand position sensors 3410 may be positioned at the tips of the fingers and thumb (e.g., 3410a-3410e) for capturing fine motor movements with high spatial resolution. In the illustrative embodiment, the hand receptacle 3405 is fingerless, and the sensors 3410a-3410e are positioned on fingertip receptacles 3406 to conform more closely with the hand of the operator (H) while allowing tactile feedback. In other embodiments, the sensors 3410a-3410e may be coupled directly to a hand receptacle that extends to include the fingers and thumb of the operator (H). In some embodiments, the glove 3400 may also include one or more palm sensors 3414 located at the palm of the glove to provide additional data on hand orientation or alternative sensors for additional positional information, such as grip force or contact pressure.

The magnetic field-generating apparatus 3412 (e.g., a first component) includes an electromagnetic field (EMF) source configured to emit controlled EMF signals over a defined space around the operator's hand, typically encompassing a volume of 30×30×30 centimeters that covers the full range of hand and finger movements. These EMF signals are generated continuously or at predetermined intervals, utilizing specific frequencies and modulation schemes optimized to minimize interference and maximize detection accuracy while maintaining compliance with electromagnetic compatibility standards. For example, the EMF source may operate within a low-frequency range between 10 kHz and 200 kHz, allowing adequate field penetration through biological tissue and reducing susceptibility to environmental noise from common electronic devices. Modulation schemes, such as frequency modulation (FM) with deviation ratios of 5-10, amplitude modulation (AM) with modulation indices of 0.5-0.9, or phase-shift keying (PSK) with phase shifts of 90-180 degrees, may be used to encode synchronization information and unique identifiers within the EMF signals. The EMF source contains an integrated processor with computational capabilities of 100-1000 MIPS and memory of 256 KB-4 MB that manage operational instructions, control signal generation parameters (e.g., frequency stability within ±0.01%, amplitude control within ±1%, and waveform shape with harmonic distortion less than 1%), and analyze data received from the sensors with latencies under 1 millisecond.

The hand position sensors 3410 (e.g., a second component) are coupled to the operator's hands and wrists that detect EMF signals from the EMF source with high sensitivity and selectivity for accurate position determination. These sensors may include magnetic flux density sensors with sensitivities of 1-100 nT, magnetic field strength sensors measuring fields from 0.1-100 μT, Hall effect sensors with voltage sensitivities of 1-5 mV/mT, and inertial measurement units (IMUs) with gyroscope ranges of 2000 degrees/second and accelerometer ranges of 16 g, all operating at a high sampling frequency—at least six times, preferably eight times, and most preferably ten times the highest frequency component of the EMF signals—to capture rapid movements accurately without aliasing. For instance, if the highest frequency component of the EMF signal is 100 kHz, the sensors may sample at 600 kHz to 1 MHz to ensure Nyquist criteria are exceeded and prevent frequency folding artifacts. The sensors are strategically placed on the fingers, back of the hands, and wrists to capture precise movement and orientation data, with typical sensor spacing of 20-30 mm, and may include magnetometers capable of measuring the amplitude, phase, and frequency of the EMF signals with high precision including amplitude resolution of 12-16 bits and phase resolution better than 0.1 degrees. These sensors may employ technologies such as anisotropic magnetoresistance (AMR) with resistance changes of 2-3% per applied field or giant magnetoresistance (GMR) with resistance changes of 10-20% for enhanced sensitivity. Integrated IMUs provide additional data on angular velocity with resolution better than 0.01 degrees/second and linear acceleration with resolution better than 0.001 m/s², enhancing the overall accuracy of tracking through sensor fusion algorithms.

Communication between the sensors 3410 and the magnetic field-generating apparatus 3412 may occur via wired connections transmitting analog signals with bandwidths of 1-10 MHz or digital signals at data rates of 1-100 Mbps, or through wireless communication protocols, such as Bluetooth Low Energy (BLE) with data rates of 1-2 Mbps, Wi-Fi Direct supporting 250 Mbps, Zigbee at 250 kbps, or other suitable wireless technologies providing adequate bandwidth and low latency. Wired connections are typically designed with lightweight, flexible cables weighing less than 50 grams to minimize user encumbrance, while wireless connections use low-power transceivers consuming 10-100 mW to conserve battery life and extend operation to 8-12 hours. The choice of communication method is based on factors such as data bandwidth requirements (typically 100 kbps to 10 Mbps per sensor), power consumption constraints (total system power under 5 W), latency requirements (end-to-end latency under 10 ms), and environmental considerations including electromagnetic interference levels. In some embodiments, a hybrid approach may be employed where high-bandwidth sensor data is transmitted via wired connections while control signals and status information use wireless communication.

To determine the position of the operator's hands and wrists, the system analyzes detected EMF signals in conjunction with known properties of the emitted field using specialized algorithms and models implemented in real-time processing hardware. The system measures signal strength attenuation, where the intensity of the EMF signal decreases with distance from the source according to known physical laws, such as the inverse-square law in far-field conditions (distances greater than λ/2π) or more complex near-field equations for distances less than one wavelength of the EMF signal. By measuring the amplitude of the received EMF signals at each sensor with dynamic ranges of 60-80 dB, the system can calculate the approximate distance d between the EMF source and each sensor using calibration curves or mathematical models with accuracies better than 1 mm. Additionally and/or alternatively, phase difference measurement calculates precise distances by analyzing the phase shift between the emitted and received continuous-wave EMF signals with phase measurement accuracies of 0.1-1 degree. The phase difference φ is related to the distance d by φ=(2πd)/λ, where λ is the wavelength of the EMF signal, typically 1.5-30 meters for the operating frequency range. Measuring the phase difference allows for precise distance calculations with millimeter-level accuracy, especially when combined with multiple frequency signals to resolve ambiguity through techniques such as dual-frequency phase unwrapping.

The system may combine magnetic field vector analysis with IMU data to further refine or specify the rotation of the human's wrist and/or finger through complementary filtering techniques that leverage the strengths of each sensor type. Magnetic field vector measurements reveal the field's direction in three-dimensional components (Bₓ, B_{y}, B_z) at each sensor location with vector magnitude accuracies of 1-2% and direction accuracies of 1-2 degrees, which provides information about the sensor's orientation relative to the EMF source. IMUs add real-time data on angular velocity (gyroscope) with bias stability better than 1 degree/hour and linear acceleration (accelerometer) with bias stability better than 1 mg, enabling tracking of rotational movements (roll, pitch, yaw) with update rates of 100-1000 Hz and correcting for drift over time through zero-velocity updates when stationary conditions are detected. Advanced sensor fusion algorithms, such as Extended Kalman Filters (EKF) with 15-21 state variables or Complementary Filters with tunable time constants of 0.5-5 seconds, integrate data from magnetometers and IMUs, refining and stabilizing orientation estimates of the hands and fingers to achieve accuracies better than 2 degrees RMS. Further, it should be understood that the system may use a combination of the above described algorithms, models, and/or techniques, and/or any one of the above described algorithms, models, and/or techniques in connection with any other known algorithm, model, and/or technique such as Madgwick filters, Mahony filters, or neural network-based sensor fusion. It should be understood that other algorithm(s), model(s) and/or technique(s) that enable said system to determine the rotation and/or pose of the operator's body parts (e.g., wrist and/or fingers) based on the data collected from the wearable magnetic field-generating apparatus may be utilized by said the portable data collection system 3010, including machine learning models trained on labeled motion capture data.

The algorithm(s), model(s) and/or technique(s) may run on a processor within the EMF source (e.g., magnetic field-generating apparatus 3412) or an external computing architecture (e.g., computer 3110) with computational capabilities of 1-10 GFLOPS in order to process the collected sensor data in real time or near real time with latencies under 5 milliseconds. The system may also implement digital signal processing techniques, including filtering (e.g., low-pass filters with cutoff frequencies of 10-100 Hz, high-pass filters at 0.1-1 Hz, band-pass filters centered on signal frequencies) with filter orders of 2-8 and calibration procedures performed every 100-1000 measurements, remove noise with SNR improvements of 10-20 dB, correct sensor biases with residual errors under 1% of full scale, and adapt to environmental changes such as temperature fluctuations of 20° C. or electromagnetic interference from nearby electronics operating at various frequencies. Further, the system may also use sensor fusion algorithms to further refine position and orientation estimates by accounting for sensor noise characteristics (white noise, flicker noise, random walk) and real-time dynamic conditions including accelerations up to 10 g. Finally, machine learning models with 10⁴ to 10⁶ parameters may also be used by the system to recognize specific movement patterns or gestures from a library of 50-500 trained gestures, enhancing tracking accuracy to 95-99% recognition rates and responsiveness with recognition latencies under 50 milliseconds.

The magnetic field-generating apparatus 3412 may perform environmental mapping to record variations in field strength and direction within the operational volume, creating a baseline reference with spatial resolutions of 10-50 mm to adapt the system dynamically to changing conditions. For example, environmental mapping can account for metallic objects causing field distortions of 10-50%, magnetic interference from power lines at 50/60 Hz, or structural anomalies that may distort the EMF field by up to 30% in localized regions. Additional stationary sensors may be placed in the operator's environment at distances of 0.5-2 meters to extend coverage to larger workspaces and provide spatial orientation references, improving error correction capabilities by supplying extra data points for the algorithms to process, reducing position errors by 30-50%. The environmental mapping may be performed prior to using the system with calibration times of 1-5 minutes or may be used to actively adjust for changing conditions that may occur as the human is walking around their environment, with adaptive updates every 10-100 milliseconds.

The glove 3400 provides accurate, real-time tracking of wrist and finger positions and rotations with update rates of 100-1000 Hz and latencies under 10 milliseconds, making it suitable for applications such as training data collection for humanoid robots requiring precise manipulation data, interactive control systems demanding responsive feedback, and immersive virtual and augmented reality environments needing natural hand interaction. This system leverages controlled EMF signal generation with field uniformity better than ±5%, high-frequency sensing at rates exceeding Nyquist requirements, sophisticated processing algorithms achieving sub-millimeter accuracies, and adaptive environmental mapping compensating for field distortions, overcoming limitations of conventional tracking methods that rely on external cameras or markers and are vulnerable to occlusions affecting 10-30% of the capture volume or lighting conditions requiring illumination levels above 500 lux. In one implementation, the apparatus complies with regulatory standards for electromagnetic emissions, as set by the Federal Communications Commission (FCC) Part 15 regulations or the International Commission on Non-Ionizing Radiation Protection (ICNIRP) guidelines, maintaining emissions below −50 dBm in restricted bands.

Designed to minimize interference with other devices through frequency selection and shielding, the EMF source operates within safe exposure limits for human use, maintaining specific absorption rates (SAR) below 1.6 W/kg. The apparatus's ergonomic design ensures user comfort during extended use sessions of 4-8 hours, with lightweight materials totaling less than 200 grams per glove and adjustable fittings that conform to various user sizes from 5th to 95th percentile hand dimensions and preferences including adjustable strap tensions and padding thicknesses. The components are embedded in gloves constructed from breathable fabrics or wearable straps with moisture-wicking properties that attach securely to the hands and wrists, and the apparatus is powered by rechargeable lithium polymer batteries with capacities of 1000-3000 mAh and efficient power management achieving consumption rates under 2 W to extend operational duration to 6-12 hours. The apparatus also includes quick-release mechanisms with release forces of 20-50 N for easy donning and removal in under 30 seconds, making it adaptable for continuous or extended use in diverse environments including indoor laboratories, outdoor training areas, and industrial settings, providing a comprehensive solution for precise motion tracking in three-dimensional space with position accuracies of 1-3 mm and orientation accuracies of 1-3 degrees. In other embodiments, the distal manipulator may be a remote trigger with a plurality of buttons, wherein said buttons can be used to trigger a grasp (e.g., pinch, power, etc.) by the robot 1.

v. Sensors of the Apparatus

The mobile data collection apparatus 3200 can include a plurality of sensors 3208 and other circuitry 3209 for signal conditioning and data processing. The plurality of sensors 3208 include encoders 3211-3213 (e.g., actuator encoders), wrist inertial measurement units (IMUs) 3220 and a torso IMU 3224, and hand position sensors 3410. The mobile data collection apparatus 3200 may also include additional sensors (e.g., IMU, GPS, etc.) to capture other sensor data while the operator (H) is performing data collection tasks while wearing the apparatus 3200. The mobile data collection apparatus 3200 is designed to collect sensor data and communicate the position of one or more of the operator's wrists relative to their torso through the kinematic chain. The IMUs 3220, 3224 may include one or more accelerometers, gyroscopes, and one or more magnetometers to provide complete 9-axis motion sensing.

The apparatus 3200 may include a comprehensive array of sensors 3208 providing multi-modal data capture capabilities for robust tracking. In addition to the encoders 3211-3213 (e.g., optical encoders with resolutions of 12-16 bits or magnetic encoders with absolute position capabilities) located at the joints of the articulated arms 3300 and hand position sensors 3410 in the gloves 3400, the apparatus 3200 may include accelerometers with ranges of ±2 g to ±16 g, gyroscopes with ranges of 250 to ±2000 degrees/second, and inertial measurement units (IMUs) combining both sensor types with additional magnetometers.

The torso IMU 3224 may be located on base mount 3240 to measure the relative position of the operator's (H) torso and may provide or establish a distance from the ground or a support surface using barometric pressure sensors with altitude resolutions of 10-50 cm. For example, the torso IMU 3224 may be coupled separately or included in electronics and other circuitry 3209 coupled with the piloting control system 3202 on the base mount 3240, maintaining thermal isolation from heat-generating components to prevent temperature-induced measurement drift. Additional IMUs 3220 may be positioned at a distal portion of the articulated arms 3300 (e.g., the glove mount 3394 and/or glove 3400) to measure the relative position of the operator's (H) wrist with 6-DOF tracking capabilities. Further, the torso IMU 3224 may be used to determine the orientation of the operator's torso with accuracies better than 1 degree and establish a reference point for the wrist IMUs 3220 through coordinate transformation matrices. In some cases, the sensor data collected from IMUs 3220 positioned at the wrist of the operator (H) from the apparatus 3200 for wrist pose estimation might rely on the change in position and orientation as determined from the IMUs 3220 and/or other sensors 3208 used for minimizing drift through zero-velocity updates and magnetic heading correction, which is then fused with the kinematic chain data derived from the encoders 3211-3213 at the joints 3313-3315 of the articulated arms 3300 using extended Kalman filtering or complementary filtering approaches.

Advantageously, these sensors 3208 are an integral part of the structure of the apparatus 3200 and are not placed manually by the human operator (H) or other operators each time the device is used, ensuring consistent sensor placement within 1-2 mm across sessions. This fixed placement methodology eliminates the variability that can arise due to the misplacement of sensors 3208 by the operator (H) and reduces substantial changes in relative sensor locations between different operators or different sessions, thereby aiding in the consistency and reliability of the collected data with repeatability better than 95%.

Moreover, in some embodiments, the sensors 3208 utilized in the apparatus 3200 may employ the same or similar underlying sensor technology as the sensor technology used in the corresponding parts of the robot 1, maintaining measurement consistency across platforms for simplified data processing. This could include, for example, using specific types of optical encoders (e.g., encoders 3211-3213) with identical line counts and interpolation factors or the exact same model of IMU chip such as the Bosch BMI088 or InvenSense ICM-42688 in both the apparatus 3200 and the robot 1. The use of such similar or identical sensor technology provides a technical advantage by reducing or eliminating the need to perform complex translation, manipulation, or alteration of the sensor data collected from the apparatus 3200, reducing computational overhead by 50-70%. As a result, this data can be more directly and meaningfully used to control the robot 1 or to serve as high-quality training data with minimal preprocessing requirements. Additionally, using the same or similar sensor technology can help to mitigate problems that are commonly associated with comparing data from sensors 3208 that exhibit different drift characteristics (typically 0.1-1 degree/hour for gyroscopes), noise profiles (with noise densities of 0.01-0.1 degrees/second/√Hz), or sensitivities to various environmental factors such as temperature coefficients of 0.01-0.05%/° C. In particular, when subjecting two significantly different sensor technologies (e.g., an IMU vs. an optical encoder, or two IMU models from different manufacturers with different Allan variance characteristics) to the same environmental noise sources (e.g., electromagnetic interference (EMI) noise commonly found on a factory floor with field strengths of 1-10 V/m, or mechanical vibrations at frequencies of 10-1000 Hz), the resulting drift or noise patterns associated with these different sensor technologies might be sufficiently different that combining or comparing their data becomes a significant challenge, potentially rendering the collected human data less usable for direct robot control or for imitation learning without extensive calibration and compensation. Thus, the disclosed apparatus 3200, by using the same sensor technology and sometimes even the exact same sensor components as the robot 1 for corresponding measurements (like joint angles), aims to overcome some of these long-standing challenges in cross-platform data consistency.

In addition to these specifically mentioned sensors 3208, the mobile data collection apparatus 3200 may incorporate a variety of additional sensors 3208, or it may obtain data from other external sensors (such as those found in a VR system), to enhance the quality of data collection and to improve the accuracy of training or control with sensor fusion improving overall system accuracy by 20-40%. For clarity, These additional sensors 3208 may be grouped by category:
Motion and Position: This category includes accelerometers with measurement ranges from ±2 g to ±200 g and bandwidths up to 5 kHz, gyroscopes with drift rates better than 10 degrees/hour, and magnetometers with resolutions of 1-10 nT (which are often combined within IMU packages 3220, 3224), flex sensors for measuring bending with resistance changes of 10-100% over their range, GPS modules for absolute outdoor positioning with accuracies of 1-10 meters, 3D cameras or depth sensors for tracking limb position relative to the body or the environment with depth resolutions of 1-10 mm, optical encoders (such as 3211-3213) with resolutions up to 20 bits, tilt sensors with accuracies of 0.01-0.1 degrees, inclinometers with measurement ranges of ±180 degrees, absolute or relative position sensors with resolutions down to nanometers, velocity sensors measuring speeds from 0.01-100 m/s, displacement sensors with ranges from micrometers to meters, vibration sensors detecting frequencies from 0.1 Hz to 10 kHz, angular rate sensors, linear accelerometers, rotary encoders, potentiometers for measuring rotation angle with linearities better than 0.1%, vision-based tracking systems that use markers placed on the operator (H) or apparatus 3200 viewed by external cameras achieving sub-millimeter tracking accuracy, or Ultra-Wideband (UWB) tags for achieving precise relative positioning with accuracies of 10-30 cm.
Biometric: This category includes Electromyography (EMG) sensors for measuring muscle electrical activity with signal amplitudes of 50 V to 30 mV, which can be used for control input or for fatigue monitoring, and eye-tracking sensors with gaze accuracies of 0.5-1 degree, which may be integrated into the apparatus 3200. Other biometric sensors such as Electroencephalography (EEG) for brain activity monitoring with 8-256 channels, Galvanic Skin Response (GSR) for stress levels detecting conductance changes of 0.01-100 μS, or heart rate monitors measuring 30-250 BPM could also be integrated into or interfaced with the system. Skin temperature sensors with accuracies of 0.1-0.5° C. may also be included to monitor the physiological state of the operator (H).
Environmental: This category includes acoustic sensors such as microphones with frequency responses from 20 Hz to 20 kHz, which can be used for voice commands or for ambient noise awareness, proximity sensors for detecting nearby objects at ranges of 1 mm to 10 m, temperature sensors with ranges from −40° C. to +125° C., barometric pressure sensors with resolutions of 0.1 Pa, humidity sensors measuring 0-100% RH, and ambient light sensors detecting 0.01-100,000 lux.
Force and Pressure: This category includes force-sensitive resistors (FSRs) with force ranges of 0.1-100N, pressure sensors for measuring applied pressure over an area from 1-1000 kPa, piezoelectric sensors that generate voltages of 1-1000V under stress, piezoresistive sensors that change resistance by 1-10% under stress, strain gauges for measuring deformation with gauge factors of 2-200, load cells for measuring force, torque sensors (which include types like strain gauge-based with accuracies of 0.1-1%, piezoresistive with response times under 1 ms, magnetoelastic with non-contact measurement, capacitive with resolutions of 0.01%, fiber-optic with immunity to EMI, and rotary transformers for continuous rotation), tactile sensor arrays that provide distributed pressure information similar to artificial skin with spatial resolutions of 1-5 mm, shear force sensors measuring tangential forces of 0.01-100N, bending moment sensors, compression sensors, tension sensors, and impact sensors detecting accelerations up to 10,000 g.
Other: A wide variety of other sensor types might be included based on specific application needs. These can include photodiodes for light detection with spectral responses from UV to IR, Hall effect sensors for magnetic field detection with sensitivities of 1-100 mV/mT, capacitive sensors for proximity or touch detection with sensing distances of 0-50 mm, inductive sensors for metal detection or positioning with ranges of 0.5-80 mm, ultrasonic sensors for distance measurement with ranges of 2 cm to 10 m, thermal sensors for non-contact temperature measurement from −70° C. to +380° C., radar sensors operating at 24-77 GHz, or LiDAR sensors with range resolutions of 1-5 cm, though the latter are less common on a apparatus 3200 compared to their use on robots.

It should be understood that other similar sensors or sensor technologies, including emerging sensor types not listed here such as quantum sensors or neuromorphic sensors, may be utilized by the mobile data collection apparatus 3200. This includes sensor types or specific sensor technologies that might be disclosed in other sections of this application or are otherwise known in the art. Sensor fusion strategies that are specific to the apparatus 3200, employing algorithms such as complementary filters with time constants of 0.5-5 seconds, Kalman filters (including variants like the EKF with 15-30 state variables or UKF with sigma point selections), or machine learning-based approaches using neural networks with 10³ to 10⁶ parameters, may be implemented within the piloting control system 3202 or the computer 3110. The goal of these strategies is to combine data from multiple sensors 3208 in an effective manner, aiming to achieve more accurate and robust estimates of the pose, motion, and intent of the operator (H) with position accuracies better than 5 mm and orientation accuracies better than 2 degrees.

In addition to the sensors already mentioned, the mobile data collection apparatus 3200 may incorporate additional sensors to enhance data collection and improve training accuracy. These may include:
Electromyography (EMG) Sensors (e.g., Delsys Trigno Wireless EMG System, Advancer Technologies MyoWare Muscle Sensor, Otto Bock MyoBock System)
Force-Sensitive Resistors (FSR) or Pressure Sensors (e.g., Interlink Electronics FSR 400 Series, Tekscan FlexiForce Sensors, Honeywell FSS-SMT Series Force Sensors)
Haptic Feedback Devices (e.g., Precision Microdrives Vibration Motors, Tactile Labs Haptics Actuators, Ultrahaptics (Ultraleap))
Flex Sensors (e.g., Spectra Symbol Flex Sensor, Adafruit Flex Sensor, Flexpoint Bend Sensors)
Acoustic Sensors (e.g., Knowles MEMS Microphones (e.g., SPH0645LM4H-B), Audio Analytic's ai3 Acoustic Sensor, MaxBotix MB1000 LV-MaxSonar-EZ1)
Eye-Tracking Sensors (e.g., Tobii Eye Trackers, Pupil Labs Eye Tracking Headsets, SR Research EyeLink Systems)
Proximity Sensors (e.g., Sharp GP2Y0A21YK0F Infrared Proximity Sensor, STMicroelectronics VL53L0X ToF Sensor, Pepperl+Fuchs Ultrasonic Proximity Sensors)
GPS Modules (e.g., u-blox NEO-M8N GPS Module, Adafruit Ultimate GPS Breakout v3, SparkFun GPS Dead Reckoning Breakout (NEO-M8U))
Temperature Sensors (e.g., Maxim Integrated DS18B20, Texas Instruments LM35, Sensirion STS3x Series)
3D Cameras or Depth Sensors (e.g., Intel RealSense Depth Cameras (D435, D455), Microsoft Azure Kinect DK, Structure Sensor by Occipital)
   vi. Piloting Control System

The piloting control system 3202 is coupled to data storage 3204, a battery 3206, other circuitry 3209 including power management and signal conditioning, multiple sensors 3208 including encoders 3211-3213, hand sensors 3410 detecting finger positions, and IMUs 3220, 3224 of the mobile data collection apparatus 3200. The piloting control system 3202 includes a processor, a memory, and instructions stored in the memory configured to be executed on the processor, where the instructions include applications to facilitate the collection of sensor data using the mobile data collection apparatus 3200 at sampling rates of 100-10,000 Hz. Additionally, the piloting control system 3202 may be in data communication with the robot 1, as well as the computer 3110, the data storage database 2900, the clutch 3140, and/or the optional display 3150 via a network 2999A-X supporting bandwidths of 1-1000 Mbps.

The piloting control system 3202 may be attached directly to the main support portion 3242 in a mounting region that is designed to receive electronics with appropriate thermal dissipation capabilities through heat sinks or thermally conductive mounting interfaces. In some embodiments, both the battery 3206 and the piloting control system 3202 are carried by the base mount. In other embodiments, the piloting control system may be remotely located from the base mount, and the base mount may be coupled to a power source that is also remotely located from the portable data collection apparatus. Said electronics may include sensors operating at various sampling rates from 10 Hz to 10 kHz, communication interfaces supporting protocols such as USB 3.0, Ethernet, Wi-Fi 6, and Bluetooth 5.0, processors including ARM Cortex-A series or Intel Atom processors, data storage devices using solid-state drives or eMMC storage, or any other electronic component that facilitates obtaining and transmitting sensor data from the mobile data collection apparatus 3200 to the computer 3110, the data storage 3204, and/or the robot 1 with end-to-end latencies under 20 ms. In some embodiments, the battery 3206 or power source for the piloting control system 3202 may reside with the piloting control system 3202 in a housing or be coupled separately to the main support portion 3242 and electrically connected to the piloting control system 3202 through power cables rated for 5-50 W. In some embodiments, the main support portion 3242 is configured to support at least the battery 3206 and/or piloting control system 3202 with vibration isolation providing 20-40 dB attenuation at frequencies that could affect sensor measurements.

The piloting control system 3202 may also be configured to integrate various software applications or functionalities (e.g., running on embedded Linux or real-time operating systems). These applications may include a sensor tracking application operating at 500-1000 Hz update rates, which may incorporate a drift correction algorithm to enhance tracking accuracy to sub-degree levels. For example, the sensor tracking application is tasked with the real-time acquisition of data from the array of sensors 3208 that are distributed across the apparatus 3200, managing data streams totaling 10-100 MB/s. The sensor tracking application communicates this collected sensor data to the computer 3110 for further processing through TCP/IP or UDP protocols, or it may process the data locally within the piloting control system 3202 using edge computing capabilities. The computer 3110 and/or the on-board processors that are located within the piloting control system 3202 then operate to refine the raw sensor data through filtering, calibration, and fusion algorithms. This refined sensor data can then be utilized, in connection with robot control data received from the robot 1, to dynamically adjust the data that is provided to generate the robot control data that is sent to the robot 1 with control loop frequencies of 100-1000 Hz.

Advanced algorithms, including various machine learning models such as recurrent neural networks with 10⁴ to 10⁶ parameters, can be employed to analyze the various data streams, such as the raw sensor data sampled at native rates, the refined sensor data after processing, and/or the received robot control data, in order to identify patterns with recognition accuracies above 95%, perform sensor fusion reducing uncertainty by 30-50%, correct for sensor drift maintaining errors below 1 degree/hour, and optimize control strategies improving task success rates by 20-40%. This comprehensive feedback loop, which incorporates data from the operator (H), the apparatus 3200, and the robot 1 with round-trip latencies under 50 ms, not only improves the performance of the apparatus 3200 in real-time but also contributes to the iterative development of more sophisticated control algorithms (or AI models) that can be tailored to operator-specific training regimens or particular task requirements through transfer learning and fine-tuning approaches. This overall system architecture facilitates an adaptive training or teleoperation environment where the mobile data collection apparatus 3200 can continuously adjust its behavior based on accumulated interaction data from the operator (H) and feedback from the robot 1, thereby maximizing both task efficacy achieving success rates above 90% and the immersion of the operator (H) with presence ratings above 4 on a 5-point scale.

b. Computing Environment

As shown in FIG. 6, the portable data collection system 3010 includes a mobile data collection apparatus 3200, a computer 3110, a data storage database 2900, 3204, a clutch 3140, and the robot 1, which are in data communication with each other via a network 2999A-X. The mobile data collection apparatus 3200 is configured to be worn by a human operator (H) to collect and send sensor data to be received and processed by computer 3110. The processed control data is sent from the computer 3110 to the robot 1 via the network 2999A-X for execution by the robot's control systems. The mobile data collection apparatus 3200 can communicate with the computer 3110 via the network 2999A-X. In some embodiments, the mobile data collection apparatus 3200 can communicate directly with the robot 1 via the network 2999A-X, bypassing the computer 3110 for reduced latency applications. In this embodiment, the computer 3110 may be integrated into: (i) the mobile data collection apparatus 3200 and/or (ii) robot 1.

The robot 1 includes a whole body controller (WBC) 1550 that is configured to receive and process control data derived from the mobile data collection apparatus 3200 through kinematic transformation and motion planning algorithms. The WBC 1550 also generates torque targets and current signals for selected actuators (J1-J7) for movement of the actuators (J1-J7). The WBC 1550 further collects robot data from the movement of the actuators (J1-J7) and communicates the robot data to the data storage database 3204 for later training use. The WBC 1550 of the robot 1 can communicate with the computer 3110 via the network 2999A-X to receive and process the control data that is derived from the sensor data that was obtained from the mobile data collection apparatus 3200. The WBC 1550 of the robot 1 can also communicate with the data storage database 3204 collected robot data for training a neural network model and/or running a data collection application to train a neural network.

i. Computer

The computer 3110 may comprise, for example, a server computer, a secondary computer, or any other system providing computing capability suitable for real-time data processing. Alternatively, the computer 3110 may comprise a plurality of computing devices that may be arranged, for example, in one or more server banks or computer banks or other arrangements. Such computing devices may be located in a single installation or may be distributed among many different geographical locations for redundancy and load balancing. The computer 3110 can include technology that trains a neural network model and/or run a data collection application to train a neural network.

The data collection system 3010 may also include a computer system 3110 that is designed to process the sensor data at rates of 100-1000 Hz in order to generate robot data that can be sent to the robot's whole body controller 1550 in order to allow for the mobile data collection apparatus 3200 to control the robot 1 or cause the robot 1 to mimic the movements of operator (H) with latencies under 50 ms. In addition to performing this data generation function with computational throughputs of 1-10 GFLOPS, the computer system 3110 may perform additional functionalities associated with data collection and storage, some of which may include using filtering algorithms such as Butterworth or Chebyshev filters with cutoff frequencies of 10-100 Hz, compression algorithms achieving compression ratios of 10:1 to 100:1, or other data manipulation methods or algorithms including outlier detection and removal.

The computer system 3110 may comprise various computing architectures to perform its intended functions with appropriate performance characteristics. Examples of such architectures include a server computer with multi-core processors, a secondary computer with GPU acceleration, or any other system that provides suitable computing capability of 10-100 TFLOPS for real-time processing. In some implementations, the computer system 3110 may comprise a distributed computing environment, which incorporates a plurality of interconnected computing devices communicating through high-speed networks. These computing devices may be arranged in various configurations, such as in server banks with blade servers, computer banks with rack-mounted systems, or other suitable distributed architectures supporting horizontal scaling. The computing devices may be co-located in a single physical installation with dedicated cooling and power infrastructure, or they may be distributed across multiple geographical locations connected through wide-area networks. This architecture might be implemented as an edge compute node with processors such as NVIDIA Jetson or Intel NUC that is situated geographically close to the robot 1 and the operator (H) in order to minimize network latency to under 5 ms. Alternatively, it could be integrated partially or wholly within the robot 1 itself using the robot's onboard computing resources or within the apparatus 3200, depending on the chosen processing architecture and power constraints. Sometimes, the computer system 3110 may be deployed on the edge, for instance, as part of the processor and computing architecture of the robot 1 with shared memory architectures. In yet other embodiments, one or more of the operations and/or processes that are performed by the computer system 3110 may be performed by processors and/or an edge computing architecture of the robot 1, thereby improving processing efficiency by 30-50% and the use of computational resources across the disclosed technology as a whole through load balancing and task distribution.

ii. Clutch

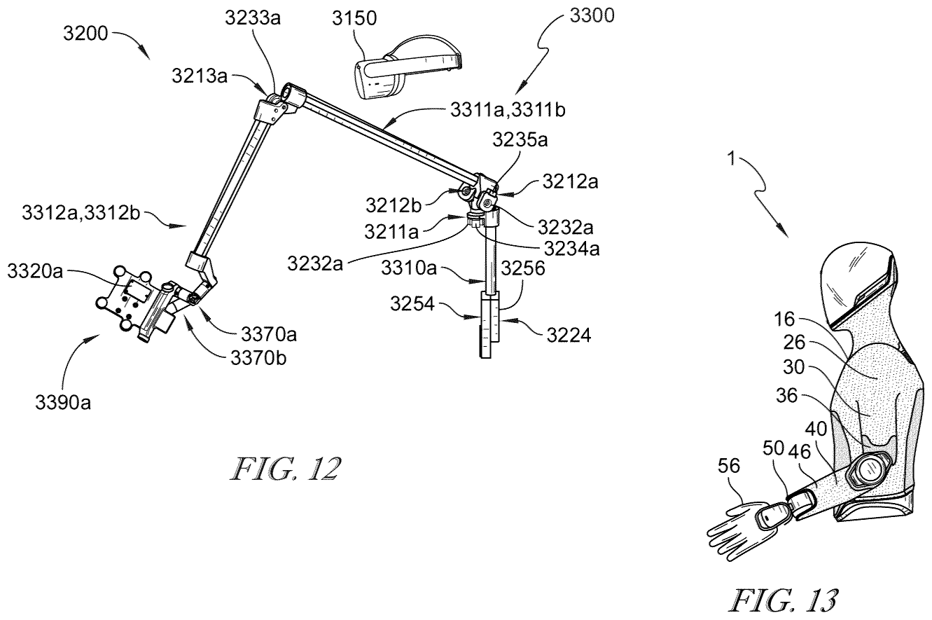

Referring to FIGS. 12, 21, and 22, the data collection system 3010 may include a clutch 3140 that is designed to allow the operator (H) to selectively pause the transmission of robot control data from the computer 3110 to the robot 1. This robot control data is derived from sensor data, which in turn was derived from the collected human data processed through the kinematic mapping algorithms. This feature may allow the operator (H) to reposition their hands or body to a more ergonomic or natural position without causing unintended movements of the robot 1, preventing potential collisions or task errors, before they resume operation of the mobile data collection apparatus 3200. By implementing this pause functionality with software and hardware interlocks, the system 3010 may prevent the unintended hand motions of the operator (H), which can occur during such repositioning over periods of 1-10 seconds, from being translated into corresponding movements of the hands 56 or other parts of the robot 1.

The operator (H) may activate the clutch 3140, for example, by using their hand to press a button with actuation forces of 2-10 N, to temporarily suspend the transmission of the robot control data that is related to certain degrees of freedom. In some configurations, the clutch 3140 may be configured to suspend transmission for all degrees of freedom simultaneously through a master enable/disable signal. In other configurations, it may be set to suspend transmission for only a predefined subset of degrees of freedom, such as only the arm movements (suspending joints J1-J7), while leaving the head tracking active to maintain the situational awareness of the operator through continuous visual feedback. Upon the release or deactivation of the clutch 3140, the mobile data collection apparatus 3200 and the computer 3110 may resume the process of generating and transmitting the robot control data with smooth trajectory blending. The resumption of this control data transmission may be immediate with latencies under 50 ms, or it may incorporate a brief ramping period of 0.5-2 seconds to ensure the smooth re-engagement of the motion of the robot 1 using velocity and acceleration limits.

The clutch 3140 may be implemented in various physical forms, such as a button with tactile feedback, a switch with definitive positions, a trigger mechanism with proportional control, or another type of operator-actuated device that is integrated directly into the mobile data collection apparatus 3200, for example, on a hand-held component with ergonomic placement or on the main body of the mobile data collection apparatus 3200 within easy reach. This integration may allow the operator (H) to selectively engage and disengage the clutch 3140 with one or both hands as appropriate during the performance of a task. For instance, a pressure-sensitive grip on a handheld controller with force thresholds of 5-20 N could be configured to function as the clutch 3140, disengaging control whenever the operator (H) relaxes their grip below the threshold.

In alternative embodiments, the clutch 3140 may be implemented as a separate, discrete device with wireless or wired connectivity. For example, as shown in FIGS. 21-22, the clutch 3140 could take the form of a foot pedal with adjustable resistance that is coupled to the computer 3110 and positioned on the floor for foot activation by the operator (H), or it could be made accessible to another supervising operator through a control panel. A supervising operator might utilize such a separate clutch 3140 to intervene in the operation for safety with emergency stop capabilities or for training purposes during skill transfer sessions. Alternative methods for clutch activation could involve the use of voice commands that are recognized by the system 3010 with recognition accuracies above 95%, gesture recognition that is performed using the sensors 3208 on the apparatus 3200 with gesture libraries of 10-50 commands, or even a predictive clutch engagement system using machine learning models. For example, a specific spoken phrase like “Pause robot” processed through speech recognition could activate the clutch 3140, and the phrase “Resume robot” could deactivate it with voice activation latencies under 500 ms.

Predictive engagement of the clutch 3140 might function based on detecting movement patterns that are indicative of non-task-related actions through anomaly detection algorithms, for example, large, rapid repositioning movements of the operator (H) that fall outside the typical workspace (exceeding 1 meter) or velocity profile (exceeding 2 m/s) of the task being performed. A software-based clutch interface, which could be presented on the display 3150 or on an auxiliary screen with touch or gaze interaction, could also allow for activation through gaze control with dwell times of 0.5-2 seconds or through interaction with a tracked controller that is associated with the VR headset. The display 3150 could present a virtual button with visual feedback that the operator (H) selects either via gaze dwell time or by pointing at it with a controller tracked at 90-120 Hz.

The clutch 3140, whether it is implemented as a physical or a virtual device, may incorporate advanced haptic feedback technologies providing multi-modal sensory confirmation. This haptic feedback could provide the operator (H) with a tactile confirmation, such as a click with forces of 2-5 N, a vibration at frequencies of 100-300 Hz, or a change in resistance from 10 N to 30 N, that indicates the successful engagement and disengagement of the clutch 3140. Such feedback enhances the confidence of the operator (H) and improves the overall usability of the system 3010 with user satisfaction scores improving by 15-25%. Additionally, the system 3010 may implement an intelligent clutch behavior, which could be managed by a dedicated intelligent clutch module running at 100-500 Hz. This intelligent clutch module might use machine learning algorithms trained on datasets of 10³ to 10⁵ operator interactions to analyze the movements of the operator (H) and the current task context, thereby learning to predict and automatically engage the clutch 3140 during natural pauses lasting 2-10 seconds or transitions in the operator's workflow. This would further enhance the ergonomics and usability of the mobile data collection apparatus 3200, reducing operator fatigue by 20-30%. For example, if the system 3010 detects that the operator (H) is looking away from the primary task area for an extended period exceeding 3 seconds, the intelligent clutch module might infer that a pause is intended and automatically engage the clutch 3140 with predictive accuracies above 90%.

iii. Display

The portable data collection system 3010 may include a display 3150 that provides visual feedback to the operator (H) from the robot 1 and/or from the operator's viewpoint with refresh rates of 60-144 Hz and resolutions from Full HD to 8K. To provide this visual feedback with minimal latency, the display 3150 can be incorporated into one or more types of devices, including but not limited to: standard computer monitors that use technologies like liquid crystal display (LCD) with response times of 1-5 ms, organic light-emitting diode (OLED) with infinite contrast ratios, microLED with brightness exceeding 1000 nits, or quantum dot displays with color gamuts covering 100% of DCI-P3; virtual reality (VR) or augmented reality (AR) headsets (e.g., Sony PlayStation VR with 120 Hz refresh rate, the HTC Vive with 2K per eye resolution, the Apple Vision Pro with micro-OLED displays, and the Meta Quest series with inside-out tracking), which may function as the headset device; and other head-mounted display (HMD) configurations, including those where a mobile device is positioned within a headset frame (e.g., Google Cardboard-style viewers supporting phones with 5-7 inch displays, Merge VR Goggles with adjustable lenses, Carl Zeiss VR One Plus with 100-degree field of view, Xiaomi Play2 with focus adjustment, and similar models, as well as projected displays with lumens ratings of 3000-10000). A headset device may include a head position sensor, such as an internal IMU, configured to determine a position of a head of the operator and provide head positional data to the piloting control system.

Additionally, the display 3150 may be alternatively implemented using technologies such as transparent displays with 50-80% transparency, holographic projectors creating 3D images without glasses, electronic ink (e-ink) panels with power consumption under 10 mW, laser projection systems with 4K resolution, multi-panel display arrays creating wrap-around views, curved monitors with 1000R-1800R curvature, flexible displays that can be rolled or folded, retinal projection systems directly imaging onto the retina, and/or any other known display or display system technology that is suitable for presenting the visual feed of the robot 1. Projection mapping systems with 10,000+ lumens could serve as an alternative for the display 3150, projecting the view of the robot 1 or related information onto surfaces within the environment of the operator (H), an approach which offers a different form of immersion or situational awareness when compared to head-mounted displays.

In some embodiments, the display 3150 may further include advanced optical components with specific optical characteristics. Examples of such components include Fresnel lenses with focal lengths of 40-50 mm, pancake lenses reducing thickness by 50%, waveguide optics with efficiency above 85%, or diffractive optical elements with sub-wavelength features, which can be used, particularly in HMDs, to enhance visual clarity to 20/20 vision equivalent, widen the field of view to 110-200 degrees, and minimize optical distortion to less than 2% across the field in augmented and virtual reality environments. Additional implementations may integrate adaptive optics that are capable of adjusting their focal lengths in real-time from 0.5 to 3 meters, in order to accommodate the specific vision conditions of the operator (H) or to simulate focus changes that correspond to the sensor focus of the robot 1. Tunable polarization filters with extinction ratios of 1000:1 might also be included to improve contrast and reduce glare under the varying environmental lighting conditions from 10 to 100,000 lux that are reported by the robot 1. Furthermore, high-refresh-rate displays, such as those operating at 120 Hz, 144 Hz, 240 Hz or higher, may be utilized in conjunction with motion prediction algorithms predicting 16-33 ms ahead to further reduce the perceived latency to under 20 ms and improve the real-time responsiveness of the visual feedback. Variable Refresh Rate (VRR) technologies supporting ranges of 48-144 Hz, adapted for VR use cases, could also help to smooth the visual performance by allowing the display 3150 refresh rate to synchronize with the rendering rate of the graphics pipeline, although fixed high refresh rates combined with latency compensation techniques like Asynchronous Timewarp (ATW) reducing latency by 20-40 ms and ASW maintaining smooth motion at 45 fps input are common strategies in VR. VRR can reduce screen tearing and stutter by 90%. These collective enhancements all contribute to creating a more immersive and accurate visual representation of the operational environment of the humanoid robot 1 for the operator (H) with presence scores above 4.5 on a 5-point scale. The overall goal is to achieve a seamless and realistic operator experience with motion-to-photon latencies under 20 ms.

In order to transform visual data that is received from the robot 1, which may be captured in a vertical stereo vision format using vertically separated cameras with baselines of 50-200 mm, into a horizontally oriented stereo image that is suitable for human viewing (e.g., a VR headset with horizontal IPD of 58-72 mm), specialized software methods may be implemented achieving transformation latencies under 10 ms. These methods may include geometric rectification using homography transformations with 3×3 matrices, disparity re-projection techniques maintaining depth accuracy within 1%, convolutional neural networks (CNNs) with 10⁶ to 10⁸ parameters specifically trained for stereo image conversion tasks, and adaptive warping techniques with per-pixel displacement maps. Algorithms such as those that are based on epipolar geometry transformation can be applied to remap the vertically aligned depth or image data into a horizontal stereo pair while attempting to maintain accurate depth perception for the viewer with depth estimation errors under 5%. This category of methods broadly covers various view synthesis and image rectification techniques, such as Depth Image Based Rendering (DIBR) with depth map resolutions of 1080p, Neural Radiance Fields (NeRF) with 10⁵ to 10⁶ sample rays, 3D Gaussian Splatting (3DGS) with 10⁴ to 10⁶ Gaussians, Multi-Plane Images (MPI) with 32-128 depth planes, or direct learned transformations that are executed on the appropriate processing hardware capable of 1-10 TFLOPS, which could be located on the robot 1, on an edge computer 3110, or distributed between them with task allocation based on available compute.

Alternative transformation methods may involve the use of light field rendering techniques with 5×5 to 15×15 view arrays, where the system captures or synthesizes a richer representation of the light rays in the scene. This allows for view generation from different perspectives with angular resolution of 0.5-2 degrees, which can offer more comfortable viewing experiences or enable features like variable focus from 30 cm to infinity. The choice between these different transformation methods may involve trade-offs concerning computational cost (GFLOPS used), the quality of the output image (PSNR above 30 dB), the amount of introduced latency (target under 10 ms), and the robustness of the method to different scene types or camera configurations. Additionally, interpolation methods that use optical flow estimation with sub-pixel accuracy can further enhance the alignment between the transformed left and right eye images in order to reduce visual distortion to under 1% and provide a more natural viewing experience for the operator (H). Optical flow information can also be utilized in techniques like Asynchronous Spacewarp (ASW) or similar frame interpolation methods generating intermediate frames at 90-120 Hz. These methods can be used to synthesize intermediate frames when the system cannot consistently maintain the target frame rate of the display 3150, thereby improving the perceived smoothness of the motion by maintaining apparent frame rates above 90 fps.

The display 3150 and/or the portable data collection system 3010 may also include capabilities for integrating additional sensor modalities to provide an enriched interaction experience for the operator (H) with multi-modal feedback improving task performance by 15-30%. Multi-modal interaction serves to enhance the level of control precision and situational awareness. These modalities may include eye-tracking sensors with accuracies of 0.5-1 degree and sampling rates of 120-250 Hz, gesture recognition systems which may use cameras or other sensors detecting 20-50 distinct gestures, capacitive or resistive touch interfaces with response times under 10 ms which may be on associated controllers or on the display 3150 itself, voice control systems with vocabulary sizes of 1000-10000 words, or biometric sensors like heart rate monitors (30-250 BPM) or galvanic skin response sensors (0.01-100 μS) providing physiological feedback. These additional sensors provide alternative input channels for the operator with recognition accuracies above 95%.

Eye-tracking technology that is integrated into a VR headset is particularly relevant in this context with calibration times under 30 seconds. Eye-tracking has several applications in VR enhancing both performance and user experience. It enables gaze-contingent rendering, which involves rendering higher detail only in the area where the operator (H) is currently looking (typically 20-30 degrees), and it also enables foveated encoding, which involves compressing the video stream more aggressively in the peripheral vision areas with compression ratios of 10:1. These techniques serve to optimize both rendering performance and bandwidth usage by 40-60%. Both of these techniques can significantly reduce the computational load and the network bandwidth requirements for rendering and transmitting the high-resolution video stream from the robot 1. The resulting efficiency gains are substantial, enabling higher resolution displays or reduced hardware requirements.

Furthermore, other sensor modalities, beyond those related to the interaction of the operator (H), may be incorporated to enhance the ability of the display 3150 to interpret and present the perception of the robot 1 of its surroundings with enhanced environmental awareness. These may include depth-sensing cameras that provide depth maps with 1-10 mm accuracy at 30-60 fps, infrared sensors for enhanced vision in low-light conditions down to 0.001 lux, electromagnetic motion tracking systems for providing precise positional awareness of tracked objects or controllers with sub-millimeter accuracy, environmental microphones that are integrated into the display 3150 device for spatial audio processing with 360-degree sound localization, thermal imaging sensors for detecting heat signatures, and/or any other sensors that are disclosed elsewhere herein as being part of the robot 1 or the system 3010.

Integrating spatial audio rendering with 7.1 or Atmos support, which is synchronized accurately with the visual feed presented on the display 3150 with audio-visual sync within 40 ms, can further enhance the immersion and situational awareness of the operator (H) for teleoperation tasks improving task completion rates by 10-20%. Haptic feedback mechanisms that are integrated into the display 3150 device or its associated controllers, such as vibrating motors operating at 20-1000 Hz or force feedback elements providing up to 40N, could provide tactile cues that correspond to events in the environment of the robot 1 or provide feedback related to the actions of robot 1, thereby complementing the visual and audio information with response times under 20 ms.

Separate and apart from the calibration procedures for the mobile data collection apparatus 3200, the display 3150 itself may also utilize its own calibration procedures using 2-5 minutes. These procedures, which may employ image processing techniques and corrective transformation matrices updated at 60-120 Hz, may be implemented to ensure color accuracy within ΔE<2, geometric fidelity with distortion under 1%, and depth perception consistency within 5% in the visuals that are presented to the operator. These display calibrations may include machine learning-based error correction algorithms with neural networks of 10⁴ to 10⁶ parameters that dynamically adjust for image distortions based on real-time feedback or the known hardware characteristics of the display 3150. This can help to compensate for issues like lens aberrations in HMDs (typically 1-5% distortion), motion blur effects with 1-10 ms persistence, and to adapt to the different environmental lighting conditions from 10 to 100,000 lux that are being experienced by the robot 1. The calibration processes might utilize standardized reference targets, such as color checker patterns with 24 color patches that are viewed by the cameras of the robot 1, structured light scans of known geometries with patterns projected at 30-120 Hz, or pre-computed depth maps with resolutions matching the display, in order to derive calibration equations or lookup tables that are able to mitigate distortion and ensure visual consistency across varying operational conditions with calibration accuracies better than 1%. Operator-specific calibration profiles for the operator (H) could also be stored and applied, which would account for individual operator preferences or visual characteristics, such as their interpupillary distance (IPD) ranging from 52-78 mm. This Personalization improves both comfort reducing eye strain by 30-50% and accuracy for the operator improving depth perception accuracy by 10-20%.

Ensuring an accurate calibration between the cameras of the robot 1, including their intrinsic parameters like focal length (typically 3-50 mm) and distortion coefficients (k1, k2, p1, p2, k3), and their extrinsic parameters like their relative position (accurate to 1 mm) and orientation (accurate to 0.1 degrees), especially the vertical baseline separation if applicable (typically 50-200 mm), and then correctly mapping the resulting stereo view to the measured IPD of the operator (H) in the VR headset is an integral process. This accurate mapping helps to provide a comfortable and accurate stereoscopic viewing experience with vergence-accommodation conflicts minimized, preventing eye strain for the operator (H) during sessions lasting 2-8 hours and avoiding misperceptions of depth or scale in the presented view with depth accuracy maintained within 5%. Furthermore, advanced computational imaging techniques, such as multi-view stereo reconstruction using 2-8 camera views, photometric calibration to ensure consistent brightness and color response across 0.1-100,000 lux, and adaptive exposure correction algorithms with dynamic ranges of 120 dB, may be employed on the image data before it is displayed, in order to enhance the accuracy and reliability of the visual data being presented. Real-time optimization algorithms running at 60-120 Hz may also be implemented to compensate for minor discrepancies in the stereo vision alignment that might occur during operation, which ensures that the depth information remains reasonably accurate within 2-3% error and dynamically responsive to any environmental changes. Techniques for online camera calibration updating every 10-60 seconds or adaptive rectification with sub-pixel accuracy could also be employed for this purpose. These techniques could be configured to run periodically or continuously to maintain the alignment accuracy within 1-2 pixels, even if minor mechanical shifts occur in the camera rig of robot 1 over time due to factors such as vibration at 10-100 Hz or temperature changes of 20° C.

Operationally, the display 3150 can be physically configured in multiple ways to accommodate different use cases and operator preferences. It might be designed to be worn by the operator (H) with head strap tensions of 10-30N, as is the case with an HMD weighing 300-800 grams, it might be mounted directly on the mobile data collection apparatus 3200 at eye level, or it could be positioned in a stationary manner, like a desktop monitor at viewing distances of 50-100 cm, in front of the operator (H) during the operation of the apparatus 3200. Additionally and/or alternatively, the display 3150 system or the broader portable data collection system 3010 may include the capability to process image data through real-time rendering engines achieving 60-120 fps and sensor fusion algorithms with latencies under 5 ms. These algorithms are designed to integrate inputs from various sensors, including inertial measurement units (IMUs) that are located within the display 3150 device itself with update rates of 500-1000 Hz, LiDAR sensors on the robot 1 with 300,000-2,000,000 points per second, infrared depth cameras on the robot 1 operating at 30-90 fps, electromagnetic motion tracking systems with update rates of 240-360 Hz, environmental microphones for spatial audio processing with 48-192 kHz sampling, and other vision-based tracking systems, such as SLAM running on the headset cameras achieving 6-DOF tracking. Specifically for a VR headset implementation of the display 3150, the rendering engine may use inputs from the headset's own IMU updating at 1000 Hz and its tracking system, which could be, for example, inside-out tracking using the headset's cameras with 4-6 cameras or outside-in tracking using external sensors with sub-millimeter precision.

Additionally or alternatively, the display 3150 may include capabilities to provide augmented reality (AR) overlays with registration accuracies of 1-5 mm. These overlays would utilize environmental mapping techniques, such as simultaneous localization and mapping (SLAM) algorithms processing 30-60 fps, which could run either on the robot 1 or on the AR display device itself with dedicated processors. This would enable the dynamic alignment of virtual information or graphics with the view of the operator (H) of their physical surroundings with update rates of 60-90 Hz, as seen either directly or through the cameras of the robot 1. Further, machine learning-based predictive tracking algorithms with prediction horizons of 20-100 ms may be implemented to anticipate the head movements of the operator (H) more accurately and preemptively begin rendering the corresponding visuals, which further contributes to the reduction of perceived latency by 30-50%.

Moreover, the display 3150 system may also include features like diagnostic modes showing system metrics updated at 10-30 Hz, which could show raw sensor data or system status, playback functionalities for reviewing recorded sessions at variable speeds from 0.25× to 4×, or immersive simulation modes for training or testing with physics simulations at 1000 Hz. In these modes, latency minimization may be achieved through techniques such as variable refresh rate (VRR) supporting 48-240 Hz and adaptive sync technologies with response times under 1 ms, which help to ensure that the effective frame update interval remains consistent even under rapid motion conditions exceeding 180 degrees/second, although techniques like ATW/ASW are generally considered for maintaining smooth visual perception during frame rate fluctuations in VR environments. Ensuring low latency under 20 ms and smooth visuals above 90 fps is a constant focus of the system design achieving user comfort ratings above 4/5. For instance, an alternative diagnostic mode may overlay the predicted trajectories or planned paths of the robot 1 onto the view of the operator (H) with trajectory updates at 30 Hz, which would allow for an intuitive assessment of the intentions of the robot 1. The Playback functionalities may also incorporate the synchronized playback of multiple sensor data streams alongside the visual feed with synchronization accuracy within 1 ms, a feature which facilitates a detailed post-session analysis of the performance of both the robot 1 and the inputs of the operator (H) with analysis tools supporting frame-by-frame review.

iv. Data Storage

The data storage database 3204 collects and stores robot data generated by the actuators (J1-J7) for subsequent training and analysis purposes. The robot data collected and stored by the data storage database 3204 can be filtered, labeled, refined, and/or modified to generate training data that can be used for training of networks that will run on one or more robots 1. The data storage database 3204 may be a server, a hard drive, a computer, or other device or devices suitable to collect and store data with sufficient capacity and throughput. Similar to the discussion regarding the location of the computer 3110, the data store 3204 may be local to the robot 1 with direct bus connections, the mobile data collection apparatus 3200 (e.g., integrated with piloting control system 3202), or the computer 3110 with high-speed interfaces. In other examples, the data store 3204 may not be local and instead may be remote relative to one or more of the robot 1, the mobile data collection apparatus 3200, or the computer 3110, connected through network links with appropriate bandwidth and reliability.

c. Operation of the Portable Data Collection System

A method for operating the portable data collection system 3010 to train robot 1 and neural networks running on one or more robots begins by linking the mobile data collection apparatus 3200 to the computer 3110 via the network 2999A-X through appropriate connection protocols. The operator (H) then dons the mobile data collection apparatus 3200, as illustrated in FIGS. 21-22, securing the harness and gloves for comfortable operation. While worn by the operator, the apparatus collects sensor data from the plurality of sensors 3208 at frequencies ranging from 50 Hz to 200 kHz depending on the sensor type. This sensor data is transmitted to the computer 3110 over the network 2999A-X for processing. Upon receiving the data, the computer 3110 processes it to extract pilot movement data relevant to the training of robot 1. The computer 3110 uses the sensor data to determine the six degrees of freedom (DOF) pose of each wrist of operator (H) relative to the operator's torso. Notably, the computer calculates the difference, or delta, between the last known location of each wrist and their current positions, rather than determining the absolute positions, which reduces sensitivity to calibration errors and drift. However, in alternative embodiments, the system may be designed to compute the absolute six DOF pose of the operator's wrists. In various embodiments, the pilot movement data may be extracted, processed, and/or calculated on the processor of the piloting control system 3202 and transmitted to the robot 1.

Specifically, the delta location for the left wrist is determined using data from encoders 321 la-3213a, wrist IMU 3220a, and torso IMU 3224 through sensor fusion techniques. Similarly, the delta for the right wrist is determined from encoders 3211b-3213b, wrist IMU 3220b, and torso IMU 3224. The IMUs 3220a, 3220b, and 3224 are primarily used to determine the orientation of the operator's wrists, not their positions, although they may contribute to position estimation through integration. In cases where each IMU includes only a 3-axis gyroscope and a 3-axis accelerometer, the computer implements a Mahony algorithm to combine these sensors into an orientation signal. The gyroscope signal is integrated to obtain wrist orientation, while the accelerometer provides a measurement of the gravity vector for tilt correction. The Mahony algorithm effectively removes any bias due to gyroscope signal integration along the pitch and roll axes. When the IMUs also include a magnetometer, an absolute heading signal is provided, and the computer uses a Madgwick algorithm to determine an absolute orientation. The data from encoders 3211-3213 is then fused with the absolute orientation and heading signals to correct drift in the IMU data, as the encoders are less susceptible to magnetic interference and exhibit less drift.

To correct drift from the IMUs or to provide a more accurate six DOF delta pose, the computer 3110 may employ various methods, including algorithms (e.g., filtering), sensor fusion, calibration, or any combination thereof. Algorithms that may be used include the Kalman Filter, Extended Kalman Filter, Unscented Kalman Filter, Error-State Kalman Filter, Particle Filter, complementary filter, or combinations thereof to process the sensor data. Additionally, advanced drift correction models may be utilized, such as zero-velocity updates (ZUPT), zero-angular rate updates (ZARU), machine learning-based drift correction, dead reckoning, factor graph optimization, information filtering, recursive least squares, Bayesian estimation techniques, simultaneous localization and mapping algorithms, and constraints that limit the IMUs estimated movements to feasible ones based on anatomical and mechanical limits.

In further embodiments, the system may obtain a magnetic field map of the training environment to identify regions with magnetic anomalies. This map can help users avoid areas with high magnetic interference, adjust the environment to minimize disturbances, or allow advanced models on the computer 3110 to correct drift based on the magnetic field map. For instance, if a high magnetic field is detected, the model may apply a specific set of weights to compensate, while a different set may be used in low magnetic field areas. Additionally or alternatively, the IMUs may be enclosed within shielding materials to reduce exposure to external magnetic fields, mitigating drift in measurements.

The magnetometers within each IMU may also be manually recalibrated or recalibrated over the network 2999A-X through remote calibration procedures. Calibration can occur upon startup, at predefined intervals (e.g., every 30 minutes, 10 minutes, 1 minute, 30 seconds, 15 seconds, every second, or fractions of a second), or continuously through automatic processes. Calibration techniques may include:
Static calibration: Using stationary measurements to determine sensor biases; Rate table calibration: Rotating the sensor at known rates to calibrate gyroscopes.
Allan variance analysis: Characterizing and modeling sensor noise over different time scales.
Dynamic calibration: Adjusting outputs based on comparisons with ground truth data from motion capture or optical tracking systems when available.
Multi-position calibration: Collecting data at various orientations to improve accuracy through comprehensive sampling.
In-field calibration methods: Allowing calibration during normal operation without special equipment for convenience.
Machine learning-based calibration: Using algorithms to adaptively correct sensor errors based on learned patterns.
Temperature compensation calibration: Adjusting for performance changes due to temperature variations that affect sensor behavior.
Cross-calibration with redundant sensors: Using multiple sensors to correct each other through comparison and fusion.
Other known calibration types: Such as network-based or user-assisted procedures appropriate for the application.

Based on processing data from the sensors 3208, the computer 3110 generates control data at frequencies between 10 Hz and 10 kHz depending on the control requirements. This control data is sent to robot 1 via the network 2999A-X for execution. The Whole-Body Controller (WBC) 1550 in robot 1 receives and processes this data through its motion planning and control algorithms. After processing the control data, the WBC 1550 generates torque targets and current signals for actuators (J1-J7) at frequencies ranging from 50 Hz to 200 kHz. The torque targets and current signals are then sent to the one or more actuators (J1-J7) of the robot to cause the one or more actuators (J1-J7) to move in accordance with the torque targets and current signals. In response to the movement of the one or more actuators (J1-J7), robot data is collected for training purposes. For example, the robot data may include forces and signals sent to the actuators (torques, current, video, other sensor data, etc.).

As the actuators move, robot data is collected, including forces, torques, currents, position data, velocity data, acceleration data, video feeds from onboard cameras, and other sensor data relevant to training. This data is sent to the data storage database 2900 for storage and subsequent analysis. The robot data can then be filtered, annotated, analyzed, and modified to generate training data, which is used to train models like Machine Learning or Bipedal Action Models (MLLM or BAM). These models may run on one or more robots, in the cloud, or both, depending on computational requirements and deployment scenarios.

i. Software Applications of the Mobile Data Collection Apparatus

The piloting control system 3202 may also be configured to integrate various software applications or functionalities running on embedded Linux or real-time operating systems for deterministic timing. These applications may include, for example, a sensor tracking application operating at 500-1000 Hz update rates, which may incorporate a drift correction algorithm to enhance tracking accuracy to sub-degree levels.

For example, the sensor tracking application is tasked with the real-time acquisition of data from the array of sensors 3208 that are distributed across the apparatus 3200, managing data streams totaling 10-100 MB/s. The sensor tracking application communicates this collected sensor data to the computer 3110 for further processing through TCP/IP or UDP protocols, or it may process the data locally within the piloting control system 3202 using edge computing capabilities. The computer 3110 and/or the on-board processors that are located within the piloting control system 3202 then operate to refine the raw sensor data through filtering, calibration, and fusion algorithms. This refined sensor data can then be utilized, in connection with robot control data received from the robot 1, to dynamically adjust the data that is provided to generate the robot control data that is sent to the robot 1 with control loop frequencies of 100-1000 Hz.

Advanced algorithms, including various machine learning models such as recurrent neural networks with 10⁴ to 10⁶ parameters, can be employed to analyze the various data streams, such as the raw sensor data sampled at native rates, the refined sensor data after processing, and/or the received robot control data, in order to identify patterns with recognition accuracies above 95%, perform sensor fusion reducing uncertainty by 30-50%, correct for sensor drift maintaining errors below 1 degree/hour, and optimize control strategies improving task success rates by 20-40%. This comprehensive feedback loop, which incorporates data from the operator (H), the apparatus 3200, and the robot 1 with round-trip latencies under 50 ms, not only improves the performance of the apparatus 3200 in real-time but also contributes to the iterative development of more sophisticated control algorithms (or AI models) that can be tailored to operator-specific training regimens or particular task requirements through transfer learning and fine-tuning approaches. This overall system architecture facilitates an adaptive training or teleoperation environment where the mobile data collection apparatus 3200 can continuously adjust its behavior based on accumulated interaction data from the operator (H) and feedback from the robot 1, thereby maximizing both task efficacy achieving success rates above 90% and the immersion of the operator (H) with presence ratings above 4 on a 5-point scale.

In cases where each IMU (e.g., IM 3224) includes only a 3-axis gyroscope for measuring angular velocity with noise densities of 0.01-0.1 degrees/second/√Hz and a 3-axis accelerometer for measuring linear acceleration with noise densities of 100-500 g/Hz, including gravity, the computer 3110 or the piloting control system 3202 may implement an algorithm such as the Mahony filter with proportional gains of 0.5-2.0, the Madgwick filter with convergence rates of 0.01-0.5, or a complementary filter with time constants of 0.5-5 seconds, or similar sensor fusion techniques achieving orientation accuracies of 1-3 degrees RMS. The purpose of these techniques is to combine the readings from these sensors 3208 into a stable orientation estimate, which can be represented, for example, as a quaternion with four components or a rotation matrix with nine elements. Generally, the gyroscope signal is integrated over time using numerical integration methods to estimate the changes in orientation, while the accelerometer provides a measurement of the direction of the gravity vector (when motion is not causing high linear acceleration above 0.5 g). This gravity vector measurement helps to correct for the drift that accumulates in the integrated gyroscope signal at rates of 0.1-1 degree per minute, particularly in the pitch and roll angles. The Mahony algorithm, for example, effectively uses the accelerometer data to remove the bias or drift that results from the integration of the gyroscope signal along the pitch and roll axes relative to the force of gravity, achieving steady-state errors below 1 degree.

When the IMUs (e.g., IMU 3224) also include a 3-axis magnetometer that measures the local magnetic field with resolutions of 1-10 nT, an absolute heading or yaw orientation, relative to magnetic north with declination corrections applied, can be determined. In such cases, the computer 3110 might use an algorithm like the Madgwick filter, which is capable of incorporating magnetometer data with adaptive gain parameters, or similar techniques to determine an absolute orientation estimate in all three axes of rotation with accuracies of 2-5 degrees. If the apparatus 3200 includes encoders (3211-3213) in its articulated arms 3300, the position data that is derived from these encoders using forward kinematics with Denavit-Hartenberg parameters can then be fused or combined with the absolute orientation and heading signals that are obtained from the IMUs (such as 3224) through sensor fusion algorithms. This fusion process can be instrumental in correcting for drift in the position estimates that are derived purely from integrating IMU (e.g., IMU 3224) data over time, reducing position errors from meters to centimeters over typical operation periods.

To correct for the drift that is inherent in IMU (such as 3220, 3224) measurements (both orientation drift at rates of 1-10 degrees/hour and position drift at rates of 1-10 cm/minute, if the latter is derived from IMU integration), or more generally to provide a more accurate 6-DOF delta pose or absolute pose with position accuracies of 1-10 mm and orientation accuracies of 1-3 degrees, the computer 3110 or the piloting control system 3202 may employ a variety of methods. These methods include applying advanced filtering algorithms with computational complexities of O(n²) to O(n³), implementing sophisticated sensor fusion techniques that combine multiple sensor types with different error characteristics, performing periodic calibration routines every 10-60 minutes, or using any combination of these approaches to achieve the desired accuracy.

Specific algorithms that may be used for this purpose of sensor fusion and state estimation include variants of the Kalman Filter (e.g., the standard Kalman Filter for linear systems, the Extended Kalman Filter (EKF) for nonlinear systems with 15-30 state variables, the Unscented Kalman Filter (UKF) with 2n+1 sigma points, or the Error-State Kalman Filter (ESKF) for improved numerical stability), Particle Filters with 100-10000 particles, complementary filters with adjustable time constants, or combinations thereof, which must be configured appropriately to process the available sensor data from the array of sensors 3208 at update rates matching sensor sampling frequencies.

Additionally, the magnetometer component of each IMU (such as 3224) may require periodic manual re-calibration every 1-7 days, or the system may employ automatic online calibration techniques to maintain its accuracy within 5-10 degrees. Such calibration techniques may include: (i) static calibration procedures, which involve collecting data while the sensor is held stationary in various orientations for 30-60 seconds per position; (ii) rate table calibration, which uses specialized equipment to rotate the sensor at precisely known rates from 1-1000 degrees/second; (iii) Allan variance analysis, which is a method used to characterize noise and stability over different time scales from 0.01 seconds to 10000 seconds; (iv) dynamically adjusting sensor outputs based on a comparison of IMU data with ground truth data provided by a more accurate system, such as an external motion capture or optical tracking system with accuracies better than 1 mm, if one is available during a calibration phase; and/or (v) any other known type of sensor calibration method that is suitable for IMUs including temperature compensation and magnetic field mapping.

Further, a range of advanced drift correction models or techniques may be utilized by the system achieving drift rates below 0.1 degrees/minute. Examples of such techniques include exploiting periods of known motion constraints, such as applying zero-velocity updates (ZUPT) when a hand or foot is detected to be stationary for more than 0.5 seconds, or applying zero-angular rate updates (ZARU) when rotation is detected to have stopped based on thresholds of 0.1 degrees/second. Other advanced techniques include the use of machine learning-based drift prediction and correction models trained on datasets of 10⁴ to 10⁶ samples, dead reckoning combined with map-based localization if a map of the environment is available with resolutions of 1-10 cm, factor graph optimization methods with 10² to 10⁴ variables, information filtering with information matrices, recursive least squares estimation with forgetting factors of 0.95-0.99, various Bayesian estimation techniques including maximum a posteriori estimation, adapting SLAM algorithms for this purpose achieving loop closure errors under 1%, and applying kinematic constraints that limit the estimated movements to those that are physically feasible based on the structure of the human operator (H) or the apparatus 3200 itself such as joint angle limits and maximum velocities. Adaptive calibration routines, which could run periodically every 100-1000 measurements or continuously during operation to estimate and compensate for changing sensor biases (typical rates of 0.01-0.1 degrees/second/hour) or scale factors (drift rates of 0.01-0.1%/hour), could also be employed to enhance long-term accuracy over multi-hour sessions.

As described, the system may use sensor fusion to correct for IMU (3220, 3224) drift or to provide a more accurate 6-DOF delta pose or absolute pose. This fusion process may involve combining data from the primary IMUs (e.g., torso IMU 3224) and encoders (3211-3213) with data obtained from any of the following additional sensors or systems, if they are available to the system:
Ultra-wideband (UWB) positioning systems: Utilizing UWB tags on the operator (H) and anchors in the environment for precise relative positioning with accuracies of 10-30 cm and update rates of 10-100 Hz.
Visual-Inertial Odometry (VIO): Integrating visual data from cameras mounted on the apparatus 3200 or the head of the operator (H) (e.g., from a VR headset) with IMU (3220, 3224) data can significantly improve pose accuracy to centimeter-level precision, especially for position tracking. Examples of VIO systems include integrated devices like the Intel RealSense T265 Tracking Camera with dual fisheye cameras, software libraries like VINS-Mono achieving 0.1-0.5% trajectory error, or platform features like Apple's ARKit with world tracking capabilities.
LiDAR Sensors: (e.g., Velodyne VLP-16 Puck with 16 channels and 100 m range, Ouster OSi LiDAR with 64-128 channels, Hokuyo UTM-30LX with 270-degree field of view and 30 m range).
Optical Tracking Systems: Using external cameras (like Vicon Motion Capture Systems with sub-millimeter accuracy, OptiTrack Systems achieving 0.1 mm precision, ART Tracking Systems with latencies under 5 ms) to track reflective markers placed on the apparatus 3200 or the operator (H) can provide highly accurate ground truth pose information with update rates of 100-360 Hz.
Additional Gyroscopes: High-performance gyroscopes beyond those in standard IMUs (such as 3220, 3224) might offer lower noise or drift (e.g., STMicroelectronics L3GD20H with 0.03 dps/√Hz noise density, Analog Devices ADXRS290 with 0.004 degrees/second/√Hz, Bosch BMG250 with bias stability of 2 degrees/hour).
Pressure Sensors: Barometric pressure sensors can provide altitude information with resolutions of 10-20 cm, which is useful for correcting vertical drift (e.g., Bosch BMP388 with 0.08 Pa resolution, Honeywell ABP Series with 0.03% accuracy, TE Connectivity MS5803-14BA with 24-bit ADC).
Magnetic Field Sensors (Magnetometers): Used for heading estimation with accuracies of 1-2 degrees, as discussed earlier (e.g., Honeywell HMC5883L with 2 milligauss resolution, Asahi Kasei AK8963 with 0.6 μT sensitivity, STMicroelectronics LIS3MDL with ±4/8/12/16 gauss range).
Acoustic Sensors: (e.g., Knowles MEMS Microphones with SNR>65 dB, Audio Analytic's ai3™ Sensor for sound event detection, Microflown Technologies Acoustic Sensors for sound source localization).
Time-of-Flight (ToF) Sensors: ToF cameras or sensors could provide depth information relative to the environment with millimeter precision (e.g., STMicroelectronics VL53L1X with 4 m range, Texas Instruments OPT8241 with QVGA resolution, Basler blaze ToF Camera with 30 fps frame rate).
Ultrasonic Sensors: Can provide range measurements to nearby surfaces with centimeter accuracy (e.g., MaxBotix LV-MaxSonar-EZ Series with 1 mm resolution, HC-SR04 Ultrasonic Sensor with 2-400 cm range, Pepperl+Fuchs Ultrasonic Sensors with response times under 100 ms).
Capacitance Sensors: Primarily used for proximity or touch sensing with detection distances of 0-50 mm (e.g., Microchip CAP12xx Series with 12 channels, Cypress CapSense Controllers with water tolerance, Analog Devices AD7746 with 24-bit resolution).
Infrared Sensors: Can be used for ranging, proximity, or thermal imaging applications (e.g., Sharp GP2Y0A21YK0F with 10-80 cm range, FLIR Lepton Thermal Camera Module with 160×120 resolution, Omron D6T Thermal Sensor with 4×4 or 16×4 pixel arrays).
   ii. Use of the Mobile Data Collection Apparatus

In order to collect the human data, the system 3010 uses its sensors, such as sensors 3208, to collect sensor data at sampling rates of 100-1000 Hz. Said sensor data includes data about the human teleoperator, who is the operator (H), and their various movements in space captured with six degrees of freedom per tracked segment. It should be understood that the said sensor data is a proxy for the underlying human data, because the said sensors 3208 are naturally offset from the body of the operator (H) by distances of 10-50 mm and are not directly integrated into the human operator (H). The mismatch between the human data and the sensor data may be minimal in certain designs of the mobile data collection apparatus 3200 achieving correspondence within 2-3 mm, or it may be more significant in others reaching 10-20 mm offsets. However, to reduce the delta that exists between the sensor data and the true human data, raw data may be collected from multiple sources and then combined by the computer 3110 to form the final sensor data through sensor fusion algorithms running at 500-1000 Hz. These sources may include: (i) sensors that are associated with any joints in the mobile data collection apparatus 3200, such as position encoders 3211-3213 measuring joint angles with resolutions of 0.02-0.09 degrees; (ii) wrist-mounted inertial measurement units (IMUs), one for each wrist 3220 providing 6-DOF motion data; (iii) a torso-mounted IMU 3224 establishing the base reference frame; (iv) additional body-worn IMUs, for example, placed on the upper arms or head of the operator (H) for redundant tracking; (v) physiological sensors that are integrated into the mobile data collection apparatus 3200 or an associated headset, such as eye-tracking sensors providing gaze direction data with 1-degree accuracy which may be indicative of the intent of the operator (H), or EEG/EMG sensors providing data related to the cognitive state or refined motor commands of the operator (H) with signal processing at 256-1024 Hz; and (vi) any of the other types of sensors 3208 that were discussed previously or any other known suitable sensors meeting performance specifications. Other suitable sensors could include flex sensors for detecting finger movement with bend angles from 0-90 degrees or pressure sensors located in the gloves 3400 for measuring grip force from 0.1-100 N.

iii. Generation of the Control Algorithm or Model

Any aspect of the disclosed environment, systems, and/or assemblies may be used to generate a control algorithm or model, wherein said algorithm or model is configured to obtain sensor data sampled at 100-1000 Hz, which is derived from the human data of the operator (H) and output robot control data for consumption and control of the robot 1. For example, said control algorithm or model may output control information that contains the desired positions with millimeter precision, velocities up to 5 m/s, torque targets ranging from 1-500 Nm, or current signals from 0.1-50 A for the actuators of the robot 1, for example, for the selected arm actuators J1-J7, or for all actuators J1-J16 of the robot 1 for more coordinated movements including whole-body control. This control information can be generated at frequencies that are suitable for stable joint control of the robot 1, which can range from 50 Hz to 200 kHz depending on the control architecture, while the higher-level updates might run at rates such as 500 Hz to 2 kHz for trajectory planning and coordination.

The control algorithm or model may be generated using control methodologies including PID control with tuned gains, model predictive control with prediction horizons of 10-100 ms, or may be generated using advanced learning techniques that are unique to machine learning models or AI models with network architectures containing 10⁶ to 10⁹ parameters. A reinforcement learning method along with a desirable reward system providing shaped rewards may be used to leverage trial and error in simulations running at 1000× real-time to teach the robot 1 how to properly respond to the sensor data from said mobile data collection apparatus 3200. These robots are then exposed to a wide range of scenarios that they might encounter in the real world, including over 10,000 different environment configurations, and a single neural network policy learns to operate all of them with success rates exceeding 95%. This training includes encountering various terrains with friction coefficients from 0.1 to 1.5, dealing with changes in actuator dynamics including wear and temperature effects, and learning responses to trips, slips, shoves applying forces up to 100 N, and other perturbations. By combining the technique of domain randomization in the simulations with parameter variations of 30% and high-frequency torque feedback on the real robot 1 at rates of 1-10 kHz, the policies that are trained in the simulation may be able to transfer with zero-shot capability to the real hardware without additional tuning achieving sim-to-real success rates above 90%. This thereby provides for a fast, efficient, and lightweight deployment of the policy to the edge, on the computer 3110 with inference times under 5 ms, the piloting control system 3202, and/or the whole body controller 1550 of the robot 1 using model compression techniques reducing size by 10-100×.

More specifically, a policy that is learned using only RL might converge to sub-optimal control strategies that do not capture the proper response to the provided sensor data, achieving only 60-70% task success rates. To address this issue, the said preference for robot control can be injected into the learning framework by providing a reward to the robot 1 for mimicking proper positioning of the robot based on the provided sensor data with position matching rewards weighted at 0.3-0.7. Furthermore, as was indicated above, a combination of domain randomization in the simulation with randomization ranges of ±20-50% and a kHz-rate torque feedback control loop on the robot 1 with control frequencies of 1-10 kHz may be used to bridge the reality gap that exists between the robot 1 in a simulation and the robot in real-time. Domain randomization helps to bridge this gap by randomizing the physical properties of each simulated robot, including mass variations of ±15%, friction changes of 40%, and sensor noise levels of 1-5%, which simulates a breadth of systems that the policy may have to run on in the real world. This helps the policy to generalize with zero-shot capability to a physical robot without the need for additional fine-tuning reducing deployment time from weeks to hours. The output of the policy can also be run through a kHz-rate closed-loop torque control system with gains tuned for each actuator to compensate for any errors in the actuator modeling typically within 5% of commanded values. The resulting policy is robust to robot-to-robot variations of 10% in parameters, to changes in surface friction from 0.3 to 1.2, and to external pushes up to 200 N, and it produces a repeatable control of the robot across the entire fleet of robots with consistency ratings above 95%. As a result, the disclosed technology can scale in an effective manner without additional engineering effort per robot, thereby supporting broad commercial operations across thousands of units.

iv. Use of the Control Algorithm or Model and Sensor Data

This raw sensor data can then be filtered using Butterworth or Kalman filters, modified through calibration matrices, altered via outlier removal, or changed by the computer 3110 to generate the combined sensor data with noise reduced by 60-80%. The combined sensor data can then be processed by a control algorithm or model that is running on the computer 3110 with computational loads of 1-10 GFLOPS, the piloting control system 3202, and/or the whole body controller 1550 of the robot 1. The processing of said sensor data by the control algorithm or model will generate control information that is designed to be sent to the motor controllers operating at PWM frequencies of 10-50 kHz that govern the one or more actuators (J1-J7) of the arm of the robot 1, or other controlled parts of the robot 1, causing these actuators to move in accordance with the desired motion that was derived from the input of the operator (H) with motion fidelity above 95%. For example, the raw sensor data from the mobile data collection apparatus 3200 may be transformed to control information for consumption by the robot 1 in real time with end-to-end latencies under 50 ms.

v. Collection and Use of the Training Data

Once the robot 1 has received and moved according to the robot data, such as the joint commands with position accuracies of 0.1-1 mm, the WBC 1550, or other subsystems on the robot 1, collects the training data that results from the actuator movements and the sensor readings from the sensors of the robot 1 at rates of 100-1000 Hz. This training data can then be communicated to the central data storage database 2900 for the purpose of logging and later analysis or model training with data throughputs of 10-100 MB/s. It may also be communicated back to the mobile data collection apparatus 3200, specifically to the piloting control system 3202, to enable a closed-loop haptic feedback experience for the operator (H) with feedback latencies under 20 ms. For example, the collected training data may include: measured forces and torques from sensors located in the joints or end-effectors of the robot 1 with force ranges of 0.1-1000 N and torque ranges of 0.01-500 Nm, control signals that were sent to and/or received from the actuators of the robot 1, such as commanded vs. actual currents differing by less than 5%, torques with tracking errors under 2%, or positions with errors under 0.5 mm, measured actuator position data from encoders on the robot 1 with resolutions of 12-20 bits, velocity data which may be derived or measured for the robot 1 ranging from 0.01-10 m/s, acceleration data from IMUs on the robot 1 or derived with ranges of 20 g, video feeds from the onboard cameras of the robot 1, such as a stereo pair or head cameras at 30-120 fps with resolutions from 720p to 4K, data from other onboard sensors of the robot 1, such as LiDAR providing 300,000 points/second or tactile sensors with spatial resolutions of 1-5 mm, and internal state information from the WBC 1550 of the robot 1 including joint states, end-effector poses, and balance metrics updated at 500-1000 Hz.

This collected training data, along with the corresponding sensor data from the mobile data collection apparatus 3200, and the robot control data from the apparatus 3200, may undergo various processing steps which are performed by the computer 3110, either offline or online. These steps might include filtering out noise using digital filters with 20-40 dB noise reduction, synchronizing the timestamps across the various data streams to within 1 ms accuracy, labeling segments of data according to the task that was performed with over 100 task categories, refining the pose estimates of both the operator (H) and the robot 1 to sub-centimeter accuracy, and modifying or augmenting the data with techniques such as time warping, noise injection, or trajectory perturbation, in order to generate structured training data that is suitable for training machine learning models with dataset sizes ranging from 10⁴ to 10⁷ samples.

These models could include general Machine Learning (ML) models for specific tasks, like object recognition by the robot 1 achieving mAP scores above 0.8, or they could be comprehensive policies like Bipedal Action Models (BAMs) with 10⁸ to 10⁹ parameters or Large Language Models (LLMs) that have been adapted for robotic control with context windows of 4096-32768 tokens, which are sometimes referred to as MLLMs. These trained models may subsequently be run on one or more robots, like the robot 1, for autonomous operation achieving task success rates above 90%, in the cloud for large-scale analysis or simulation with thousands of parallel instances, or in a hybrid fashion balancing edge and cloud compute. The structured training data may also be used for the performance analysis of the operator (H) generating metrics such as task completion time, movement efficiency, and error rates, or for refining the control algorithms of the system 3010 through iterative optimization achieving performance improvements of 10-30% per iteration.

In further embodiments, the system 3010 may obtain a magnetic field map of the training environment with spatial resolutions of 10-50 cm and field strength measurements accurate to 1 μT. This map can help operators avoid areas with high magnetic interference exceeding 100 μT, adjust the environment to minimize disturbances by relocating ferromagnetic objects, or allow advanced models on the computer 3110 to correct drift based on the magnetic field map reducing heading errors by 50-70%. For instance, if a high magnetic field exceeding 50 μT is detected, the model may apply a specific set of weights to compensate with correction factors of 1.2-2.0, while a different set may be used in low magnetic field areas below 10 μT. Additionally or alternatively, the IMUs may be enclosed within shielding materials such as mu-metal or soft iron providing 20-40 dB attenuation to reduce exposure to external magnetic fields, mitigating drift in measurements to rates below 1 degree/hour.

The magnetometers within each IMU may also be manually recalibrated taking 30-60 seconds or recalibrated over the network 2999A-X with remote calibration protocols. Calibration can occur upon startup taking 5-10 seconds, at predefined intervals (e.g., every 30 minutes, 10 minutes, 1 minute, 30 seconds, 15 seconds, every second, or fractions of a second), or continuously through automatic processes updating every 100 ms. Calibration techniques may include hard-iron and soft-iron compensation, temperature coefficient correction, and eight-figure calibration patterns.

d. Alternative Mobile Data Collection Apparatus

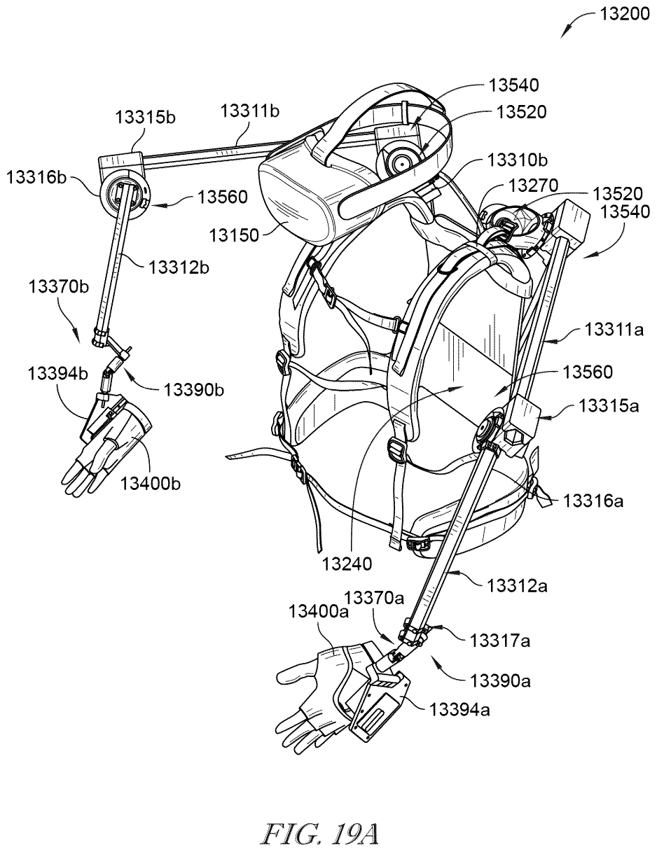

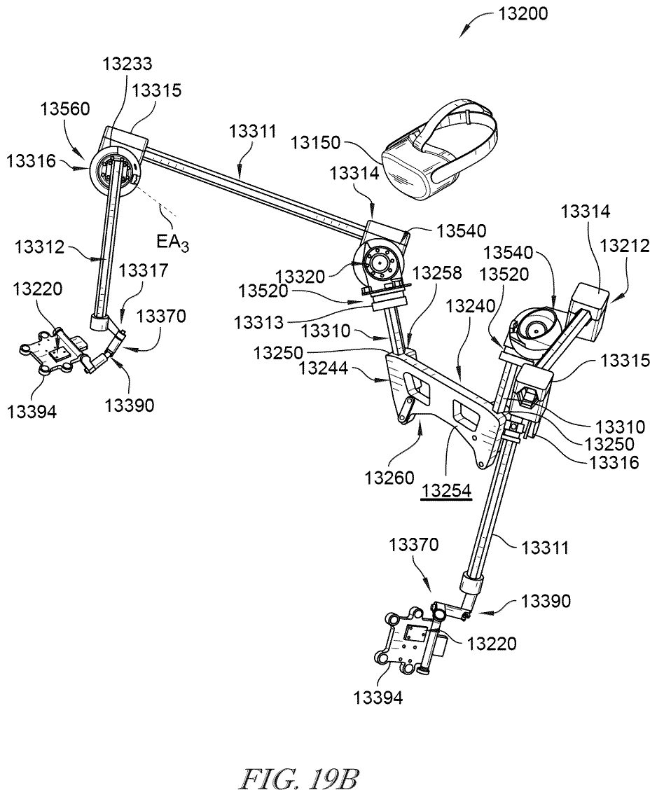

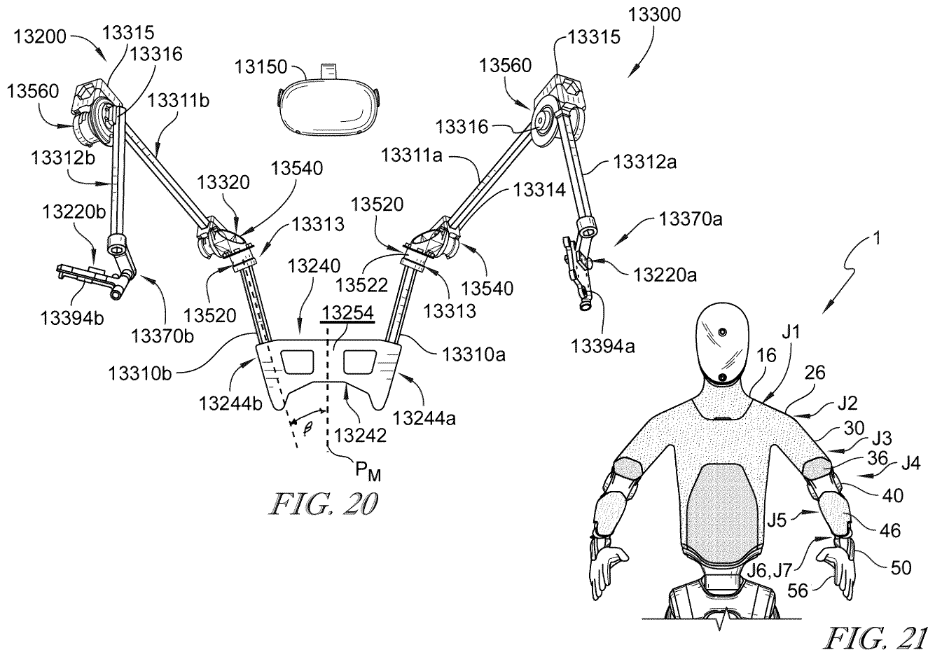

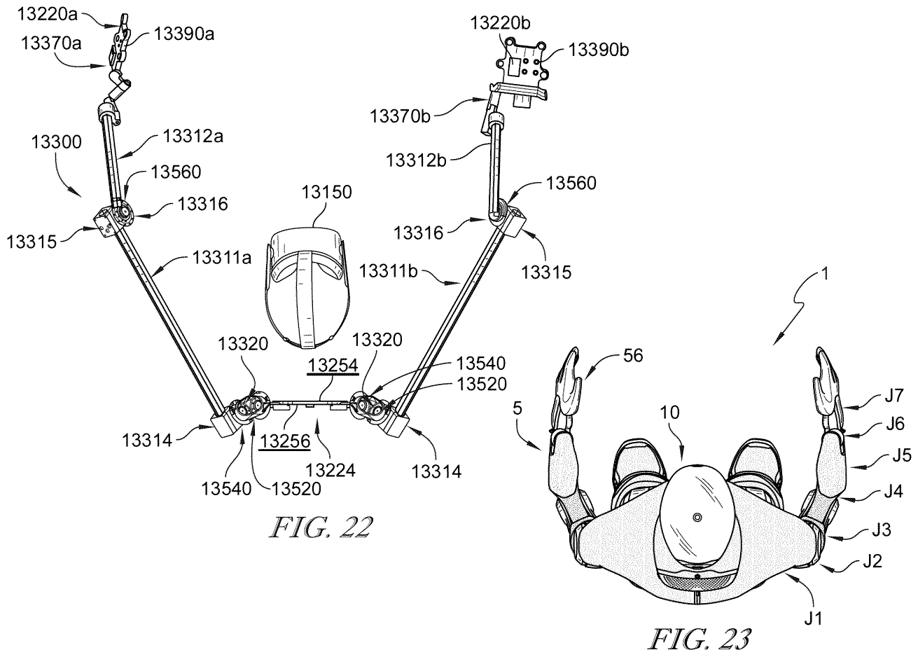

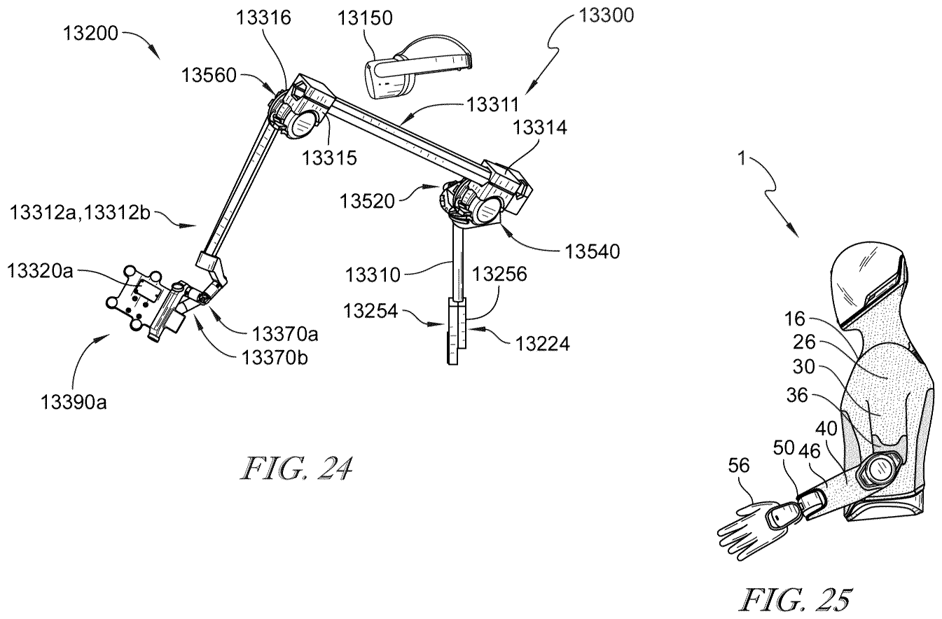

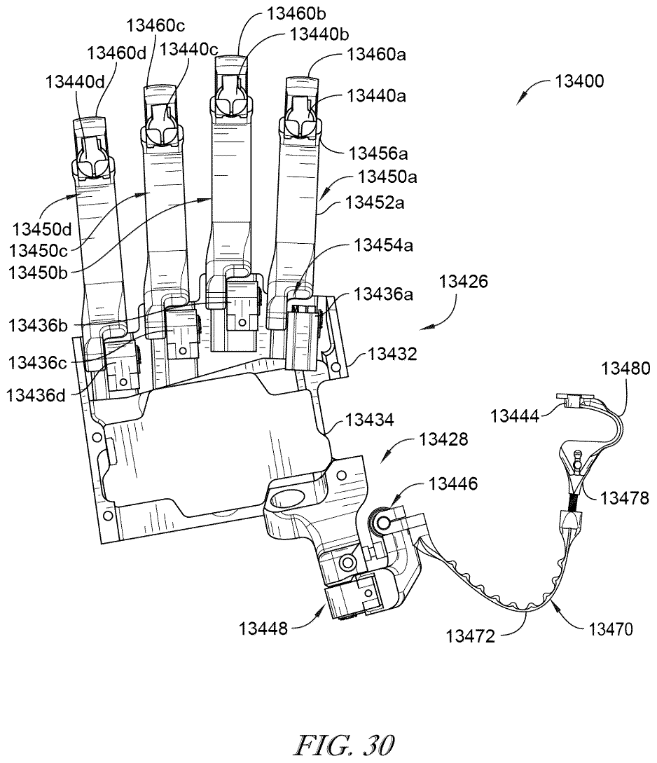

Referring to FIGS. 19A-30, a second embodiment of the portable data collection system 13010 may utilize a mobile data generation apparatus 13200 that is designed to provide haptic feedback to the operator (H). For sake of brevity, the above disclosure in connection with the data collection system 3010 will not be repeated below, but it should be understood that across embodiments like numbers represent like structures. As such, the base mount 13240 and wrist assembly 13370 are substantially the same as the first embodiment in terms of overall structure and function. The primary difference between the second embodiment of the portable data collection system 13010 and the first embodiment portable data collection system 3010 is that the second mobile data generation apparatus 13200 is configured to provide haptic feedback to the operator (H) through the use of actuators 13520, 13540, and 13560, which are strategically positioned at the joints of frame links 13300 of the apparatus 13200. Said haptic feedback to the operator (H) is beneficial because it allows the operator (H) to feel or experience the forces that the robot 1 is experiencing during completion of a task. For example, this may help ensure that operator (H) does not apply too much pressure to the robot's hands 56 during a teleoperation session, which could cause the robot 1 to fall over or damage its fingers.

To collect the sensor data and provide haptic feedback to the operator (H), the mobile data generation apparatus 13200 may include: (i) a piloting control system 13202, (ii) a data storage 13204, (iii) a battery 13206, (iv) sensors 13208, (v) other circuitry 13209, (vi) frame linkages (e.g., articulated arms 13300), and (vii) actuators 13520, 13540, and 13560. Subsequent to the capture of the sensor data, the apparatus 13200 can be configured to transfer said sensor data to another system component in data communication with each other via a network 2999A-X. The mobile data generation apparatus 13200 may include the second embodiment gloves 13400 described below. In alternative embodiments, the first embodiment gloves 3400, third embodiment gloves 23400, or other alternative gloves may be utilized with the mobile data generation apparatus 13200.

i. Articulated Arms—Actuated

Referring to FIGS. 19A-27, left and right articulated arms 13300 extend from the base frame 13240 and are configured to move with the arms of the operator (H) wearing the mobile data generation apparatus 13200 as the operator (H) performs tasks. These tasks may include sensor data acquisition, control operations, robot interactions, and training exercises for various manipulation and locomotion scenarios. Each articulated arm 13300 includes (i) three (3) individual rigid frame links 13310-13312, where the first frame link 13310 is coupled to the base mount 13240, (ii) a base actuation assembly 13362 coupled between the first and second frame link 13310, 13311, (ii) a medial actuation assembly 13360 coupled between the second and third frame link 13311, 13312, (iii) a wrist assembly 13370 coupled to the distal end of the third frame link 13312. The wrist assembly 13370 includes a wrist component 13390 and a glove mount 13394, where the glove mount 13394 is further configured to couple with the glove 13400 suitable to be worn by the operator (H). The base and medial assemblies 13362, 13360 include three actuators 13520, 13540, 13560 configured to provide resistive forces at the wrist component 13390 for haptic feedback as the operator (H) performs a remote task.

### 1. Base Actuation Assembly

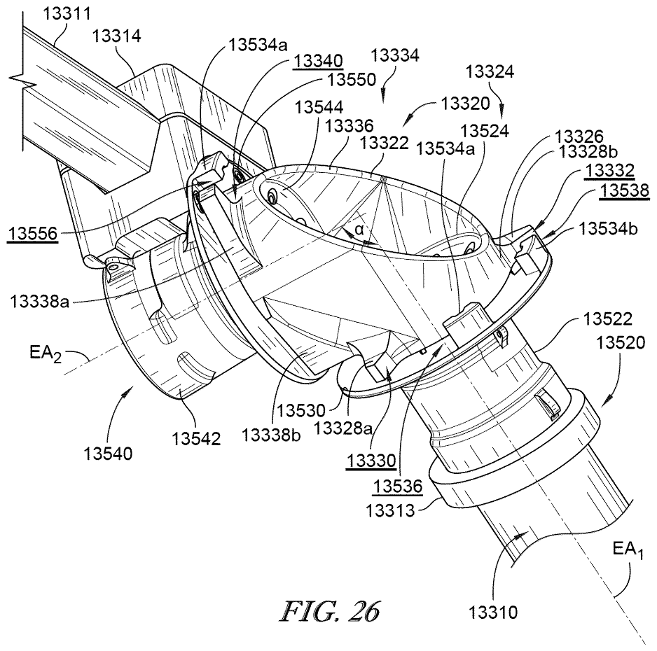

The base actuation assembly 13362 includes a first actuator 13520, a second actuator 13540, and an actuator output coupler 13320, as shown in at least FIG. 26. The first actuator 13520 is coupled to the first frame link 13310 via a first joint coupler 13313 to provide a stable mounting point. The first actuator 13520 comprises a first actuator housing 13522 and a first output mount 13524 that rotates about a first rotational axis EA₁. The second actuator 13540 comprises a second actuator housing 13542 and a second output mount 13544 that rotates about a second rotational axis EA₂. The first and second actuators 13520, 13540 are arranged such that the first rotational axis EA₁ of the first actuator 13520 is positioned at a predetermined angle alpha (α) with respect to the second rotational axis EA₂ of the second actuator 13540. Said predetermined angle alpha (α) may be between 1 degree and 180 degrees, preferably between 70 and 110 degrees, and most preferably 90 degrees. In the illustrative embodiment, the predetermined angle alpha (α) is preferably 90 degrees; thus, the first rotational axis EA₁ and the second rotational axis EA₂ are orthogonal to each other to provide independent control of two rotational degrees of freedom. The first actuator 13520 and the second actuator 13540 are coupled to each other by the actuator output coupler 13320. The actuator output coupler 13320 is coupled to the first output mount 13524 and the second output mount 13544 of respective actuators 13520, 13540.

The first actuator housing 13522 includes a first output mounting ring 13530 that surrounds the first output mount 13524 and provides structural support. The first output mounting ring 13530 includes a first interface surface 13532 that faces outward and a first limiter 13534 that protrudes from the first interface surface 13532. The first limiter 13534 has first and second limit walls 13536, 13538 that are substantially perpendicular to the first interface surface 13532 to define the range of motion. In the illustrative embodiment, the first limiter 13534 is discontinuous and defined by two limit projections 13534a, 13534b, where the first limit projection 13534a includes the first limit wall 13536 and the second limit projection 13534b includes the second limit wall 13538, as shown in FIG. 26. The first actuator housing 13522 is coupled to the first frame link 13310 by a first joint coupler 13313 and held in a fixed position with respect to the base frame 13240. For example, the first actuator 13520 is arranged such that the first rotational axis EA₁ is positioned at an angle beta (β) with respect to a midline plane Pₘ (e.g., sagittal plane) of the base frame 13240 that defines the left and right portions of the mobile data generation apparatus 13200. For example, the angle beta (β) can be between 0 and 90 degrees with respect to the midline plane Pₘ, and preferably between 30 and 60 degrees. Similarly, the second actuator housing 13542 includes a second output mounting ring 13550 that surrounds the second output mount 13544. The second output mounting ring 13550 includes a second interface surface 13552 that faces outward and a second limiter 13554 that protrudes from the second interface surface 13552. The second limiter 13554 has first and second limit walls 13556, 13558 that are substantially perpendicular to the second interface surface 13552. The second actuator housing 13542 is coupled to the second frame link 13311 by a second joint coupler 13314.

As shown in FIG. 26, the actuator output coupler 13320 includes a coupling body 13322 having first and second coupling portions 13324, 13334 that mechanically link the two actuators. The actuator output coupler 13320 is configured to couple the first and second output mounts 13524, 13544 of the first and second actuators 13520, 13540 to each other at the predetermined angle alpha (e.g., 90 degrees). The first portion 13324 of the actuator output coupler 13320 includes a first coupling mount 13326 and a first limit projection 13328. The first coupling mount 13326 is configured to couple to the first output mount 13524 of the first actuator 13520 and rotate therewith during operation. The first limit projection 13328 projects radially outward from the coupling body 13322 at the first coupling mount 13326. The first limit projection 13328 has a first limit face 13330 configured to contact the first limit wall 13536 of the limiter 13534 of the first actuator 13520 to limit the rotational motion of the articulated arm 13300 at the first actuator 13520. The first limit projection 13328 may also have a second limit face 13332 that may contact the second limit wall 13538 of the limiter 13534 when rotated in the opposite direction. In the illustrative embodiment, the first limit projection 13328 is discontinuous and shown as two limit projections 13328a, 13328b, where the first limit projection 13328a includes the first limit face 13330 and the second limit projection 13328b includes the second limit face 13332, as shown in FIG. 26. Similarly, the second portion 13334 of the actuator output coupler 13320 includes a second coupling mount 13336 and a second limit projection 13338. The second coupling mount 13336 is configured to couple to the second output mount 13544 of the second actuator 13540 and rotate therewith. The second limit projection 13338 projects radially outward from the coupling body 13322 at the second coupling mount 13336. The second limit projection 13338 has a first limit face 13340 configured to contact the first limit wall 13556 of the limiter 13554 of the second actuator 13540 to limit the rotational motion of the articulated arm 13300 at the second actuator 13540. The second limit projection 13338 may also have a second limit face 13342 that may contact the second limit wall 13558 of the limiter 13554 when rotated in the opposite direction. In the illustrative embodiment, the second limit projection 13338 is discontinuous and shown as two limit projections 13338a, 13338b.

In particular, the second frame link 13311 includes a proximal link coupler 13352 and a distal link coupler 13354 at opposite ends. The proximal link coupler 13352 is configured to couple the second actuator housing 13542 of the base actuation assembly 13362 to the second frame link 13311 at a proximal end portion. The second frame link 13311 moves as the coupled first and second output mounts 13524, 13544 of actuators 13520, 13540 change position through coordinated actuation. In particular, the second output mount 13544 of the second actuator 13540 is fixed with respect to the first output mount 13524 of the first actuator 13520. As such, the second actuator housing 13542 rotates about the second output mount 13544 to change the position of the coupled second frame link 13311. The combination of movements of the first and second actuators 13520, 13540 in the base actuation assembly 13362 orients a distal end portion of the second frame link 13311 through the combined degrees of freedom.

### 2. Medial Actuation Assembly

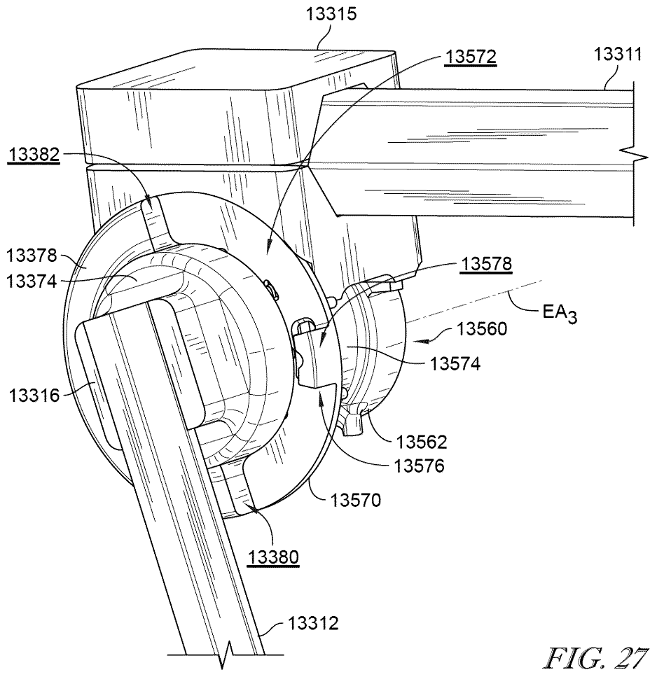

As shown in greater detail in FIG. 27, the medial actuation assembly 13360 is coupled to the distal end portion of the second frame link 13311 and is configured to move the third frame link 13312 and wrist assembly 13370 coupled thereto. The medial actuation assembly 13360 includes a third actuator 13560 having a third rotational axis EA₃ for elbow-like motion. The third actuator 13560 comprises a third actuator housing 13562 and a third output mount 13564 that rotates about the third rotational axis EA₃. The medial actuation assembly 13360 is coupled to the second frame link 13311 such that the third rotational axis EA₃ is positioned parallel to the second rotational axis EA₂ of the second actuator 13540 at a separation distance corresponding to the link length. The third actuator housing 13562 includes a third output mounting ring 13570 that surrounds the third output mount 13564. The third output mounting ring 13570 includes a third interface surface 13572 that faces outward and a third limiter 13574 that protrudes from the third interface surface 13572. The third limiter 13574 has first and second limit walls 13576, 13578 that are substantially perpendicular to the third interface surface 13572. The third actuator housing 13562 is coupled to the distal end of the second frame link 13311 via a third joint coupler 13315. In the illustrated embodiment, the second and third actuators 13540, 13560 are positioned on the same side of the second frame link 13311 such that the second rotational axis EA₂ and third rotational axis EA₃ are parallel and coplanar for simplified kinematic calculations.

In the illustrated embodiment, the first and second actuators 13520, 13540 are coupled such that the first and second rotational axes EA₁, EA₂ are arranged perpendicular to each other to position the second frame link 13311 of the actuated arm 13300 with two degrees of freedom at the shoulder region. By locating these actuators 13520, 13540 together in the base actuation assembly 13362 coupled to the base frame 13240, the weight of the actuators 13520, 13540 is positioned in the rear shoulder region of the operator (H) and is distributed, making the actuated arm 13300 lighter in weight at the distal end to facilitate the comfort and ease of use for the operator (H). The arrangement of the third actuator 13560, positioned at the distal end of the second frame link 13311, allows for better positioning of the wrist assembly 13370 of the actuated arm 13300. Although the weight of the third actuator 13560 may produce a moment on the second frame link 13311, the second actuator 13540 can be configured to counteract the effect via the piloting control system 13202 through gravity compensation algorithms.

The third frame link 13312 extends from the medial actuation assembly 13360 to the wrist assembly 13370 and corresponds generally to the forearm of the operator (H). At its proximal end, the third frame link 13312 includes a fourth joint coupler 13316 having a medial actuator output coupler 13374, configured to be coupled to the third output mount 13564 of the third actuator 13560. The medial actuator output coupler 13374 includes a medial coupling mount 13376 and a medial limit projection 13378 projecting radially outward from the medial coupling mount 13376 and configured to travel between the first and second limit walls 13576, 13578 of the third limiter 13574. The medial limit projection 13378 extends circumferentially about the medial coupling mount 13376 for an arc length and is delimited by first and second contact faces 13380, 13382, where the first contact face 13380 is suitable to interface with the first limit wall 13576 and the second contact face 13382 is suitable to interface with the second limit wall 13578 of the third limiter 13574 of the third actuator 13560.

### 3. Actuators Assemblies

The actuators 13520, 13540, 13560 may be engineered to provide the rotational movement for the left and right articulated arms 13300 with precision and responsiveness. These actuators 13520, 13540, 13560 may utilize a range of motor types, including brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. These motors may employ rare-earth permanent magnets, such as neodymium-iron-boron (NdFeB) alloys, samarium-cobalt (SmCo) magnets, ferrite magnets, alnico magnets, flexible magnets, bonded rare-earth magnets, and high-temperature permanent magnets, to achieve high torque density and energy efficiency. Motor windings may include high-conductivity copper wire with ceramic or polyimide insulation for enhanced thermal and electrical performance. For example, the actuators 13520, 13540, 13560 may contain brushless motors and have momentary peak torque ranging from 17.6-26.4 N-m, preferably from 19.8-24.2 N-m.

The motors may be coupled with various high-reduction gear mechanisms designed for precision and load handling in the compact form factor of a wearable device. These may include strain wave gears (e.g., Harmonic drives), cycloidal reducers, planetary gearboxes, bevel gear systems, worm gears, parallel shaft helical gear mechanisms, spur gear assemblies, crossed helical gear systems, double-enveloping worm gears, herringbone gears, hypoid gears, rack-and-pinion systems, bevel hypoid gears, epicyclic gear trains, and differential gear systems. Additionally, some implementations may incorporate custom gear profiles optimized for torque transfer efficiency, backlash reduction, and noise minimization. The selection and design of these gear mechanisms may be tailored to the specific requirements of each joint in the left and right arm frameworks 13300, potentially allowing for a balance between high torque output, precision positioning, and a compact design. Manufacturing techniques, such as precision machining, additive manufacturing, or surface treatments, may be employed in the production of these gear systems to enhance their performance characteristics and durability.

Additionally, each actuator 13520, 13540, 13560 may also include various types of bearings, such as cross-roller bearings, angular contact ball bearings, thrust ball bearings, tapered roller bearings, spherical roller bearings, cylindrical roller bearings, needle roller bearings, deep groove ball bearings, and hybrid ceramic bearings. To further optimize performance, the rolling elements of the bearings may be composed of ceramic materials (e.g., silicon nitride, tungsten carbide, or zirconia), sapphire, or composite materials combining ceramic with metal or polymer matrices. Manufacturing techniques, including additive manufacturing methods like selective laser melting (SLM), could be employed to create complex bearing geometries, housings, or other components of the actuators 13520, 13540, 13560. These geometries may integrate features such as internal cooling channels, lubrication reservoirs, or textured surfaces to enhance lubrication retention and minimize wear. The incorporation of such features may allow for improved thermal management, reduced friction, and consistent lubrication distribution, even under challenging operating conditions. Additive manufacturing may also enable the production of customized bearing designs with minimal material waste, aligning with sustainable manufacturing practices.

In addition to additive manufacturing, other processes like precision machining, laser hardening, or chemical vapor deposition (CVD) coatings may be applied to enhance the surface properties of the bearings. These techniques may improve wear resistance, reduce friction, and provide protection against corrosion, further extending the operational life of the components. Additionally, damping elements, such as elastomeric bushings, may be incorporated to absorb vibrations and reduce mechanical stresses during operation. The selection of coupling mechanisms may be tailored to the specific requirements of each joint, considering factors such as load capacity, misalignment tolerance, and damping characteristics.

To achieve positional accuracy and ensure reliable operation, each of the actuators 13520, 13540, 13560 may be equipped with encoders 13211, 13212, 13213. The encoders 13211, 13212, 13213: (i) may include two encoders that are offset from one another by 180 degrees for redundancy and error detection, and (ii) may be or may utilize any aspect of the following technology: optical encoder, magnetic encoder, capacitive encoder, inductive encoder, resistive encoder, laser encoder, ultrasonic encoder, microwave encoder, linear potentiometer, rotary potentiometer, LVDT (Linear Variable Differential Transformer), resolver, string pot (draw-wire sensor), inclinometer, optical grating scale, magnetic grating scale, laser interferometer, fiber optic sensor, micro-electromechanical systems (MEMS) gyroscopes and accelerometers, digital encoder, absolute encoder, incremental encoder, gray code encoder, binary code encoder, piezoelectric, hall-effect, and ultrasonic sensors. These encoders may facilitate sub-millimeter-level accuracy in position sensing.

To complement positional data, said actuators 13520, 13540, 13560 may include integrated torque sensors that have strain gauges, piezoresistive sensors, magnetoelastic sensors, capacitive sensors, fiber-optic sensors, or rotary transformers. The strain gauges may be of any type, which includes: (i) linear strain gauges, (ii) double linear strain gauges, (iii) shear or torsional strain gauges, (iv) rosette strain gauges (T (or Tee) shaped, rectangular shaped, delta shaped, stacked), (v) diaphragm strain gauges, (vi) biaxial strain gauges, (vii) bi-directional strain gauges, (viii) stacked strain gauges, (ix) cross strain gauges, (x) double shear strain gauges, (xi) circular strain gauges, (xii) any hybrid or combination thereof, and (xiii) any other suitable strain gauge type that is known to one of skill in the art. The strain gauges may be arranged in different configurations including: (i) quarter-bridge configurations, (ii) half-bridge configurations, and (iii) full-bridge configurations.

It should be understood that other sensors and technology may be used instead of or in combination with the sensor assemblies discussed above for comprehensive measurement capabilities. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Brüel & Kjær, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacturer), (iv) inductive strain gauges, (v) capacitive strain gauges, (vi) piezoelectric strain gauges, (vii) optical fiber strain gauges, (viii) semiconductor strain gauges, (ix) foil strain gauges, (x) ink-based strain gauges, and (xi) a hybrid or combination thereof. The foil strain gauges may be made from or include: (i) foils that may be or may include constantan (copper-nickel alloy), karma (nickel-chromium alloy), isoelastic (nickel-iron alloy), evanohm (nickel-chromium alloy), nichrome v (nickel-chromium alloy), and (ii) a carrier that may be or may include polyimide film, epoxy or phenolic resin, glass-fiber reinforced epoxy, ceramic backing, and polyurethane. The strain gauges may be used in combination with other sensors in the sensing assembly or at alternate locations in the robot 1. Other sensors or technology that may replace or be added to the actuators may include sensors within the bearing housing to allow for monitoring of parameters such as temperature, vibration, and load.

Additionally or alternatively, the actuators 13520, 13540, 13560 may include current sensors, such as Hall-effect sensors, shunt resistors, fluxgate sensors, Rogowski coils, or magnetoresistive sensors for motor control and torque estimation. Furthermore, the system may incorporate micro-electromechanical systems (MEMS) gyroscopes and accelerometers, which provide additional sensory data related to orientation, angular velocity, and linear acceleration. This sensory integration may enhance the ability of the robot 1 to navigate complex environments and maintain stability during operation. The multi-modal sensing approach may allow for redundancy and cross-validation of sensor data, potentially improving the overall reliability and accuracy of the movements of the robot 1. In summary, it should be understood that the actuators 13520, 13540, 13560, the mobile data generation apparatus 13200, and/or the robot 1 may include any part, component, assembly, or technology of any sensor disclosed herein or that would be obvious to one of skill in the art based on the parts, components, assemblies, or technologies disclosed herein.

In another embodiment, the mobile data generation apparatus 13200 may be configured with additional actuators or sensory feedback components designed to enhance the ability of the operator (H) to perceive and interact with the environment in a manner analogous to the sensory experiences of the robot 1. These actuators may include, but are not limited to, vibrotactile stimulators, electromechanical transducers, and force-feedback mechanisms, all of which are strategically integrated into the mobile data generation apparatus 13200 to simulate tactile, pressure, temperature, or proprioceptive sensations. For instance, vibrotactile actuators may be embedded within the mobile data generation apparatus 13200 at key contact points, such as the fingertips, palms, or forearms, to simulate surface textures, material properties, or the sensation of contact with objects. These actuators may utilize piezoelectric elements, linear resonant actuators (LRAs), or eccentric rotating mass (ERM) motors to generate localized vibrations corresponding to sensory input received by the robot 1. The intensity, frequency, and duration of these vibrations may be modulated in real-time based on data from the sensors of the robot 1, allowing the operator (H) to experience variations in surface roughness, object hardness, or environmental conditions with high fidelity.

Additionally, force-feedback actuators may be incorporated into the mobile data generation apparatus 13200 to provide resistance, pressure simulation, or kinesthetic feedback that corresponds to forces encountered by the robot 1. These actuators may be based on pneumatic, hydraulic, or electromechanical principles, employing linear actuators, artificial muscles, or torque-generating motors to resist the movements of the operator (H) in a manner that mimics the physical interactions of the robot 1. For example, if the robot 1 encounters an obstacle that involves forceful manipulation, the mobile data generation apparatus 13200 may apply a proportional resistance to the hand of the operator (H), providing an intuitive sense of the exertion used. Furthermore, the mobile data generation apparatus 13200 may include temperature-responsive elements such as thermoelectric modules or resistive heating elements to convey thermal sensations experienced by the robot 1. These elements may simulate temperature gradients, allowing the operator (H) to distinguish between hot and cold surfaces, which may be beneficial for certain applications involving hazardous environments or delicate materials handling.

Alternative embodiments may also integrate electrotactile stimulation devices that deliver low-level electrical impulses to the skin, creating a sensation of touch or pressure without mechanical movement. This technology, based on transcutaneous electrical nerve stimulation (TENS) or electrocutaneous stimulation, may enable highly localized and nuanced feedback, enhancing the sensory experience of the operator (H) beyond traditional haptic methods. In some variations, the mobile data generation apparatus 13200 may be modular, allowing for customization based on the specific training scenario or application. Interchangeable actuator modules may be employed, enabling operators (H) to configure the system with the most suitable feedback mechanisms for a given task. For example, an operator (H) engaged in training for robotic-assisted surgery may prioritize fine tactile feedback, while an industrial worker operating a robotic manipulator may benefit from force-feedback actuators that simulate mechanical resistance.

ii. Glove—Second Embodiment

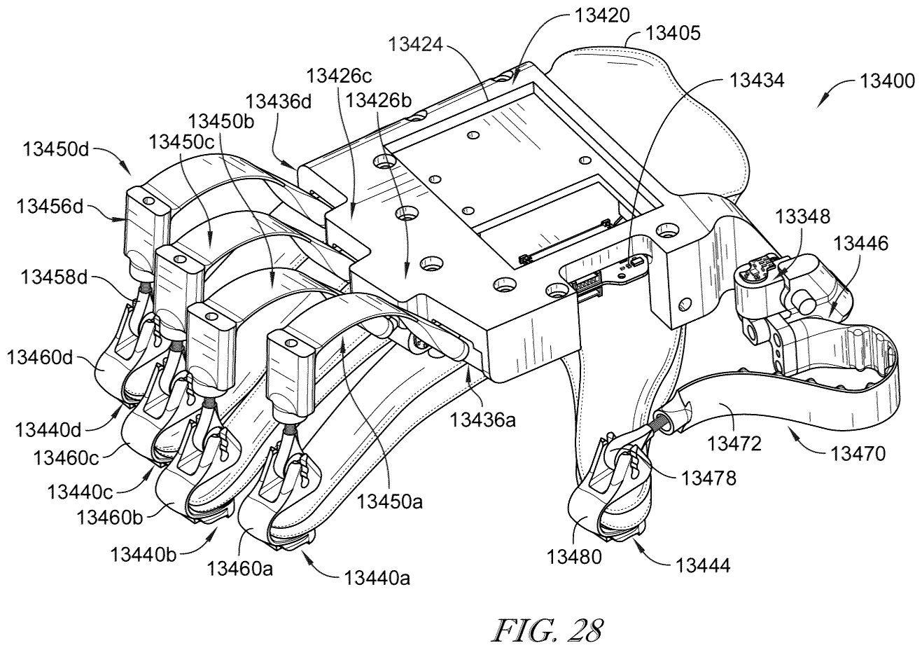

Referring to FIGS. 28-30, the portable data collection system 13010 may include a second embodiment glove 13400 coupled to the glove mount 13394 of the articulated arms 13300 through mechanical interfaces designed for quick attachment and removal. The glove 13400 is configured to be worn on the hands of an operator (H) to capture the location data of the operator's hand, palm, and/or fingers with sufficient resolution for dexterous manipulation tasks. To achieve this, the glove 13400 may include a plurality of hand position sensors 13410 arranged to capture comprehensive hand kinematics. In some embodiments, the IMU 13220 may be coupled to the glove mount 13394 near the glove 13400, maintaining proximity to the hand for accurate measurements. In certain embodiments, the glove 13400 may include an IMU 13220, for example, located on the dorsal side of the hand at the connection of the glove 13400 to the glove mount 13394, providing six-axis motion sensing.

As best shown in FIGS. 28-30, the gloves 13400 of the mobile data collection apparatus 13200 utilize mechanical linkages to determine the location of the operator's hands and fingers with high precision. The glove 13400 includes a hand receptacle 13405 constructed from a flexible textile, such as breathable fabric, with a sensor assembly 13420 coupled to it through secure mounting interfaces. The sensor assembly includes a plurality of hand position sensors 13410 including encoders 13436a-d, 13446, 13448 and haptic buttons 13440a-d and 13444. In particular, the glove sensor assembly 13420 includes: (i) a housing 13424 configured to couple to the glove mount 13394, (ii) a multi-layer PCB 13434 for signal routing, (iii) finger encoders 13436a-d with of 12-14 bit resolution, (iv) thumb encoders 13446, 13448 providing two axis-tracking, (v) haptic buttons (e.g., a vibrating motor) 13440a-d and 13444 with force thresholds of 2-5 N, and (vi) deformable connectors 13450a-d and 13470 constructed from flexible polymer materials. In various embodiments, the glove 13400 may also include an IMU 13220 providing 6-DOF hand orientation data. Each of the finger encoders 13436a-d, thumb encoders 13446, 13448, haptic buttons 13440a-d, 13444 are communicatively coupled to the hand PCB 13434 contained in the housing 13424 through flexible circuit connections.

The glove sensor assembly 13420 is coupled to hand receptacle 13405, which may be made from a textile material and formed to fit a human hand with sizes from XS to XL, where the housing 13424 of the glove sensor assembly 13420 includes a mounting surface 13422 configured to couple with the glove mount 13394 using quick-release mechanisms. The housing 13424 is shaped and sized with a width that is substantially similar to the width of the hand at the metacarpophalangeal (MCP) joints of the hand, where the operator's fingers extend. A distal portion 13426 of the housing 13424 is configured with apertures from which the deformable connectors 13450a-13450d extend with minimal friction. A proximal portion 13428 of the housing 13424 includes a mounting structure 13430 for the first and second thumb encoders 13446, 13448 and the deformable connector 13470, positioned to align with natural thumb motion arcs.

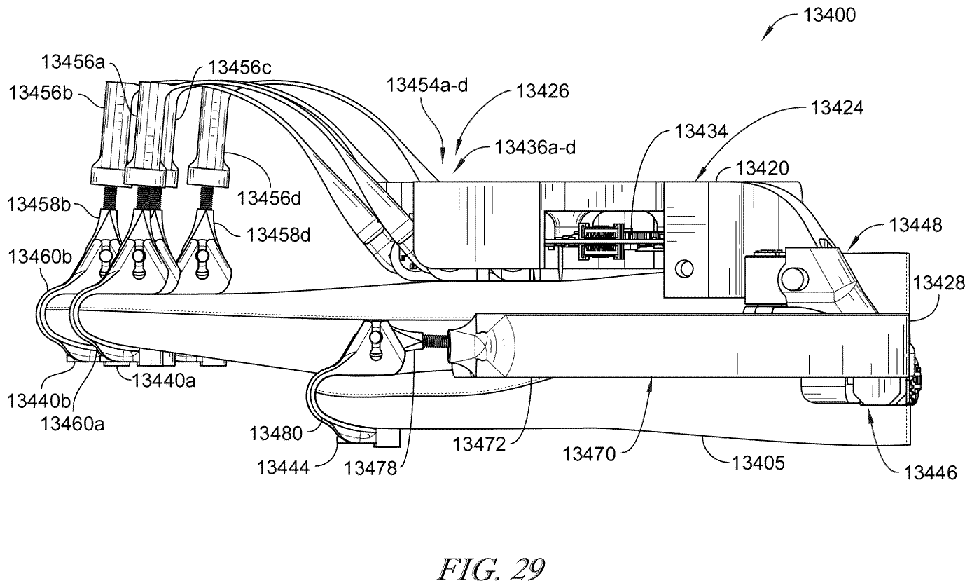

As best shown in FIG. 29, the housing 13424 includes finger encoders 13436a-d positioned within a distal portion 13426 of the housing 13424 with center-to-center spacing of 18-22 mm. The finger encoders 13436a-d are (i) positioned to align with the finger portion of the hand receptacle 13405 maintaining anatomical correspondence, (ii) configured to couple with deformable connectors 13450a-13450d through precision bearings, and (iii) are substantially parallel in orientation with alignment tolerances under 2 degrees. In some embodiments, the finger encoders 13436a-d may be angularly offset by a slight angle (e.g., angle less than about 5 degrees) to ensure the operator's finger may move within the hand receptacle 13405 without interfering with the adjacent finger during full flexion.

The deformable connector 13450 includes a deformable member 13452 with a proximal end 13454 configured to pivotably couple to a finger encoder 13436 positioned within the housing 13424 and a distal portion 13456 configured to couple to the haptic button 13440, which is coupled to a tip of the finger portion on a palmar side of the glove. The deformable member maintains consistent force transmission while allowing 3D finger motion. In the illustrative embodiment, the distal end 13456 is coupled to an eyelet 13458 with an inner diameter of 3-5 mm and tip guard 13460 that couples with the tip of the finger of the glove 13405. By positioning an axis portion of the tip guard 13460 within the eyelet 13458, the movement of the operator's fingers are less restricted and may curl to grasp objects with grip apertures from 0-150 mm.

The distal portion 13456 may be more rigid with a stiffness 2-3× greater and defined than a deformable mid-section of the deformable member 13452. The shape of the distal portion 13456 may be configured to hold the eyelet 13458 in a substantially perpendicular orientation, extending upward with respect to the haptic button 13440 when the hand is placed with the palm on a flat support surface. This orientation holds the axis portion of the tip guard 13460 in a substantially parallel arrangement with respect to the axis of the finger encoder 13436 maintaining alignment within 5 degrees. This parallel arrangement reduces error in the measurements to a single-direction for rotation with angular errors under 1 degree.

To make the gloves 13400 more comfortable to wear and use, the deformable member 13452 is configured to: (i) bend or deform in a first inward direction in order to allow the user to curl their fingers towards the palm after the finger encoders 13436a-d have reached their minimum curled position, and (ii) bend or deform in a second lateral direction in order to allow the use to abduct/adduct their fingers. However, a significantly greater lateral force (e.g., any value between 1× and 130×) must be applied on the deformable member 13452 to move said deformable member 13452 a predetermined distance (e.g., 1 mm) in the lateral direction in comparison to the curling force that is applied on the deformable member 13452 to move said deformable member 13452 the predetermined distance in the curling direction. In other words, the deformable member 13452 will move or deform along an arched or curved curling direction a greater amount in comparison to the amount said deformable member 13452 will move or deform in the lateral direction when the same amount of force is applied to the deformable member 13452 in both directions. As such, the deformable member 13452 will move or deform along an arched or curved curling direction with less force than the deformable member 13452 will move or deform along the lateral direction.

The deformable connector 13470 is coupled to the first and second thumb encoders 13446, 13448 coupled to the mounting structure 13430 at the proximal portion 13428 of the housing 13424. In the illustrative embodiment, the first and second thumb encoders 13446, 13448 are positioned with substantially perpendicular axes (90°±2°) and generally correspond to the position of the first and second thumb actuators located in the hand 56 of the robot 1. Including two thumb encoders 13446, 13448 in the glove 13400 facilitates the kinematic mapping of the measured positions to control functions for the robot 1. The deformable member 13472 includes a proximal end 13474 that couples to the first thumb encoder 13446 and pivots therewith through ranges of 45 degrees. The distal end 13476 of the deformable member 13472 includes a structure to couple an eyelet 13478 and a tip guard 13480 that are substantially similar to the eyelet 13458 and tip guard 13460 of the deformable connectors 13450 for the fingers. The deformable member 13472 may be configured with ribs protruding from at least one surface with rib heights of 1-2 mm, where the ribs help maintain the orientation of the deformable member 13472 with respect to the two thumb encoders 13446, 13448 as the thumb changes position through its range of motion.

This alternative glove 13400 provides substantial advantages over the glove 3400 described above because it is less expensive to manufacture with cost reductions of 40-60% and does not use a magnetic field to determine calculations eliminating electromagnetic interference issues, but instead utilizes only a single-direction encoder for each finger and two single-direction encoders for the thumb. The use of said single-direction encoder for each finger and thumb allows the data generated by the gloves to better align with the movements of the robot 1 with correspondence errors under 3% and minimizes the mathematical calculations needed to determine the location of a finger in space reducing computational load by 70%. By reducing the mathematical calculations, the glove 13400 can produce more consistent results. In other words, the operator can learn how to use the gloves and achieve proficiency in under 30 minutes and can obtain better control over the robot 1 with task success rates improving by 15-25%.

iii. Advanced Haptics, Actuation, and Operator Feedback

The haptic feedback systems and actuators of the apparatus 13200 may be modified to provide a more immersive and informative experience for the operator (H) through enhanced sensory feedback. Traditional actuators may be replaced or complemented with variable stiffness actuators (VSAs), soft robotic actuators like pneumatic or hydraulic artificial muscles, wearable fluidic muscles, or magnetic levitation-based actuators to provide a wide range of feedback from compliant to rigid, smooth, and highly sensitive.

Advanced proprioceptive feedback may be used, including Functional Electrical Stimulation (FES) pads that apply low-level electrical stimulation to the operator's muscles to create an involuntary tension that mimics the robot's 1 exertion. High-fidelity tactile simulation can be achieved through microfluidic haptic gloves or through ultrasound haptic projectors that project focused acoustic pressure points in mid-air. The system may also provide advanced haptic and sensory feedback through Peltier elements for thermal feedback, actuators delivering directional haptic patterns, and pressure-sensitive smart textiles. Haptic feedback may also be paired with spatialized audio cues for an immersive audio-enhanced experience.

Furthermore, the system can provide sensory substitution and augmentation capabilities. Sonification of non-human senses could translate data from sensors for radiation or chemical compounds into audio cues. Haptic “cognitive” feedback could provide feedback on the robot's 1 internal state, such as a vibration to indicate high uncertainty in the robot's control model. The system may also support passive haptic observation, or “haptic ghosting,” where a remote observer or trainee can feel the haptic feedback being experienced by the primary operator 3001 without being able to send control signals, providing an immersive method for training and observation.

### e. Alternative Embodiments

In alternative embodiments, the data collection system 3010 or 13010 may be adapted for various glove embodiments 3400, 13400, 23400, and other variations detailed below. In each embodiment, the data collection system and mobile data collection apparatus remain substantially similar to the illustrative data collection system 3010, where the mobile data collection apparatus 3200 is adapted to include an alternative glove and/or hand sensors and the piloting control system 3202 is adapted to receive and process sensor data from said alternative glove. In summary, each of the disclosed systems 3010, 13010 (including alternative configurations) may be worn by a human operator to collect data for training humanoid robots with data collection rates of 10-100 GB per hour. The collection of this data may be: (i) directly from the mobile data collection apparatus 3200, 13200 with onboard storage capabilities, (ii) directly from the robot 1 based on teleoperation with real-time streaming, or (iii) based on a combination of data collected from the mobile data collection apparatus 3200, 13200 and data collected from a robot 1 during teleoperation enabling multi-modal learning.

It should also be understood that the additional embodiments may be contemplated as discussed herein and said embodiments may be partially or fully combined with any of the above-described embodiments data collection system 3010, 13010. For example, the alternative glove 23400 may be coupled to alternative articulated arms 3300, 13300 creating hybrid configurations. Additionally, the base mount 3240, 13240 and first individual rigid frame link 3310, 13310 may be modified to provide an alternative rear support structure that couples to the adjustable harness 3270, 13270, where the first joint coupler 3313 or first actuator 13520 are arranged at or above the operator's scapula and/or shoulder. Further, the apparatus 3200, 13200 may: (i) omit links for simplified configurations, (ii) include links that are adjustable with 10-20 mm increments, (iii) include rigid links that are not adjusted for fixed anthropometry, (iv) be custom built or printed for a specific operator using additive manufacturing, or (v) include alternative gloves embodiment and/or sensors as described achieving various performance specifications.

i. Glove—Third Embodiment

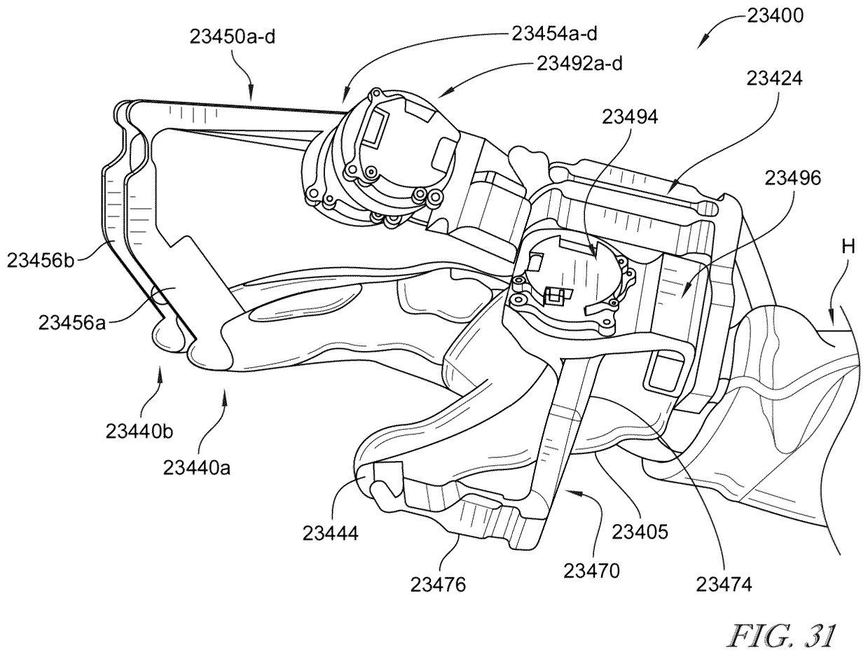

Referring to FIG. 31, a third embodiment glove 23400 may be utilized with the portable data collection system 3010 or 13010. For sake of brevity, the above disclosure in connection with the mobile data collection apparatus 3200 will not be repeated below, but it should be understood that across embodiments like numbers represent like structures. The primary difference between the gloves 13400 of the second embodiment and the gloves 23400 is the addition of motors 23490 positioned at each finger and thumb for active force feedback. The gloves 23400 include deformable members 23450 that extend forward from electric motors 23492a-23492d to a haptic button (e.g., a vibrating motor) 23440a-d. Similarly, for the thumb, gloves 23400 include deformable members 23470 that extends forward from electric motors 23494, 23496 to a haptic button 23444. This enables the gloves 23400 to provide forces on the hand that the robot 1 may experience, wherein said forces that can be exerted on the hand of the operator (H) as haptic feedback. Said haptic feedback to the operator (H) is beneficial because it allows the operator to feel or experience the forces that the robot 1 is experiencing during completion of a task. For example, this may help ensure that operator (H) does not apply too much pressure to the robot's hands 56 during a teleoperation session, which could cause the robot 1 to fall over or damage its fingers.

Referring to FIG. 31, the motors 23492a-d are positioned at a distal portion 23426 of the sensor assembly housing 23424. The motors 23492a-d are (i) positioned to align with the finger portion of the hand receptacle 23405 maintaining anatomical correspondence, (ii) configured to couple with deformable connectors 23450a-d, and (iii) are substantially parallel in orientation. In some embodiments, the motors 23492a-d may be angularly offset by a slight angle (e.g., angle less than about 5 degrees) to ensure the operator's finger may move within the hand receptacle 23405 without interfering with the adjacent finger during full flexion. A proximal portion 23428 of the housing 23424 includes a mounting structure 23430 for the first and second thumb motors 23494, 23496 and the deformable connector 23470, positioned to align with natural thumb motion arcs. The motors 23494, 23496 are positioned perpendicular to each other to provide two degrees of freedom for thumb tracking and feedback. In various embodiments, the finger encoders 23436a-d and thumb encoders 23446, 23448 reside with the motors 23492a-d and thumb motors 23494, 23496.

The piloting control system 23202 may also be configured to integrate various software applications or functionalities. These applications may include, for example: (i) an actuator control application for managing haptic feedback, and (ii) a sensor tracking application, which may incorporate a drift correction algorithm to enhance tracking accuracy.

The actuator control application is designed to precisely modulate the torque output or other control signals that are sent to each actuator, such as motors 23492a-d, 23494, 23496 of the glove 23400 to provide haptic feedback. This application may leverage data from multiple diverse sources, including: (i) simulated data that is generated via computational models which predict dynamic interactions and expected loads based on a virtual environment or a task model, (ii) simulated data that is informed by the state of the robot 1, allowing adaptive learning algorithms to refine actuation patterns based on real-world conditions encountered by the robot 1, and/or (iii) direct data that is received from the robot 1, sourced from its own sensors positioned across the joints, limbs, or end-effectors of the robot 1. This sophisticated integration of data sources allows the actuator control application to deliver haptic feedback to the operator (H) that corresponds to environmental stimuli being experienced by the robot 1. This capability thereby enhances the realism of the training or teleoperation experience by accurately simulating physical interactions and resistances that are encountered during operational scenarios.

In parallel, the sensor tracking application is tasked with the real-time acquisition of data from the array of sensors 23208 that are distributed across the apparatus 23200. The sensor tracking application communicates this collected sensor data to the computer 23110 for further processing, or it may process the data locally within the piloting control system 23202. The computer 23110 and/or the on-board processors that are located within the piloting control system 23202 then operate to refine the raw sensor data. This refined sensor data can then be utilized, in connection with robot control data received from the robot 1, to dynamically adjust the data that is provided to the actuator control application (for the purpose of haptic feedback) and to generate the robot control data that is sent to the robot 1. As will be described in greater detail below, advanced algorithms, including various machine learning models, can be employed to analyze the various data streams, such as the raw sensor data, the refined sensor data, and/or the received robot control data, in order to identify patterns, perform sensor fusion, correct for sensor drift, and optimize control strategies. This comprehensive feedback loop, which incorporates data from the operator (H), the apparatus 23200, and the robot 1, not only improves the performance of the apparatus 23200 in real-time but also contributes to the iterative development of more sophisticated control algorithms (or AI models) that can be tailored to operator-specific training regimens or particular task requirements. This overall system architecture facilitates an adaptive training or teleoperation environment where the mobile data generation apparatus 23200 can continuously adjust its behavior based on accumulated interaction data from the operator (H) and feedback from the robot 1, thereby maximizing both task efficacy and the immersion of the operator.

ii. Additional Tactile Sensors

In various embodiments, the glove 3400, 13400, 23400, or another alternative glove may include additional tactile sensors providing force and pressure feedback capabilities. Said sensors may include one or more strain gauges with gauge factors of 2-200, wherein said strain gauges are positioned on a strain gauge bridge (e.g., spring bridge) with bridge completion resistors matched to within 0.1%, or may be formed in an L-shaped array covering 20-50 square millimeters. The bridge member may have any suitable shape to enable a plurality of strain gauges to be mounted thereto (e.g., rectangular with aspect ratios of 1:1 to 3:1, triangular for three-point sensing, circular for uniform stress distribution, oval for ergonomic considerations, square for simplified mounting, pentagonal, hexagonal, or octagonal for multi-directional sensing, trapezoidal for graduated sensitivity, rhombus for shear measurement, parallelogram for parallel force detection, ellipsoid for reduced stress concentration, crescent for conformal mounting, star-shaped for radial measurements, heart-shaped, diamond-shaped for point loading, heptagonal, decagonal for high-resolution arrays, semicircular for partial coverage, sphere for omnidirectional sensing, cylinder for axial loads, cone for force concentration, pyramid for multi-axis detection, torus for distributed loading, dodecagon for fine angular resolution, scalene triangle for asymmetric loading, isosceles triangle for balanced sensing, equilateral triangle for uniform response, oblong for extended coverage, kite-shaped for specific force vectors, and prism-shaped for three-dimensional force measurement, etc.). The strain gauges may be of any type, which includes: (i) linear strain gauges with active lengths of 1-20 mm, (ii) double linear strain gauges for temperature compensation, (iii) shear or torsional strain gauges with 45-degree grid orientations, (iv) rosette strain gauges (T (or Tee) shaped with 0-45-90 degree orientations, rectangular shaped with 0-45-90 degree arrangements, delta shaped with 0-60-120 degree configurations, stacked for reduced footprint), (v) diaphragm strain gauges for pressure sensing, (vi) biaxial strain gauges for plane stress measurement, (vii) bi-directional strain gauges for orthogonal measurements, (viii) stacked strain gauges for increased sensitivity, (ix) cross strain gauges for multi-axis detection, (x) double shear strain gauges for pure shear measurement, (xi) circular strain gauges for radial stress, (xii) any hybrid or combination thereof achieving combined functionality, and (xiii) any other suitable strain gauge type that is known to one of skill in the art meeting application requirements. The strain gauges may be arranged in different configurations including: (i) quarter-bridge configurations with single active gauges, (ii) half-bridge configurations with two active gauges for temperature compensation, and (iii) full-bridge configurations with four active gauges for maximum sensitivity and temperature compensation.

It should be understood that other sensors and technology may be used instead of or in combination with the sensor assemblies discussed above to achieve comprehensive force and tactile feedback. Other strain gauge technology that may be used includes: (i) mems-based strain gauges with dimensions under 1 mm², (ii) nanocomposite strain gauges with gauge factors exceeding 1000, (iii) thin-film or thick-film strain gauges (e.g., C4A Series with 350Ω resistance or EA Series with 120Ω resistance from Vishay Precision Group, RF9 Series with 0.02% linearity or Y Series with 0.01% accuracy from Hottinger Brüel & Kjær, KFG Series with 2 mm gauge length or KFR Series with 1 mm gauge length from Kyowa Electronic Instruments, TFSG Series with response times under 1 microsecond from BCM Sensor Technologies, SGT Series with operating temperatures to 200° C. or KFH Series with weldable tabs from Omega Engineering, ELF Series with fatigue life exceeding 10⁷ cycles or EPL Series with environmental sealing from Meggitt Sensing Systems, or any other known manufacturer meeting performance specifications), (iv) inductive strain gauges with inductance changes of 1-10%, (v) capacitive strain gauges with capacitance changes of 0.1-1 pF, (vi) piezoelectric strain gauges with charge sensitivities of 1-100 pC/N, (vii) optical fiber strain gauges with Bragg grating wavelength shifts of 1-10 nm, (viii) semiconductor strain gauges with gauge factors of 50-200, (ix) foil strain gauges with thicknesses of 3-5 micrometers, (x) ink-based strain gauges printed with resolutions of 50-200 micrometers, and/or (xi) a hybrid or combination thereof optimizing multiple parameters. The foil strain gauges may be made from or include: (i) foils that may be or may include constantan (copper-nickel alloy with 45% nickel), karma (nickel-chromium alloy with 74% nickel and 20% chromium), isoelastic (nickel-iron alloy with 36% nickel), evanohm (nickel-chromium alloy with 75% nickel, 20% chromium, and 2.5% aluminum), nichrome v (nickel-chromium alloy with 80% nickel and 20% chromium), and (ii) a carrier that may be or may include polyimide film with thickness of 25-50 micrometers, epoxy or phenolic resin with glass transition temperatures above 150° C., glass-fiber reinforced epoxy with elastic moduli of 20-30 GPa, ceramic backing for high-temperature applications above 500° C., and polyurethane for flexible applications with elongations exceeding 100%.

Finally, the strain gauges may be any gauge that meets, uses, and was tested with at least one of the following standards: ASTM E251-13(2018), Standard Test Methods for Performance Characteristics of Metallic Bonded Resistance Strain Gages, ASTM International, ISO 376:2011, Metallic materials Calibration of force-proving instruments used for the verification of uniaxial testing machines, ISO 9513:2012, Metallic materials Calibration of extensometer systems used in uniaxial testing, VDI/VDE 2635 Blatt 2, Experimental structural analysis—Recommendation on the implementation of strain measurements at high temperatures, IEC 61298-3:1998, Process measurement and control devices—General methods and procedures for evaluating performance—Part 3: Tests for the effects of influence quantities, and DIN 51301, which is hereby incorporated by reference for all purposes. The strain gauges may be used in combination with other sensors in the sensing assembly or at alternate locations in the robot 1 to provide comprehensive force feedback data. Other sensors or technology may replace or be added to the tactile sensor assemblies as discussed below, including piezoelectric sensors, capacitive arrays, or optical tactile sensors.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,465, 19/224,109, 19/224,252, 19/249,517, 19/252,392, 19/252,708, 19/286,240, 19/306,591, 19/319,712, 19/323,751, 19/325,486, 19/325,415, 19/322,446, 19/324,342, 19/329,008, 19/329,485, 19/329,559, 19/337,845, 19/337,852, 19/347,690, 19/347,994, 19/351,294, 19/352,959, 19/355,393, 19/355,531, 19/355,786, 19/357,879, 19/362,617, 19/362,708, 19/363,293, 19/371,132, 19/372,574, 19/377,127, 19/378,092, 19/378,308, 19/381,159, 19/384,836, 19/387,569, 19/334,800, 19/325,392, 19/324,895, 19/324,614, 19/392,086 19/337,899, and 19/452,151; and (iii) U.S. Design Patent application Ser. Nos. 29/889,764, 29/928,748, 29/935,680, 29/954,572, 29/967,462, 29/993,115, 29/998,761, 30/024,341, 30/024,351, 30/026,579, 30/026,737, 30/026,738, 30/026,746, 30/026,978, and 30/026,981; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/870,426, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A mobile data collection apparatus for use with a humanoid robot, the apparatus comprising:
a wearable base mount configured to be secured to a torso of a human operator such that the mobile data collection apparatus is carryable by the human operator during operation;
at least one articulated arm extending from the wearable base mount, the at least one articulated arm comprising:
a shoulder joint coupled to the wearable base mount, the shoulder joint comprising a first joint coupler defining a first rotational axis and a second joint coupler defining a second rotational axis;
a first rigid frame link coupled to the shoulder joint;
an elbow joint coupled to the first rigid frame link, the elbow joint defining a third rotational axis;
a second rigid frame link coupled to the elbow joint;
a plurality of joint sensors configured to obtain positional data associated with the shoulder joint and the elbow joint; and
a wrist assembly coupled to a distal end of the second rigid frame link.

2. The mobile data collection apparatus of claim 1, further comprising a distal manipulator coupled to the wrist assembly, wherein the distal manipulator comprises a plurality of buttons.

3. The mobile data collection apparatus of claim 1, wherein the plurality of joint sensors comprises a plurality of encoders and wherein each encoder in the plurality of encoders is a same type of encoder as a corresponding encoder in a corresponding joint of the humanoid robot.

4. The mobile data collection apparatus of claim 3, wherein at least one of the encoders in the plurality of encoders is a 14-bit absolute encoder, and wherein the 14-bit absolute encoder communicates via a CAN bus.

5. The mobile data collection apparatus of claim 1, wherein the wrist assembly comprises (i) a first wrist joint member having a first wrist rotational axis, (ii) a second wrist joint member having a second wrist rotational axis orthogonal to the first wrist rotational axis, and (iii) a joint coupling member connecting the first wrist joint member and the second wrist joint member.

6. The mobile data collection apparatus of claim 1, wherein the mobile data collection apparatus is configured to transmit the positional data obtained by the plurality of joint sensors to a piloting control system that is carried by the wearable base mount.

7. The mobile data collection apparatus of claim 6, further comprising a piloting control system housed in the wearable base mount, wherein the piloting control system is configured to (i) process the positional data obtained by the plurality of joint sensors to generate control information for a humanoid robot for teleoperation and (ii) transmit the control information to the humanoid robot via a wireless network interface.

8. A mobile data collection apparatus, the apparatus comprising:
a wearable base mount configured to be worn on a torso of a human operator such that the mobile data collection apparatus is carryable by the human operator during operation;
at least one articulated arm extending from the base mount, the at least one articulated arm comprising a plurality of rigid frame links coupled by a plurality of joints; and
a plurality of joint sensors, wherein each joint sensor of the plurality of joint sensors is coupled to a respective joint of the plurality of joints and configured to obtain positional data.

9. The mobile data collection apparatus of claim 8, further comprising a wrist assembly and a distal manipulator, the wrist assembly comprising at least two wrist joint members rotatably connected about at least two rotational axes, wherein the distal manipulator is coupled to a distal end of the articulated arm via the wrist assembly.

10. The mobile data collection apparatus of claim 9, wherein the distal manipulator is configured to receive a human hand and comprises a plurality of buttons.

11. The mobile data collection apparatus of claim 9, wherein the plurality of rigid frame links and the plurality of joints in the at least one articulated arm are configured to be manipulated by a human operator exclusively via movement of the distal manipulator during operation.

12. The mobile data collection apparatus of claim 8, wherein at least one of the rigid frame links of the plurality of rigid frame links has an adjustable length.

13. The mobile data collection apparatus of claim 8, wherein the apparatus is communicatively coupled to a piloting control system for teleoperation of a humanoid robot based on the obtained positional data, and wherein an end-to-end latency from obtaining the positional data to transmitting control information to the humanoid robot for teleoperation is less than 20 ms.

14. The mobile data collection apparatus of claim 13, further comprising a display, wherein the mobile data collection apparatus is configured to receive video data from the humanoid robot and present the video data on the display.

15. A mobile data collection apparatus, the apparatus comprising:
a wearable base mount configured to be secured to a torso of a human operator via a harness such that the mobile data collection apparatus is carryable by the human operator during operation;
left and right articulated arms extending from opposing sides of the base mount, each articulated arm respectively comprising:
a first rigid frame link extending from the base mount;
a second rigid frame link rotatably coupled to the first rigid frame link; and
a third rigid frame link rotatably coupled to the second rigid frame link;
a first limiting member and a second limiting member positioned between the first rigid frame link and the second rigid frame link, wherein the first limiting member includes a first hard stop and the second limiting member includes a second hard stop, the first and second hard stops configured to limit rotational motion of the second rigid frame link with respect to the first rigid frame link;
a plurality of encoders distributed along each articulated arm at joints between the rigid frame links; and
a wrist assembly coupled to the third rigid frame link, the wrist assembly comprising (i) a first wrist joint member having a first rotational axis, (ii) a second wrist joint member having a second rotational axis orthogonal to the first rotational axis, and (iii) a joint coupling member connecting the first wrist joint member and the second wrist joint member.

16. The mobile data collection apparatus of claim 15, wherein the first rigid frame link of each articulated arm extends upwardly from the wearable base mount such that, when the wearable base mount is secured to a torso of a human operator, a proximal end of the second rigid frame link is positioned above a shoulder of the human operator.

17. The mobile data collection apparatus of claim 15, wherein at least one of the first rigid frame link, the second rigid frame link, or the third rigid frame link has an adjustable length.

18. The mobile data collection apparatus of claim 15, further comprising a distal manipulator coupled to the wrist assembly, wherein the distal manipulator is configured to receive a human hand and comprises a plurality of buttons.

19. The mobile data collection apparatus of claim 18, wherein at least one button in the plurality of buttons comprises a haptic button having a force threshold between 2-5 N.

20. The mobile data collection apparatus of claim 15, wherein each articulated arm comprises seven axes of rotation, for a total of fourteen axes of rotation between the right articulated arm and the left articulated arm.

21. The mobile data collection apparatus of claim 15, wherein the plurality of encoders comprises at least one 14-bit absolute encoder, and wherein the plurality of encoders communicate via a CAN bus.

22. The mobile data collection apparatus of claim 15, wherein each encoder in the plurality of encoders is a same type of encoder as a corresponding encoder in a corresponding joint of a humanoid robot.

23. The mobile data collection apparatus of claim 15, further comprising one or more wrist IMUs, wherein each wrist IM is coupled to a respective wrist assembly and configured to obtain orientation data associated with at least one wrist joint member.

24. The mobile data collection apparatus of claim 15, further comprising a piloting control system and a communication interface, wherein the piloting control system is configured to transmit positional data obtained from the plurality of encoders to a remote computer via the communication interface.

25. The mobile data collection apparatus of claim 15, further comprising a piloting control system configured to (i) receive positional data from the plurality of encoders, (ii) generate control information for teleoperation of a humanoid robot based on the positional data, and (iii) transmit the control information to the humanoid robot via a network.

26. The mobile data collection apparatus of claim 25, wherein the control information for teleoperation of the humanoid robot comprises (i) rotational data corresponding to an orientation of the human operator's wrist about three rotational axes, and (ii) translational data corresponding to a position of the human operator's wrist along three translational axes.
